(19) United States
(12) Patent Application Publication
(10) Pub. No.: US 2002/0049617 A1
(43) Pub. Date: Apr. 25, 2002

(54) System and method for facilitating selection of benefits

(75) Inventors: Donna K. Lencki, Candia, NH (US); Chris Henchey, Candia, NH (US); Patrick B. Miller, Hooksett, NH (US)

Correspondence Address: Donald J. Perreault, HAYES, SOLOWAY, HENNESSEY, GROSSMAN & HAGE, P.C., 175 Canal Street, Manchester, NH, 03101, US

(73) Assignee: Choicelinx Corporation

(21) Appl. No.: 09/748,359

(22) Filed: Dec. 26, 2000

Related U.S. Application Data
(60) Provisional application No. 60/174,056, filed on Dec. 30, 1999.
(60) Provisional application No. 60/205,338, filed on May 18, 2000.

(51) Int. Cl. G06F 17/60

(52) U.S. Cl. 705/4

(57) ABSTRACT

A system and method of providing benefits. One method consistent with the invention includes identifying at least one price for each of a plurality of line items within a benefit category, and offering the line items for purchase by the individual. Another method consistent with the invention includes offering benefit line items to the employee for purchase using a predefined employer contribution. The line items may be established based on a group benefit cost. A system consistent with the invention may include a database comprising data representing at least one price for each of a plurality of line items within a benefit category; a processor for accessing the database; and a user-interface for accessing the processor to allow purchase of the line items by the employee. A method of processing a benefit claim consistent and a method of providing customer service to an individual are also provided.

### CROSS-REFERENCE TO RELATED APPLICATIONS

The present application claims the benefit of the filing dates of U.S. Provisional Application Nos. 60/174,056 and 60/205,338 filed Dec. 30, 1999 and May 18, 2000, respectively, the teachings of which are incorporated herein by reference.

### FIELD OF THE INVENTION

The present invention relates in general to a system and method for selection, delivery and management of employee benefits such as healthcare benefits, and, in particular an Internet-based tool which permits customization of an employee benefit plan at the individual level, while maximizing the buying power of the employer group.

### BACKGROUND OF THE INVENTION

There is a palpable lack of confidence on the part of consumers that healthcare will be available and accessible in the future. Moreover, it is primarily employers and providers today who are making the choices and decisions for the healthcare consumer. In addition to the consumer issues, the nation's employers are confronted with an increasingly intense global environment in which the cost of health and other employee benefits is causing employer concern. Further, employers continue to struggle with employee retention in the current booming economy. Both consumers and employers are becoming increasingly dissatisfied with the current model of care delivery: managed care.

The industry and public policy environment is such that it is clear the current financial model of insurance is ready for change. HMOs and the “gatekeeper” model of healthcare delivery have created more problems than solutions. Information technology is underutilized within the industry, and the regulatory environment is tightening, and consumer perceptions continue to deteriorate, while consumer demands escalate.

The current arrangement is characterized by a reliance on benefit consultants who manage geographically diverse employee, insurer, and delivery systems through a “one-size fits all” approach. It is clear that employer coalitions are failing (or the strategy is not being actively pursued) because there are currently no tools available to support the concept and/or operationalizing the strategy. What is clearly a solution for small/medium size employers with diverse needs has been left to struggle for the lack of tools to support the strategy.

There has been a recognition of the issues created when the underlying beneficial principles of managed care are morphed into a focus of controlling cost and creating large administrative infrastructures rather than managing to health outcomes. This irrational pursuit of savings at the expense of individual treatment has left the consumer with a real fear of their health insurer and of the medical delivery system while remaining unaware of the costs associated with their utilization within the delivery system. Finally, it is clear that members of the industry are again trying to clarify their role as to whether they are in the healthcare delivery business or the insurance (risk financing) business.

Except for the modifications to retirement strategies brought about as a result of a change in the Tax Code (Section 401(K)) in the late 70's, little attention has been given to employee benefits as an active tool of employee retention. As with the healthcare benefits, other traditional benefits such as Dental, Short/Long term disability, Life and Retirement are in need of change in order to meet the new needs of the workforce.

There is, therefore, a need in the art for a change to an Internet-based, consumer-centered approach to employee benefits.

### SUMMARY OF THE INVENTION

Consistent with the invention, a method of providing benefits to an individual such as an employee includes: identifying at least one price for each of a plurality of line items within a benefit category; and offering the line items for purchase by the individual. The invention is applicable to a wide range of benefit categories, including, but not limited insurance benefits such as health insurance. When healthcare benefits are provided in a manner consistent with the invention, the individual benefit category line items may include, for example, preventative care, physician care, hospital care, emergency care, pharmacy care, alternative care, vision care, behavioral health care services, etc.

According to another aspect of the invention, there is provided a method of providing benefits to an employee including: establishing an account comprising a predefined employer contribution; offering a plurality of benefit line items to the employee for purchase; and deducting a cost associated with each benefit line item purchased by the employee from the account. A method of establishing a health care benefits offering to an employee group consistent with the invention includes: establishing a healthcare cost for the group; and establishing a plurality of health care line items based on the cost. A system for providing benefits to an employee consistent with the invention includes: at least one database comprising data representing at least one price for each of a plurality of line items within a benefit category; at least one processor for accessing the database; and a user-interface for accessing the processor to allow purchase of at least one of the line items by the employee.

The present invention also includes methods of processing benefit claims and providing customer service. A method of processing a benefit claim consistent with the invention includes: receiving a signal comprising data representing individual line items within a benefit category purchased by the individual; automatically building a benefit profile for the individual based on the data; and authorizing payment of the claim based on the benefit profile. A method of providing customer service to an individual purchasing benefits includes: receiving a signal comprising data representing individual line items within a benefit category purchased by the individual; creating a summary of the individual benefit line items from the data; and referring to the summary to answer questions from the individual relating to the individual benefit line items.

### BRIEF DESCRIPTION OF THE DRAWING

For a better understanding of the present invention, together with other objects, features and advantages, reference should be made to the following detailed description which should be read in conjunction with the following figures wherein like numerals represent like parts:

FIG. 1: diagrammatically illustrates employee advantages of an exemplary system consistent with the invention;

FIG. 2: illustrates in block diagram form an exemplary system and method consistent with the invention;

FIG. 3: illustrates in block diagram form an exemplary benefit configuration wizard for an exemplary system and method consistent with the invention;

FIG. 4: illustrates, in block diagram form, an exemplary system architecture for implementing an exemplary system and method consistent with the invention;

FIG. 5: illustrates in block diagram form an exemplary systems integration model for an exemplary system and method consistent with the invention;

FIG. 6: illustrates in block diagram form a telecom/CTI model for an exemplary system and method consistent with the invention;

FIGS. 7A and 7B: illustrate in block diagram form a benefit plan feed for an exemplary system and method consistent with the invention;

FIG. 8: illustrates an exemplary web site entrance arrangement for an exemplary system and method consistent with the invention;

FIG. 9: illustrates an exemplary web site “members only portal” arrangement for an exemplary system and method consistent with the invention;

FIG. 10: illustrates an exemplary web site “providers only portal” arrangement for an exemplary system and method consistent with the invention;

FIG. 11: illustrates an exemplary web site “employers only portal” arrangement for an exemplary system and method consistent with the invention;

FIG. 12: is a process flow diagram for an exemplary member menu in an exemplary system and method consistent with the invention;

FIG. 13: is an exemplary security process flow diagram in an exemplary system and method consistent with the invention;

FIG. 14: is an alternative exemplary member entry screen process flow diagram in an exemplary system and method consistent with the invention;

FIG. 15: is an exemplary member login process flow diagram in an exemplary system and method consistent with the invention;

FIG. 16: is an exemplary enrollment process flow diagram in an exemplary system and method consistent with the invention;

FIG. 17A: is an alternative enrollment process flow diagram in an exemplary system and method consistent with the invention;

FIG. 17B: is an exemplary enrollment screen view in an exemplary system and method consistent with the invention;

FIG. 17C: is an exemplary enrollment screen view in an exemplary system and method consistent with the invention;

FIG. 17D: is an exemplary enrollment screen view in an exemplary system and method consistent with the invention;

FIG. 18: is an exemplary high level benefit selector tool process flow diagram in an exemplary system and method consistent with the invention;

FIG. 19: is an alternative exemplary member expert benefit builder process flow diagram in an exemplary system and method consistent with the invention;

FIG. 20A: is an exemplary process flow diagram for the benefit selection process in an exemplary system and method consistent with the invention;

FIG. 20B: is another exemplary high-level process flow diagram for the benefit selection process in an exemplary system and method consistent with the invention;

FIG. 21: is an exemplary employer group/benefit configuration process flow diagram with data structures, in an exemplary system and method consistent with the invention;

FIG. 22A: is an exemplary member benefit Wizard process flow diagram in an exemplary system and method consistent with the invention;

FIG. 22B: an exemplary initial information screen in an exemplary system and method consistent with the invention;

FIG. 22C: an exemplary co-pay benefits choice screen in an exemplary system and method consistent with the invention;

FIG. 22D: an exemplary dental benefits choice screen in an exemplary system and method consistent with the invention;

FIG. 22E: an exemplary summary of benefits screen in an exemplary system and method consistent with the invention;

FIG. 22F: an exemplary “how do I choose” screen in an exemplary system and method consistent with the invention;

FIG. 22G: an exemplary summary of benefits delivery screen view in an exemplary system and method consistent with the invention;

FIG. 22H: an exemplary “Why do we ask?” screen view in an exemplary system and method consistent with the invention;

FIG. 22I: an exemplary “what's covered” screen view in an exemplary system and method consistent with the invention;

FIG. 23: an exemplary provider directory process flow diagram in an exemplary system and method consistent with the invention;

FIG. 24: an alternative exemplary provider directory process flow diagram in an exemplary system and method consistent with the invention;

FIG. 25A: an exemplary primary physician selection process flow diagram in an exemplary system and method consistent with the invention;

FIG. 25B: an exemplary primary physician selection screen view in an exemplary system and method consistent with the invention;

FIG. 26: an alternative exemplary physician selection process flow diagram in an exemplary system and method consistent with the invention;

FIG. 27: illustrates an exemplary member preference selection interface in an exemplary system and method consistent with the invention;

FIG. 28: an alternative exemplary member preference process flow diagram in an exemplary system and method consistent with the invention;

FIG. 29: an exemplary post-enrollment add/delete/change process flow diagram in an exemplary system and method consistent with the invention;

FIG. 30: another exemplary enrollment/disenrollment/enrollment information change process flow diagram in an exemplary system and method consistent with the invention;

FIG. 31: an alternative exemplary healthy lifestyles process flow diagram in an exemplary system and method consistent with the invention;

FIG. 32: an exemplary “healthy lifestyles/reminders” process flow diagram in an exemplary system and method consistent with the invention;

FIG. 33: an exemplary healthy lifestyles journal process flow diagram in an exemplary system and method consistent with the invention;

FIG. 34: an exemplary member services process flow diagram in an exemplary system and method consistent with the invention;

FIG. 35: an exemplary health risk assessment process flow diagram in an exemplary system and method consistent with the invention;

FIG. 36: an exemplary employer entry screen process flow diagram in an exemplary system and method consistent with the invention;

FIG. 37: an exemplary process flow diagram for the data importation process in an exemplary system and method consistent with the invention;

FIG. 38: an exemplary employer enrollment process flow diagram in an exemplary system and method consistent with the invention;

FIG. 39: an exemplary employer benefit package builder process flow diagram in an exemplary system and method consistent with the invention;

FIG. 40: an exemplary employer preferences process flow diagram in an exemplary system and method consistent with the invention;

FIG. 41: an exemplary employer disenrollment process flow diagram in an exemplary system and method consistent with the invention;

FIG. 42: an exemplary provider entry screen process flow diagram in an exemplary system and method consistent with the invention;

FIG. 43: an exemplary company contact information process flow diagram in an exemplary system and method consistent with the invention;

FIG. 44: an exemplary Customer Care Center process flow diagram in an exemplary system and method consistent with the invention;

FIG. 45: another exemplary Customer Care Center process flow diagram in an exemplary system and method consistent with the invention;

FIG. 46: an exemplary process flow diagram for customer service advocate interaction with a customer regarding an authorization inquiry, in an exemplary system and method consistent with the invention;

FIG. 47: an exemplary process flow diagram for customer service advocate interaction with a customer regarding a benefits inquiry in an exemplary system and method consistent with the invention;

FIG. 48: an exemplary process flow diagram for customer service advocate interaction with a customer regarding a claim inquiry in an exemplary system and method consistent with the invention;

FIG. 49: an exemplary high-level process flow diagram for automatic benefits building in an exemplary system and method consistent with the invention;

FIG. 50: an exemplary underwriting process flow diagram in an exemplary system and method consistent with the invention;

FIG. 51: an exemplary overall business model process flow diagram in an exemplary system and method consistent with the invention; and

FIG. 52: an exemplary Adverse Selection Model process flow diagram in an exemplary system and method consistent with the invention.

### DETAILED DESCRIPTION OF THE INVENTION

The present invention is focused on improving employer and consumer satisfaction, while confronting the rising costs of employee benefit offerings. According to the invention, there is provided an Internet-based, web-enabled application that, among other benefits, provides employers with a solution to the spiraling cost of health insurance and benefit administration, and provides employees with the ability to customize benefits to fit their own needs.

Conventionally, employers provide employee benefits and pay an average of 75% of the premium cost associated with health insurance benefits and a higher percentage of the cost of the other traditional coverage such as dental, life, and disability. One of the distinctive characteristics of the conventional system that has created distress for the employee is that they are the end user (employee-consumer-patient) of the benefit product but are not the primary designer/purchaser of the package.

The present invention revolutionizes the conventional process of benefit offerings at the employer and employee levels. First, the invention permits employers to move to a consumer choice and defined contribution strategy for their employee benefit programs. As it is with retirement benefits offered by employers, a defined benefit strategy of employee benefits has become too costly for employers. Unfortunately, the benefits themselves, with automatic cost escalators associated with the underlying services and utilization patterns beyond the impact of the employer, have become the coin of the realm. A consumer choice with defined contribution strategy will enable the employer to move the discussion away from the emotionally charged debate of benefits, enable the workforce with consumer information, empower the employees as consumers with benefit options, and give the employer a strategy to better manage/budget the cost of employee benefit on a yearly basis.

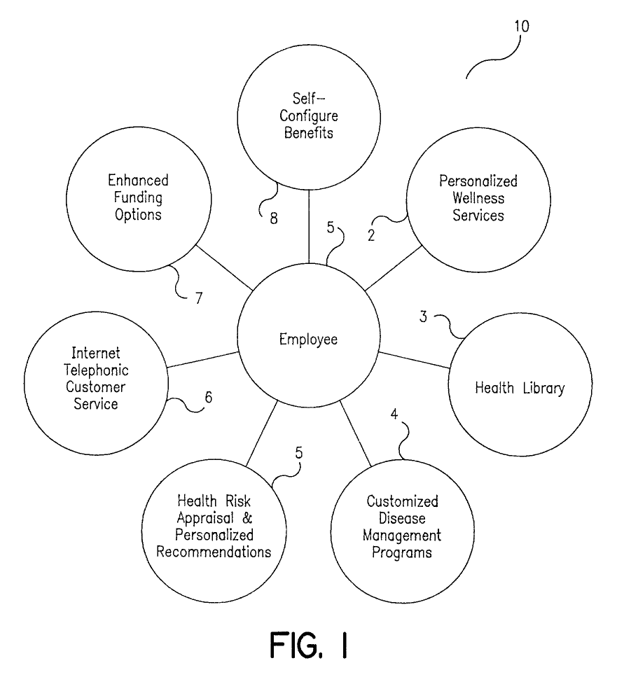

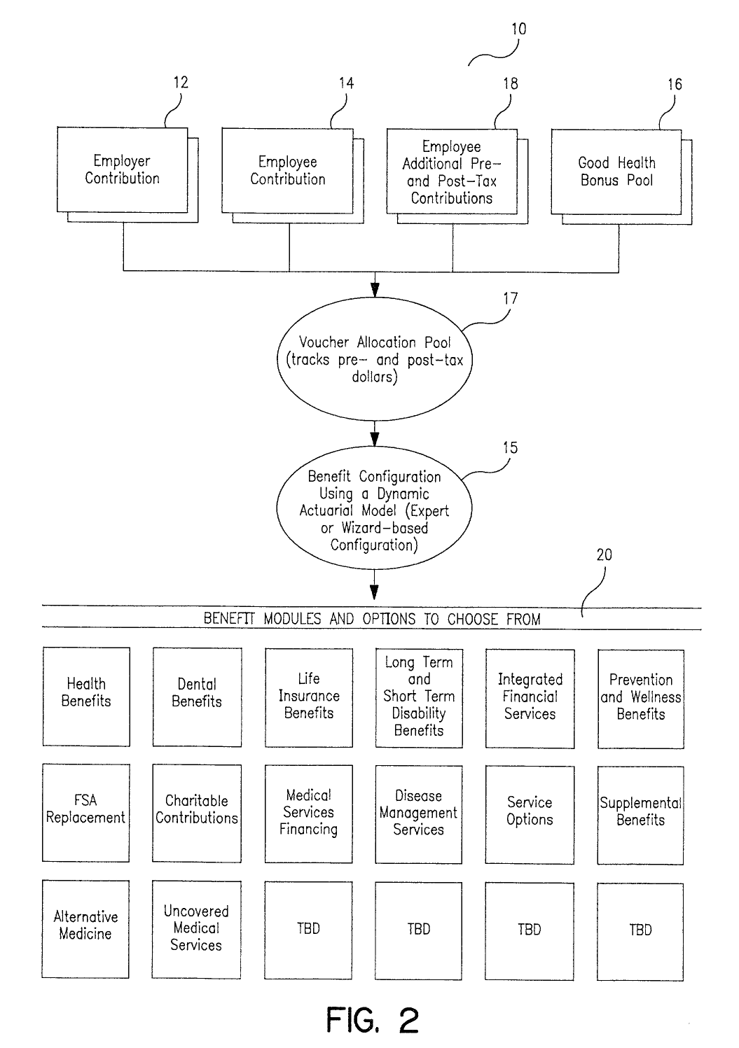

With reference now to FIGS. 1 and 2, according to an exemplary embodiment 10 of the invention, the employer may determine a specific dollar allowance 12 per employee to support a core benefit package and set parameters around the modules/options available to the workforce. The employer may contribute additional dollars 14 to the account in order to support additional benefit selections by the employee. Additionally, the employer may establish a “good health bonus” pool of dollars 16 to reward healthy lifestyle modifications, i.e. smoking cessation, exercise programs. For their part, the employee would contribute a determined percentage of premium cost sharing and would have an ability to voluntarily contribute pre and after-tax dollars 18 into their individualized Account.

Once the account is determined and the employer has determined the minimum benefit package for the company, i.e. health, dental, life, 401(K) etc, the employee would shop and select, e.g. in an on-line environment, from both upgraded and supplemental benefits from discreet line items, line item options, and line item sub-options within benefit package categories 20. Such benefit configuration may be performed by using a dynamic actuarial model in either an expert or wizard-based configuration 15. As shown, a voucher allocation pool 17 may be employed to track pre- and post-tax dollars. The system may indicate dollars spent at all times as the employee makes his/her personalized selections for health coverage, dental coverage, Life/STD/LTD, prevention and wellness programs as well as customized customer service modules.

Additionally, as illustrated, for example, in FIG. 1, an employee 5 within system 10 may select financial products or other supplemental products that best suit his or her needs. Such products may include, for example, personalized wellness services 2, health library services 3, customized disease management programs 4, health risk appraisal and personalized recommendations 5, internet and telephonic customer service 6, enhanced funding options 7, as well as self-configured benefits 8, as further described herein. The employee may also be presented with an option to purchase a disease management program at retail cost for non-covered individuals, e.g. non-covered family members.

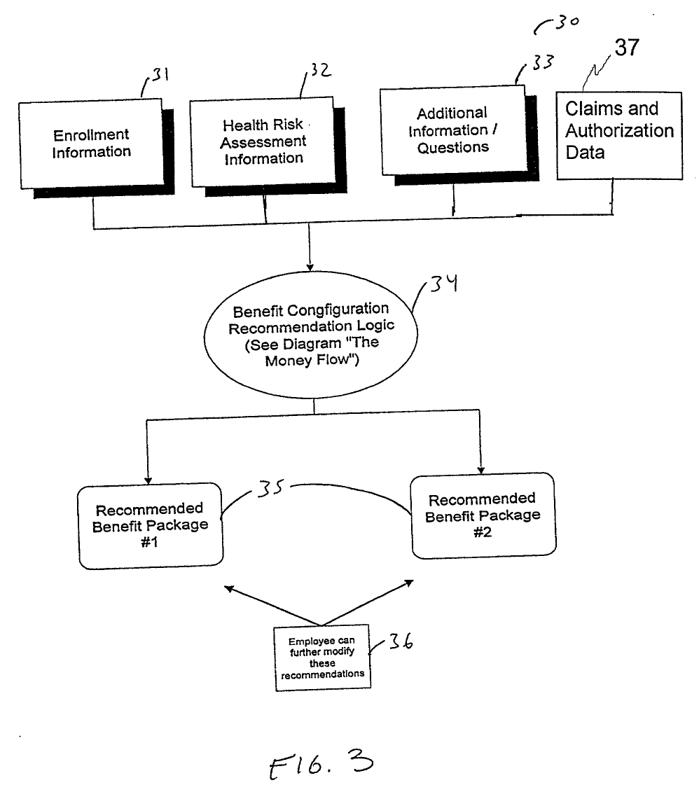

The system allows an employee to personalize a benefit package, choosing benefit modules and options that best fit a particular lifestyle. Through the use of a wizard, as diagrammatically illustrated, for example, in the process flow diagram 30 of FIG. 3, with minimal enrollment information 31 gathered through the enrollment process, health risk information 32 gathered via the health risk assessment screen, claims and authorization data 37, and other additional information 33, the system, using benefit configuration recommendation logic 34, as further described herein, may display several alternative healthcare packages 35 for the employee to choose from. The employee can then further modify these recommendations 36 by adjusting discreet health benefits and by selecting additional benefits for his or her family.

An employee may also choose to bypass the Wizard and select each benefit package independently. The employee will continue to make selections from benefits as well as other products and services until the voucher dollars are completely allocated. Finally, the employee may modify behaviors to earn incentive dollars and may allocate those dollars for products or carry over the incentive as a beginning balance for the next year's benefit selection process. The result of using either the Wizard or the Expert method of selection is a personalized benefit package, resulting in consumer satisfaction.

The personalized selection process allows the employee: (1) to select one benefit package over another to meet the needs of their family; (2) to access personalized health services and goods, e.g., fitness, wellness, disease management; and (3) to see the cost impact of his/her selections. Also, the products available through the system address the dissatisfaction with current employer offered choices. Available packages may include open access health products, traditional and alternative treatment, and enhanced coverage not currently offered at all.

Each of the constituents involved in the health insurance/benefit environment may derive significant benefits from a system consistent with the invention. Specific benefits include, for example:

Employer:

With the introduction of the consumer choice and defined contribution strategy, the employer experiences a reduction in frustration with the purchasing and administration of the benefit plan and, in effect, removes him/herself from the role of middleman with the managed care organization. The employer is released from the burdens of benefit selection and the hassles and disruption of “shopping rates” each year. The employer thus has better predictability of cost and can manage the benefit line within financial decision-making without the burden of benefit enhancement/reduction decisions. Additionally, the program can become an important component of the employee satisfaction/retention effort. Finally, the system is a catalyst for “shared” responsibility for quality/cost decision around the entire benefit package.

Employee:

The employee-consumer-patient enjoys the victory of empowerment when selecting a benefit package that will fit their needs and those of their families. The employee has open access to the provider community and can make quality decisions concerning providers by utilizing the system to review quality and cost outcomes at the physician/hospital level. Finally, the employee can access otherwise unavailable or expensive services tailored to the individual needs of the family, i.e. personal health advocate, alternative medicine or personal financial services not usually available through payroll deduction.

Provider Community:

In response to the difficulties ascribed to the managed care industry, the AMA has endorsed a defined contribution strategy as well as any program that will relieve physicians from the constraints of managed care. A system consistent with the invention has a direct impact on the provider by eliminating the managed-care administrative burdens such as referrals, pre-certifications and limited provider choice. The system expects more and better interactions with the patient on the part of all providers and delivery of service that meets the physical and emotional needs of the customer. The physician/provider will also benefit from our nationally recognized disease management protocols available on-line as well as access to population and patient specific health-risk/health-status information provided through the system data warehouse.

Additional product attributes may include the following: The module/option design ensures flexibility to modify the product to meet employer and employee demands and purchasing characteristics. The data captured and the information generated will allow both employer and providers to review the overall utilization patterns and to meet emerging demands rather than reacting to the volume/tone of consumer complaints. All parties may move with the maturing process of disease management to the next level of impact by embedding disease management into the core business functions of company providing the system (hereinafter “the company”), i.e. claims, customer service. Service kiosks may be provided in the workplaces. Outcome analysis may enable the company providing the system to see trends and meet the customer at the point of their new preferences.

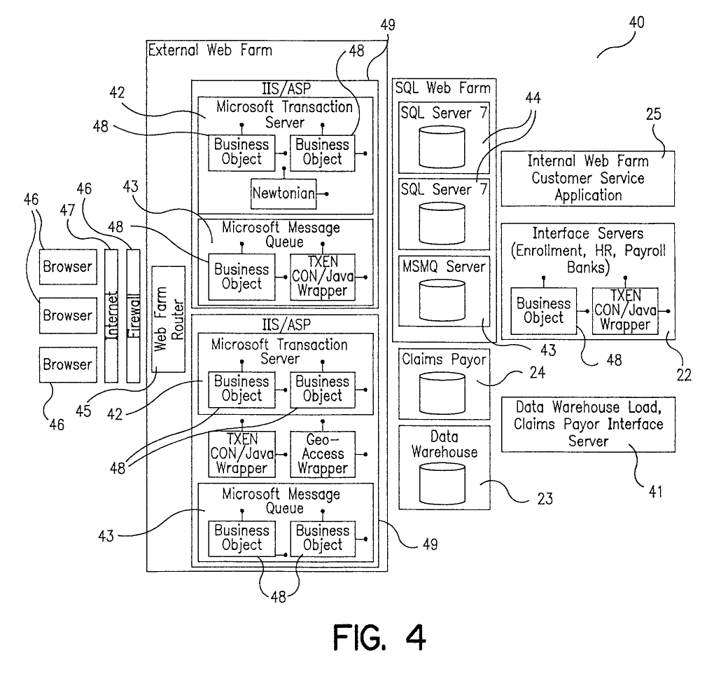

FIG. 4 illustrates an exemplary architecture 40 for a system consistent with the invention, which is flexible, robust, scalable, and fault tolerant. In an exemplary embodiment, the system may be standardized on Microsoft platforms, given the market dominance of Microsoft and the robust technical solutions provided. Windows NT/2000 may provide the backbone of the system.

The preferred architecture may be, primarily, a multi-tiered web application. Microsoft Internet Information Server (IIS) and its scripting engine, Active Server Pages (ASP), may provide web interface services. ActiveX/COM, Microsoft Transaction Server (MTS) 42, and Microsoft Message Queue Server (MSMQ) 43 may be used to implement and manage business and data access objects. Microsoft SQL Server 7 or Windows NT 2000 server 44 may provide database services.

Router hardware or software technology (Windows Load Balancing Server, for example) 45 may distribute requests across a farm of web servers 49. Firewalls 46, use of Secure Sockets Layer (SSL) and password authentication may provide security for both the site and users visiting the sites.

Active Server Pages on IIS may be used to format data and dynamically serve up web pages to users' browsers 46 via the Internet 47. Data may be provided to ASP by business objects 48 implemented as MTS-managed ActiveX/COM objects.

Microsoft Transaction Server (MTS) and Message Queue Server (MSMQ) may be utilized wherever possible. MTS, and to a lesser extent, MSMQ, are useful technologies in building a scalable and robust application. They also factor significantly in a migration path to Windows 2000. Microsoft SQL Server may serve as the primary database engine for the application. Standard performance-enhancing technologies, such as stored procedures, may be used to increase performance and scalability.

Redundancy and stability may be provided by backup servers and clustering technologies, such as Microsoft Cluster Server (MSCS). Windows 2000 may provide additional redundancy in COM+. Application servers running MTS/MSMQ may be equipped with RAID-5, and the SQL Servers may be equipped with RAID 1&0.

The system may work real-time with claims payment systems 41 from one of several TPA's or operations outsourcing vendors, e.g., CSC, and claims payment data may be stored in a claims payor server 24. Additionally, the system may utilize interface servers 22 to feed data to employer payroll systems, and access claims data from partners such as prescription drug and behavioral health vendors. Other vendors can be seamlessly integrated into the architecture, as required, given the open architecture.

A SQL Server 7, Windows NT 2000, or Oracle database 23 may serve as the Company's data warehouse. Such a system architecture will allow for unlimited growth. Additionally, the Compaq servers supporting the business are fault tolerant, and may ultimately be supported remotely through a third party data center. A customer service application 25 may be provided for customer service representatives to access system data stored in the various servers 23, 24, 43, and 44.

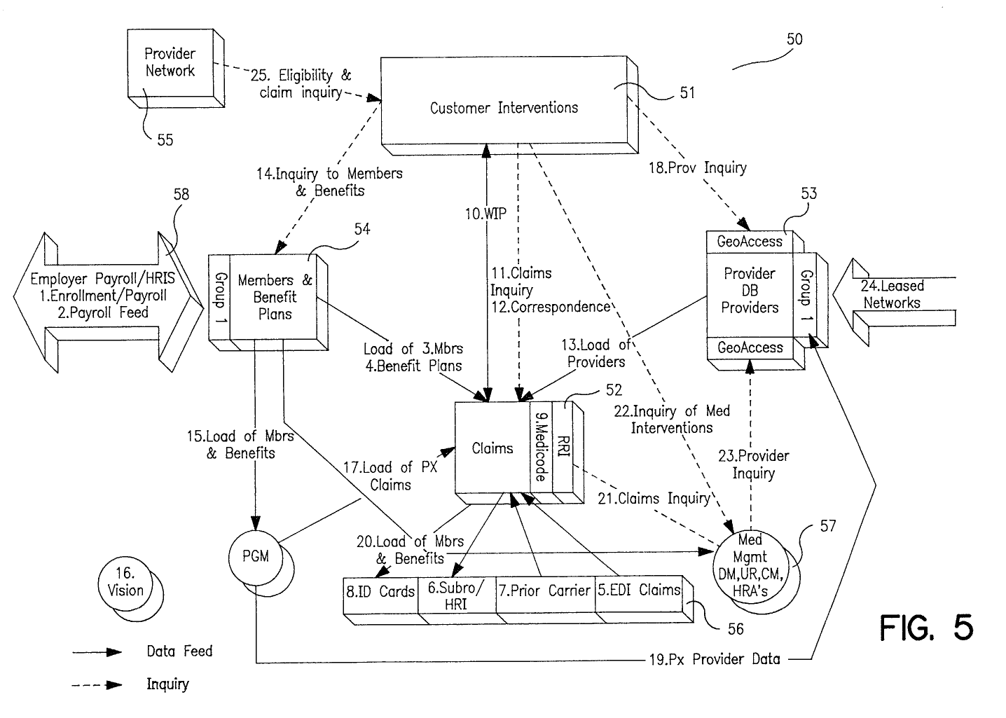

An exemplary systems integration model is shown in FIG. 5, illustrating the interaction and data flow between various system components in an exemplary system 50. Customer interventions may be performed by a customer service company 51, e.g., Clarify, which may make claim inquiries to one or more claims management companies 52, e.g. CSC, medical intervention inquiries to one or more medical management companies 57, provider inquiries to one or more providers 53, or member or benefit inquiries to the member and benefit plan portion 54 of the system 50.

Data relating to such inquiries may be transmitted and received between the claims management company 52 and the customer service company 51. A provider network 55 may make eligibility and claim inquiries via the customer service company 51. A claims management company 52 may make claims inquiries and/or provider inquiries, either directly or indirectly, to the medical management companies 57 and/or providers 53 and receive requested data from such companies 57 and/or providers 53. The claims management company 52 may also exchange data with one or more databases 56, including data relating to ID cards, subrogation/HRI, prior carriers, and EDI claims. The member and benefit plan portion 54 of the system 50 may feed provider, member and/or benefit data either directly or indirectly to one or more of the claims management company 52, medical management company 57, and/or providers 53. Payroll and enrollment data may be transmitted and received between an employer payroll or human resource system 58 and the member and benefit plan portion 54 of the system 50.

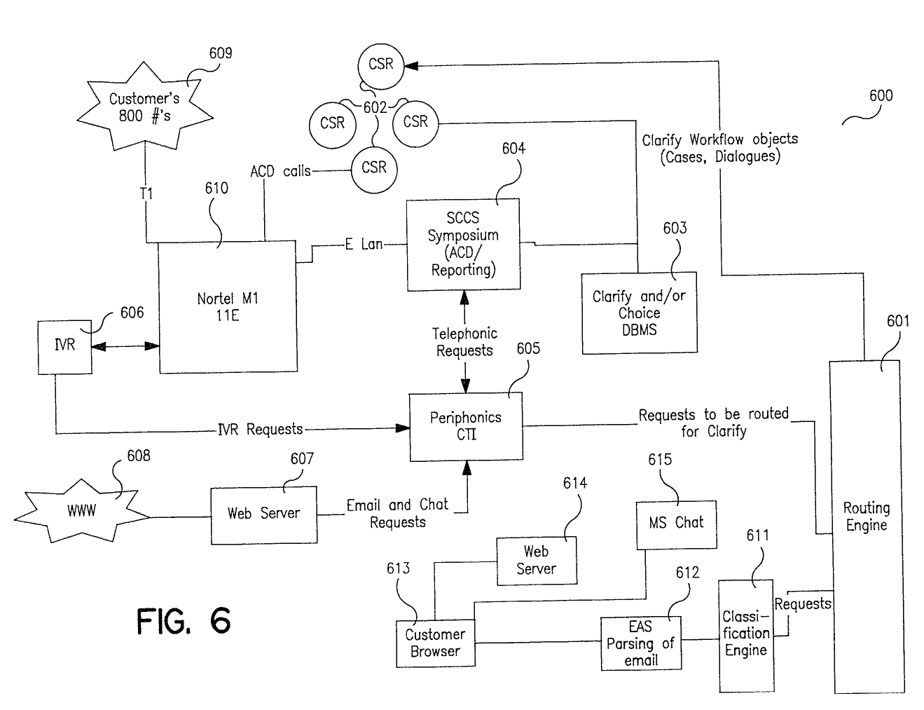

An exemplary telecom/CTI system 60 is illustrated in FIG. 6. A routing engine 601 routes data requests and feeds between the telecom/CTI system 60 and the corresponding system required to provide such data or handle such request. Data, including workflow objects (e.g. cases, dialogues) may be transmitted between a plurality of customer service representatives 602 and the routing engine 601. Data requests and/or feeds may also take place directly between the customer service representatives 602 and a customer service system 603 (e.g. Clarify and/or Choice DBMS), or ACD/reporting system 604 (e.g. SCCS Symposium). A CTI 605 (e.g. Periphonics) may handle telephonic requests from the reporting system 604, route requests to the routing engine 601, process IVR requests from IVR 606, and/or handle incoming email and chat requests from a web server 607 that interfaces to the World Wide Web 608.

Telephone calls from customers (typically via a toll-free number) 609 are handled by a telephonic network 610 (e.g. Nortel M1/11E), which may directly interface with IVR 606, reporting system 604, and/or customer service representatives 602 (e.g., for ACD calls). The routing engine 601 may also receive requests from a classification engine 611, which receives e-mail messages from a parser (e.g. EAS) 612, which receives and parses original e-mail text entered by customers via their web browsers 613. A web server 614 is configured to interface with the customer's browser 613, and a chat facility 615 (e.g. MS Chat) may be provided to allow real-time, interactive typed customer communication. Further details with respect to customer service and communications are provided herein.

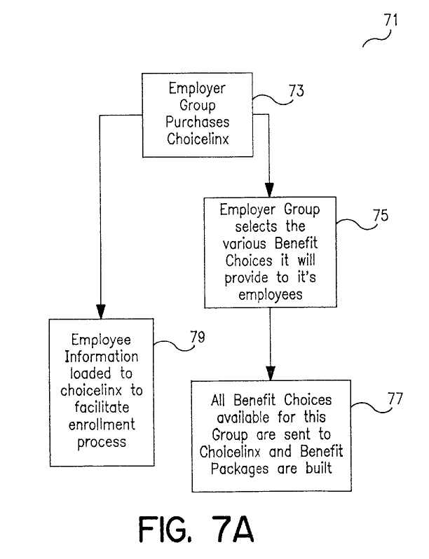

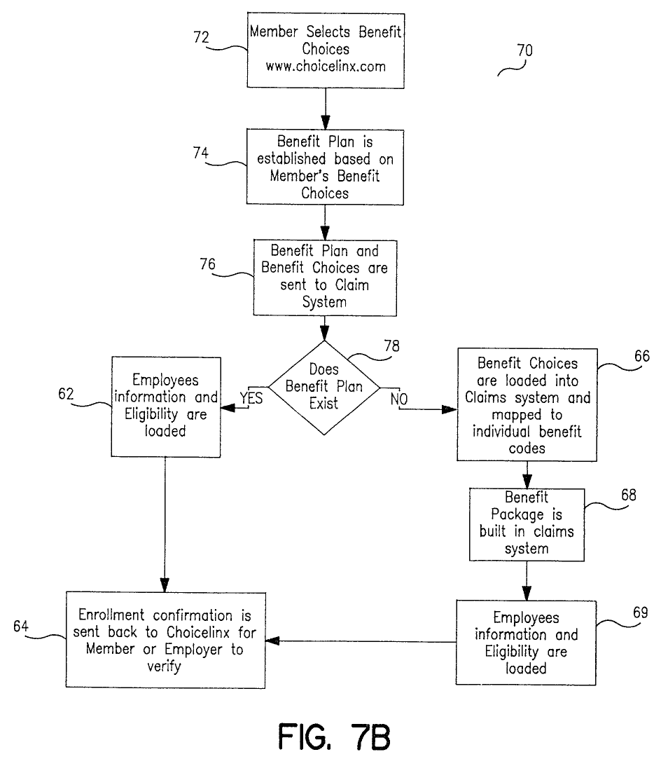

Flow charts 70, 71 illustrating an exemplary benefit feed plan are illustrated in FIGS. 7A and 7B, respectively. The group selection process 71 begins by an employer group purchasing 73 a system according to the present invention. Employee information is received 79 by a company administering the invention to facilitate the enrollment process. The employer group selects 75 the various benefit choices it will provide to its employees, and all benefit choices available for that group are sent 77 to the company administering the invention and benefit packages are built.

For the member benefit load process 70, a member uses a web interface to select 72 benefit choices, and a benefit plan is established 74 based on the member's benefit choices. The benefit plan and benefit choices are sent 76 to the claim system, and a determination is made whether the benefit plan exists 78. If so, employee and eligibility information are loaded 62, and enrollment confirmation is sent back 64 to the administrator of the web site for the member or employer to verify. If the benefit plan does not exist, the benefit choices are loaded 66 into the claims system and mapped to individual benefit codes, a benefit package is built 68 in the claims system, employee and eligibility information are loaded 69, and enrollment confirmation is sent back 64 to the administrator of the web site for the member or employer to verify.

In summary, the process flow for the benefits feed plan illustrated in FIG. 7 has the following features: The subscriber will choose their benefit options via a web site. The benefit package will be specific to that subscriber and covered members, and the overall options are specific to the employer of that subscriber. The benefit package is dynamically built and stored in the web application. At timely intervals, an output file will be generated from the web application, for interfaces with vendor systems for claims payment, and an output file will be sent to the claim system for loading to allow for claims payment. The claims system will check to see if this benefit plan exists, and if not, will load the benefit choices and auto-build the benefit plan. The claims system will then load the subscriber and member eligibility, and confirmation will be sent back to the administrator of the web site. The subscriber can log in and view benefit options at any time.

While the foregoing described illustrations make reference to specific companies, e.g. Clarify and CSC, it is to be understood that these companies are referenced only by way of illustration and not by limitation. In fact, a system consistent with the present invention may be integrated with other claims management (CSC) or customer service companies (Clarify) applications. Integration methods may include staged data with standard full and incremental loads, real-time updates, and message queued data updates. Technologies used may include MTS, COM+, BEA Tuxedo, Open API calls, XML, and Message queuing such as Microsoft MSMQ or IMB MQ series.

The system uses the latest technologies and communication protocols to appear as one seamless system. Customer service representatives are able to work within one system (e.g., Clarify) for all of their needs. External inquiries from members, employers, and providers come through the web site that utilizes interfaces with other systems to manage the requests/inquiries. Interfaces to a claims processing company, e.g. CSC, facilitate use of the claims company's open APIs for on-line inquiry and real time transactional interfaces. The QP messaging services from the claims processing company may be used to transfer “work in process” requests between company staff and other partners. Major data entries (e.g., member, provider, claims) are owned and maintained on one system, with interfaces built around the data source to share information. Duplication of data is avoided through use of “open systems” for reading data into other systems when necessary.

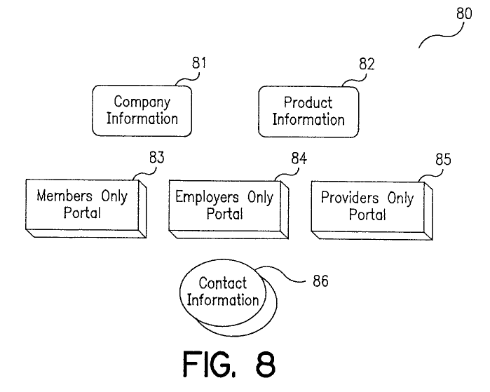

Turning now to FIG. 8, there is illustrated an exemplary web site entrance 80 for a system and method consistent with the invention. As shown, the web site may have limited choices on the front page in order to reduce clutter and enable the end user to easily and clearly navigate the site. In one embodiment, only six (6) button choices may be offered to the end user. As shown, such choices may include company information 81, product information 82, a members only portal 83, an employers only portal 84, a providers only portal 85, and company information 86. There may be a section on the front page with headlines and direct links into the site for building a sample benefits plan, viewing case studies, completing an HRA, and viewing the fitness log. There may also be a section for Company and market updates, news of strategic alliances, new partners, and new business. Scrolling may be used for this section. There may also be an area for certifications as appropriate for Web Security and endorsements.

### Company Information Section

The company information 81 section may provide information about the company or administrator operating the web site (herein referred to throughout as “the company”), including, but not limited to: company mission, the purpose of the company, company history; how and why the company got started; the founders and their biographies and pictures; the management team; the customer base; a list of the employers or employer coalitions; a list of partners; investor information; who has invested so far; whom to contact if parties are interested in investing; company updates, and news releases.

### Product Information Section

The product information 82 section may provide information regarding the various products offered through the company. It may be primarily marketing information describing the innovative programs offered to members, providers, and employers. Tutorials centered on case studies may be available within this section to allow non-members as well as members who are performing first time configurations to gain a greater understanding of the capabilities and appropriateness of package choices. Pictures to illustrate the lifestyle of the case study members may appear beside their name, with their name serving as a hyperlink. Case studies may be provided herein by way of example, as follows:

Exemplary Case Study for Person A

Person A, 38, a software engineer, recently recruited to an employer is designing a benefit package that is completely suited to her and her family's needs. The mother of two young children, she typically makes the “buying” decisions for her family's healthcare. The employer has recently endorsed the present invention rather than taking the traditional route of assigning a standard benefit package for Person A, she may shop for healthcare in a way that she is accustomed to shopping for other products and services. She may be presented with choices, purchasing information, and cost data so that she can make the best possible buying decisions.

Person A is told by her employer that it has adopted a consumer choice strategy for benefits and that she has $7,000 to spend per year for her healthcare coverage. This is a combination of her employer's contribution, her own required contribution, and her employer's healthcare incentive bonus contribution. She prefers a more traditional open access method of healthcare but does choose to upgrade her family's dental coverage in anticipation of braces for her children. One of her two children is an asthmatic, and her husband is very sports minded. The family has some disposable income to spend on “Living Healthy” extras.

Person A can see the effect of her decisions through a dynamic, interactive resource meter that tallies her choices as she designs her family's benefits package. With the present invention, she selects a $500, rather than a $200, inpatient deductible in order to save $10 per month. She also selects a modified pharmacy benefit program understanding that selection alone saves her family $15 per month. She makes this decision knowing that she may have to use certain pharmaceutical products and have a higher pharmacy co-payment. With an extra $25 per month now to spend, she purchases an expanded chiropractic benefit for herself that allows her to have twice the standard number of visits, enhanced dental coverage and a health club membership for her husband so he can play racquetball and swim. Anticipating her desire for Laser Vision Correction surgery, Person A chooses to add a voluntary contribution to save for the procedure next year. She then selects, at the recommendation of the Configuration Wizard of the present invention, the Personal Healthcare Advisor Program. For an additional few dollars a month, the Personal Healthcare Advisor Program may assist Person A and her family in an aggressive disease management program, customized for her daughter's asthma by a personal health “coach.”

Once Person A's personalization of her health insurance is completed, a web site consistent with present invention may bring her directly to the customization of her other employee benefit options as well. Once complete, Person A may have personalized her benefits, added voluntary contributions to enhance her coverage and her retirement, and taken ownership of her benefit plan.

Exemplary Case Study for Person B

Person B is a single male, age 25, employed as an entry-level journalist for the local newspaper. Person B has diabetes that is well controlled with insulin and is otherwise healthy and athletic. Because he is newly out of school and does not have much in the way of disposable income, yet needs to visit his physician on a quarterly basis and refill his prescription monthly, through the present invention he selects health benefits with low co-pays for office visits and generic drugs.

Because exercise is an important component in managing his diabetes and staying healthy, he decides to sign-up with a local gym to purchase benefits on a pre-tax basis. The money he saves in taxes and the budgeting aspect of the present invention makes it affordable for him to choose a gym with a wide range of services.

Person B's employer has made several options mandatory to ensure the financial well being of its employees. As a result, Person B chooses the base levels of Short and Long Term Disability, Life and Dental Insurance. Since he is new to his employer, he is not yet eligible for 401(K), so he may come back to a site consistent with the invention when it sends him an automatic message at his time of eligibility.

At this point, Person B opts to save his choices and complete the enrollment process.

Exemplary Case Study for Person C

Person C is a single mother of four who works at an electronics-manufacturing firm. She has two children in daycare and two in the local school system. She visits her pediatrician on a regular basis as her two youngest children have chronic ear infections. With four children to support, she is not interested in any of the extras, but does need a health plan with a low office co-pay and the most affordable pharmacy benefit.

Through a site consistent with the present invention, Person C selects the $10 co-pay and the $100 inpatient deductible, and the pharmacy benefit that has the lowest cost if she elects to use generic medications. Since her pediatrician always prescribes Amoxicillin, a generic drug, she knows that this benefit may be the most appropriate for her children and her pocketbook. Although the lower deductible cost her $10 per month more than a higher deductible, she saves $15 on the pharmacy benefit and therefore comes out ahead.

Person C's employer does not require any benefits to be mandatory, but since she has voucher dollars left to spend, she picks modest Short and Long Term Disability and Life Insurance policies to protect herself and her children in the event of a serious illness or death.

Person C decides to put money aside in the Flexible Spending Account to pay for daycare on a pre-tax basis, and asks the system to prompt her to begin contributing to 401(K) once the little ones enter first grade.

Exemplary Case Study for Person D

Person D is a 32-year-old single male employed as a Director of IT for Company Y. Person D has no known health problems, is slightly overweight and prefers alternative to traditional medicine. Through the present invention, Person D selects the $20 co-pay plan, the savings from which he applies to Alternative Medicine riders. He chooses a middle of the road pharmacy benefit, but decides to fund nutritional counseling, stress management classes and a personal fitness trainer, all on a pre-tax basis. He wears contacts, so he adds money to his Flexible Spending Account for their purchase.

Person D's employer funds both Short and Long Term Disability as well as Life Insurance, so he elects those benefits, adds on Dental with an option for 3 cleanings a years versus 2 and decides to contribute to his 401(K). In order to see which contribution amount would work out best, he enters a percentage and hits the calculate button to see this effect on his paycheck. He realizes that he can increase his contribution from 8 to 10% of his salary without changing his after-tax bi-weekly pay, and quickly decides to up the amount.

At this point Person D is not interested in financing any non-covered procedures (e.g., cosmetic, laser eye surgery) and decides to wait until he has met with his fitness trainer before financing any exercise equipment. He hits the submit button and completes his enrollment through the present invention.

### Members Only Portal

This portal may be the core repository for information pertaining to members, as well as the portal where members may interact with the site. The initial screen may ask whether or not the person is a member already, and if so, they may be prompted to input their member ID and/or PIN in order to gain access to the site. If not, then a message may be displayed encouraging them to contact their employer about offering the company products.

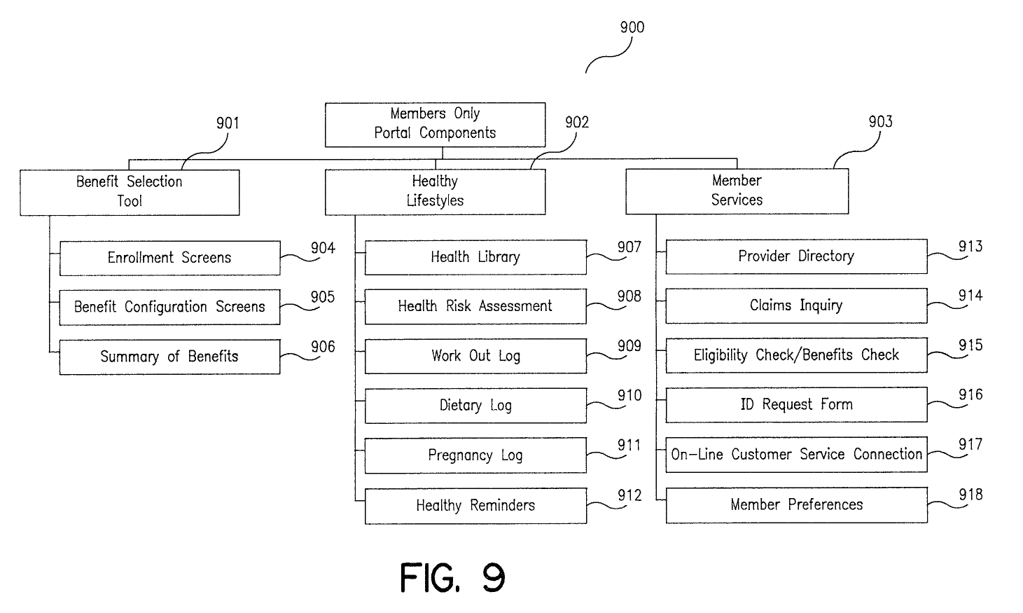

As illustrated in FIG. 9, an exemplary Members Only Portal 900 (MOP) may comprise three primary areas: a benefit selector tool 901, a healthy lifestyles section 902, and a member services section 903. Each of these three areas may have a large, descriptive icon, and that the detailed sections under each area may also be highlighted. The sub-areas within each of the three primary areas are listed in the following table, along with a description of the functionality.

The benefit selection tool 901 may include enrollment screens 904, benefit configuration screens 905, and Summary of Benefits screens 906. The enrollment screens 904 may be the screens completed by the member that may contain basic enrollment information. Members may be encouraged to choose a personal physician, even for non-gatekeeper plans. The member may have access to an on-line provider directory to search for a personal physician. Every attempt may be made to populate the system with data from the employer's databases in order to reduce the amount of work by the member.

The benefit configuration screens 905 may be the heart of the system. The member may be asked a series of questions regarding their health (history of heart disease, asthma, other lung disease, diabetes). During the configuration process, the member may always see a Resource Monitor which may tell him/her how much funds are available/have been spent. They may also have the ability to see on a pre and post tax basis the effect on their paycheck and contribution amount. There may be hyperlinks for each of the benefit options to provide the member with a concise, easy-to-understand description of the services entailed.

The summary of benefit screens 906 are displayed after the member is done with the configuration, at which time he or she may need to view a summary of the benefits selected, as well as the dollars he or she just spent. It is anticipated that this information could also be printed out via the web browser, or that an Adobe Acrobat file could be created. Additionally, the system may assign a login and password for each family member over age 18 in order for them to have individual access to the web site for health information, work out logs, dietary logs, healthy reminders, etc. Parental permission is required for separate logins for those under 18. The system may print out basic health reminders along with the summaries of benefits.

The healthy lifestyles section 902 may include a health library 907, a health risk assessment section 908, a work out log 909, a dietary log 910, a pregnancy log 911, and a healthy reminders section 912. The health library 907 may comprise health education materials in the form of links to other content sites, libraries of articles, and recommendations for fitness and dietary information. The materials may be organized around the diseases that the disease management programs may support, e.g., Cardiovascular Disease (CVD), Congestive Heart Failure (CHF), Chronic Obstructive Pulmonary Disease (COPD), Diabetes, and Hypertension. Additionally, links to fitness and dietary sites may be made. Links to smoking cessation and other preventive measures classes may be made. Finally, information links can be maintained for a sizable list of diseases and conditions. This screen may also incorporate links from health and fitness sites, and “Coming Soon” sections, e.g., for disease management programs, may be constructed.

The health risk assessment section 908 may be an on-line version of the standard HRA forms that many insurers and others use today. It may be customizable based upon gender, age, and known disease conditions. Members may fill it out on-line and then they may receive a Personalized Health Report Card that explains what they can do in order to improve their health status/risks. Personal goals may be set within the system and then it may tie to the various logs (work out, dietary, pregnancy) so members can get feedback.

The work out log 909 may be a place where members can go to enter information regarding the types of exercise, dates, durations, and comments about their work out activities. Members can set targets for themselves and see how they are doing in relation to those targets. This information may be stored so that they or their physician (with authorization) can see trending information. Some employers may use this information for Healthy Rewards benefits. Upon entering the work out log area the last 10 entries may automatically appear. The member may have the option to print out the last x entries (the x may be pre-filled with a 10 but allow the member to edit for any number) or the last x months (3 may be the pre-fill with full editing available). These may print out in MS Word. The log may contain the following fields: first name, last name, exercise, date, time, and location. The name may pre-fill with each new entry and the remaining fields may have drop-downs.

The dietary log 910 may be a place where members can go to enter information regarding what they eat and when. Members may be permitted to set targets for themselves and see how they are doing in relation. This information may be stored so that they or their physician (with authorization) can see trending information. Some employers may use this information for Healthy Rewards benefits. The functionality of the dietary log may mimic that of the work out log. The fields may be similar to those of the work out log.

The pregnancy log 911 may be a place where members can go to enter and view information regarding their pregnancy. Documentation of office visits, blood pressure, and other test results can be stored here. For high-risk pregnancies, members may enter information that can then be transmitted directly to the physician (with authorization). Members can set targets for themselves and track their progress. This information may be stored so that they or their physician (with authorization) can see trending information. Some employers may use this information for Healthy Rewards benefits. As with the dietary and work out logs, the pregnancy log may automatically populate with the last 10 entries. The fields may be similar to those of the work out log or dietary log. The member may have the option to print, e-mail and edit and all changes may be saved in the member's history file.

Healthy reminders 912 are emails that may be sent to members to remind them of certain (primarily preventive) medical services that they may have. For instance, pap smears, mammograms, prostate checks, diabetic retinal exams, etc. These may be triggered via two different ways: 1) based on simple enrollment data provided (age, gender), and 2) based on claims data. The latter is not possible initially, given that there may be no claims data (although it would be possible to build in a series of questions that could address some of this). Initially these may be triggered according to date enrolled, age, gender and a table of services with timeframes assigned.

This system of reminders may be tied into the disease management programs and protocols. Physicians may be able to select from a number of canned messages. The functionality may be designed so that it can query against claims experience by procedure code to confirm whether or not the service was provided prior to sending the reminder. Messages may be sent to the member using a hyperlink that may require their SSN and PIN for pick-up. Providers may be able to select one of several canned messages to their patients using the Healthy Reminders function.

The system may also allow for input from the member as to services they have received but might not have appeared via the claims data. Members may have the option of selecting a service and entering the month/year that it was provided to drive the message trigger. The following exemplary reminders, which are triggered based on the rules shown, may apply:

| Rule Name | Rule | Message |
|---|---|---|
| Childhood | If age <2, send | Immunizations are a proven way to help a child stay |
| Immunization | reminder, | healthy. Children under two years of age may have |
| | | the following immunizations: DTP, Polio, MMR |
| | | (Measles-mumps-rubella), H influenza type B, |
| | | Hepatitis B, Chicken Pox. The company cares about |
| | | your children; please ensure that they receive the |
| | | recommended immunizations. |
| Adolescent | If age <13, send | Immunizations are a proven defense against serious |
| Immunization | reminder, | illness. To help prevent illnesses such as Hepatitis B |
| | | and tetanus in adolescents, children under age 13 |
| | | may have the following immunizations: MMR |
| | | (Measles-mumps-rubella), Hepatitis B, and Chicken |
| | | Pox. The company cares about your children; please |
| | | ensure that they receive the recommended |
| | | immunizations. |
| Breast Cancer | If age <=69 but | Breast cancer is the most common type of cancer |
| Screening | >=52 and | among American women. Each year more than |
| | gender = F, | 175,000 women are diagnosed with breast cancer. |
| | send reminder. | Breast cancer can be identified and treated early |
| | | through mammography. Women between the ages |
| | | of 52 and 69 may have a mammogram at least once |
| | | every two years and a clinical exam annually. The |
| | | company cares about your health; please follow the |
| | | breast weliness guidelines. |
| Cervical | If age <=64 but | Every year, more than 12,000 new cases of cervical |
| Cancer | >=21 and | cancer are diagnosed in the United States. The pap |
| Screening | gender = F, | smear can detect this cancer in its early and most |
| | send reminder, | treatable stages. This highly effective test has been |
| | | credited with reducing cervical cancer deaths by as |
| | | much as 75%. Women between the ages of 21 and 64 |
| | | may have at least one pap smear in a three-year |
| | | period after two annual negative screenings. The |
| | | company cares about your health; please follow the |
| | | Cervical Cancer Screening guidelines. |
| Blood | If age <=65 and | To prevent heart disease, women between the ages |
| Cholesterol | >=45 and | of 45 and 65 may have a non-fasting blood |
| Female | gender = F, | cholesterol level once every five years. The company |
| | send reminder | cares about your health; please follow the cholesterol |
| | | screening guidelines. |
| Blood | If age <=65 and | To prevent heart disease, men between the ages of 35 |
| Cholesterol | >=35 and | and 65 may have a non-fasting blood cholesterol |
| Male | gender = M, | level once every five years. The company cares |
| | send reminder | about your health; please follow the cholesterol |
| | | screening guidelines. |
| Colorectal | If age >50, | Colorectal cancer is responsible for nearly 57,000 |
| Cancer | send reminder | deaths in the Unites States annually, however early |
| Screening | | detection and new treatments have actually |
| | | contributed to a decline. Screening techniques such |
| | | as digital exams, occult blood tests, flexible |
| | | sigmoidoscopies, colonoscopies and barium enemas |
| | | detect colorectal cancers in their earliest stages. Men |
| | | and Women over the age of 50 may contact their |
| | | physicians about the most appropriate screenings to |
| | | maintain their health. The company cares about |
| | | your health; please contact your physician about |
| | | colon screenings. |

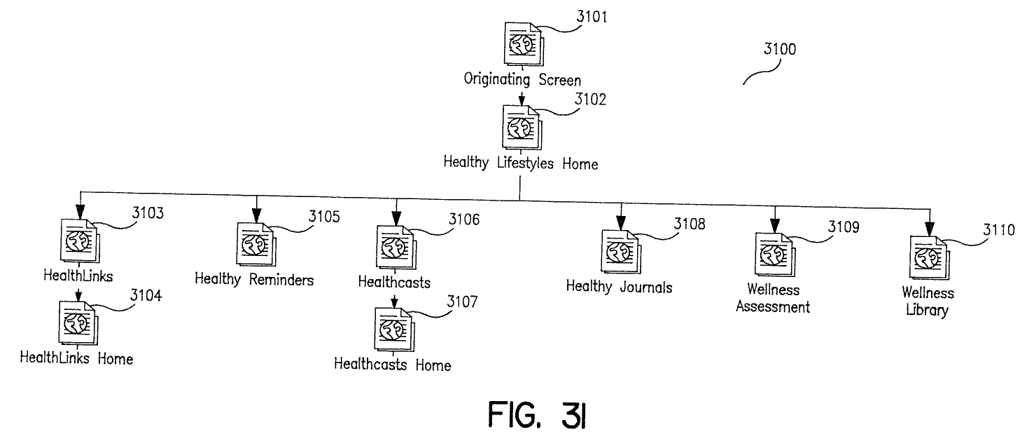

An alternative exemplary healthy lifestyles process flow 3100 is illustrated in FIG. 31. From the originating screen 3101, a member may enter the healthy lifestyles home page 3102, where he or she may choose from among options including “healthlinks” 3103, which leads the user to a “healthlinks” home page 3104, healthy reminders 3105, “healthcasts” 3106, which leads the user to a “healthcasts” home page 3107, healthy journals 3108, wellness assessment 3109, and wellness library 3110.

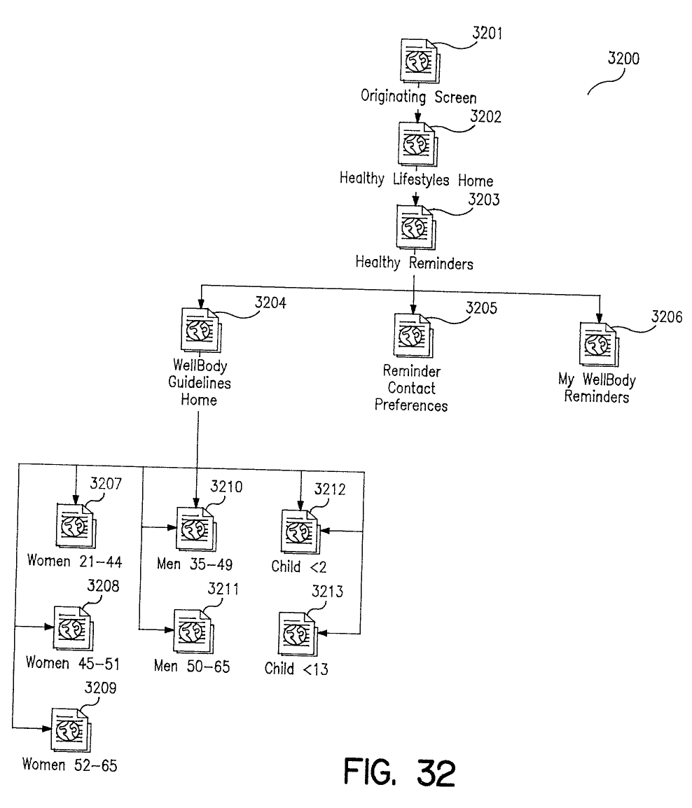

FIG. 32 illustrates an exemplary “healthy lifestyles/reminders” process flow 3200. From the originating screen 3201, a user may access the healthy lifestyles home page 3202, where he or she may select from a living healthy guidelines home page 3204, reminder contact preferences 3205, and “my living healthy reminders” section 3206. The user may further select living healthy guidelines for women 3207-3209, men 3210, 3211, or children 3212, 3213, sorted within the foregoing categories by age.

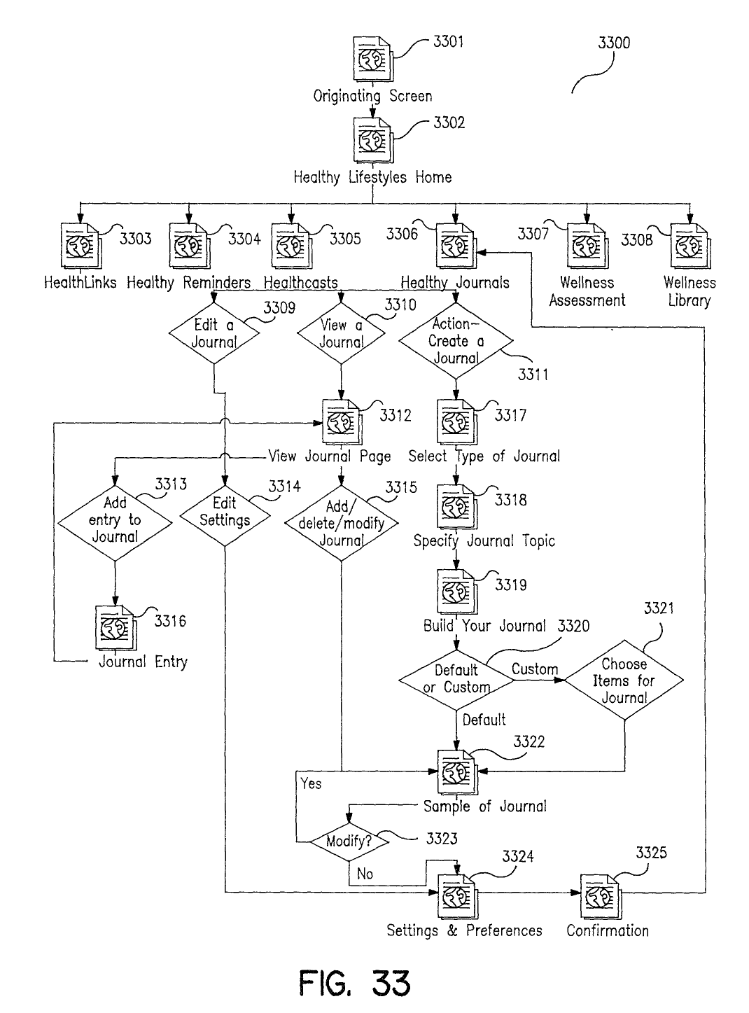

FIG. 33 illustrates an exemplary healthy lifestyles journal process flow 3300. From the originating screen 3301, a user may enter the healthy lifestyles home page 3302, where he or she may choose from among options including “healthlinks” 3303, healthy reminders 3104, “healthcasts” 3305, healthy journals 3306, wellness assessment 3307, and wellness library 3308. Upon selection of healthy journals 3306, the user may opt to edit a journal 3309, view a journal 3310, or create a journal 3311. If the user opts to create a journal 3311, he or she may select the type of journal 3317 and specify the journal topic 3318, build the journal 3319 by choosing 3320 between a custom or default format. If a custom format is chosen, the user may choose 3321 items to customize the journal. If a default format is chosen, the user may view 3322 a sample of the journal and choose whether to modify it 3323. If the user chooses to modify it, the user may return to the sample 3322 to perform such modifications. Otherwise, the user may change settings and preferences 3324, confirm the changes 3325, and return to the healthy journals page 3306.

The user may also choose to view a journal 3310, whereby the user is directed to the appropriate journal page 3312 for viewing and is presented with an option to add, delete or modify the journal entry 3315. The user may add 3313 an entry 3316 to the journal, after which the user may be returned to view the journal page 3312. The user may further choose to edit a journal 3309, in which case the user may choose to edit settings 3314, and then be transported to the settings and preferences 3324 page.

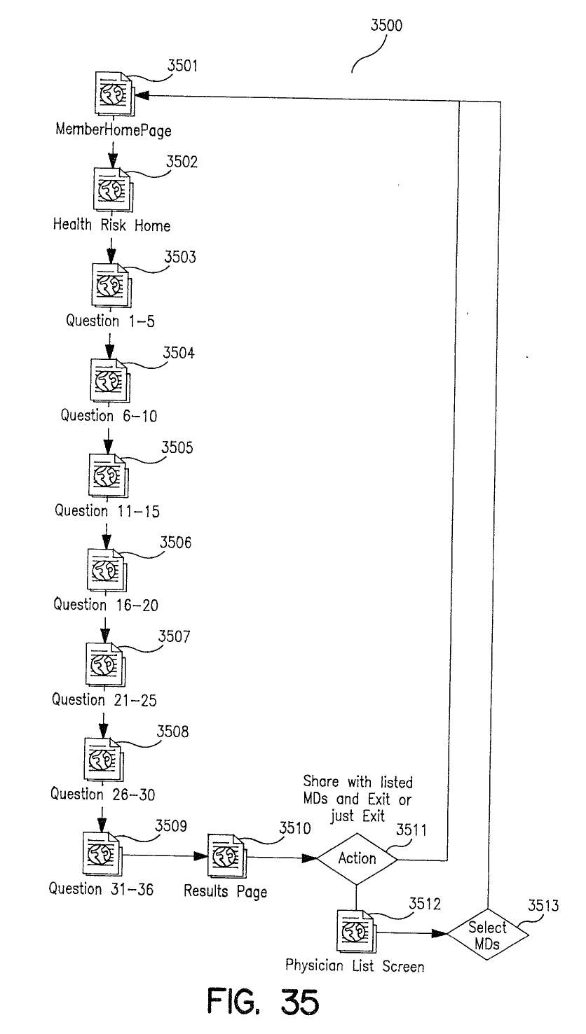

FIG. 35 illustrates an exemplary health risk assessment process flow 3500. From the member home page 3501, the user may access a health risk home page 3502, which presents the user with a plurality of questions 3503-3509, and then displays a results page 3510 based on the answers to those questions. The user may be prompted 3511 whether to share the results with listed physicians. If the user chooses not to share the results, he or she may be returned to the member home page 3501. Otherwise, a physician list screen 3512 is presented, the user may select 3513 physicians to whom the results should be sent, and then he or she may be returned to the member home page 3501.

Returning now to FIG. 9, the member services section 903 may include a provider directory 913, a claims inquiry section 914, an eligibility check/benefits check section 915, an ID request form section 916, an on-line customer service connection section 917, and a member preferences section 918. The provider directory 913 may be a core component of the system. It may allow members employers and physicians to search for providers within zip code ranges. It may be both a free-standing module on the web site under Member Services and also be integrated in places such as the enrollment screens 904.

At any time during the benefit selection process, an employee may be able to choose a “Finding a Provider” button on a navigation bar and search for network doctors, facilities, dentists, pharmacies, or fitness providers (labs or other free standing facilities can be selected, as well, as sub-specialties). The search features may be done by provider name, address, specialty, board certification, distance, and other criteria. Detailed information about the provider may be displayed to the member, including mapping and driving directions. The member may print the information or download it to a file (e.g., Adobe Acrobat).

In the claims inquiry section 914, members may be able to check claim status and claims payment history via the web site. There may be real-time, on-line connectivity with the Claims Payor. The eligibility check/benefits check section 915 may allow members to review or determine their eligibility for certain services and/or benefits. The ID request form section 916 may allow members to request ID cards if theirs have been lost or stolen. The on-line customer service connection 917 may provide an interface for members to access customer service via e-mail, live chat, and/or video, and may include appropriate encryption to maintain security of data transmitted therein.

In the member preferences section 918, members may be able to change the PIN on their ID account, allowing for security and medical privacy for individual members on the account. Additionally, they may be able to turn access on and off for their providers who may need access to HRA and other information. They may also allow for their names and addresses (only) to be shared with third parties who may be soliciting health products. They may have the ability to update a profile to include demographics, primary physician and messaging preferences.

Other functions that may be provided under the member services section 903 include primary physician selection (not shown), which may allow the member to select or change their primary physician. Although the company may not ascribe to a gatekeeper model of enabling healthcare services, having a key physician is important in coordinating patient care. Therefore the selection and change process may ensure ease of use through the retrieval of existing information and linkage to provider directory search capabilities.

As it might become important to provide members with a comprehensive medical record, change history may be date/time stamped and maintained. A Benefit Usage by Category Graph (not shown) may be provided, as this a more summarized version of the Claims Inquiry area. It may provide summaries of claims data by category (e.g. outpatient, inpatient and prescription) for the member and their family members.

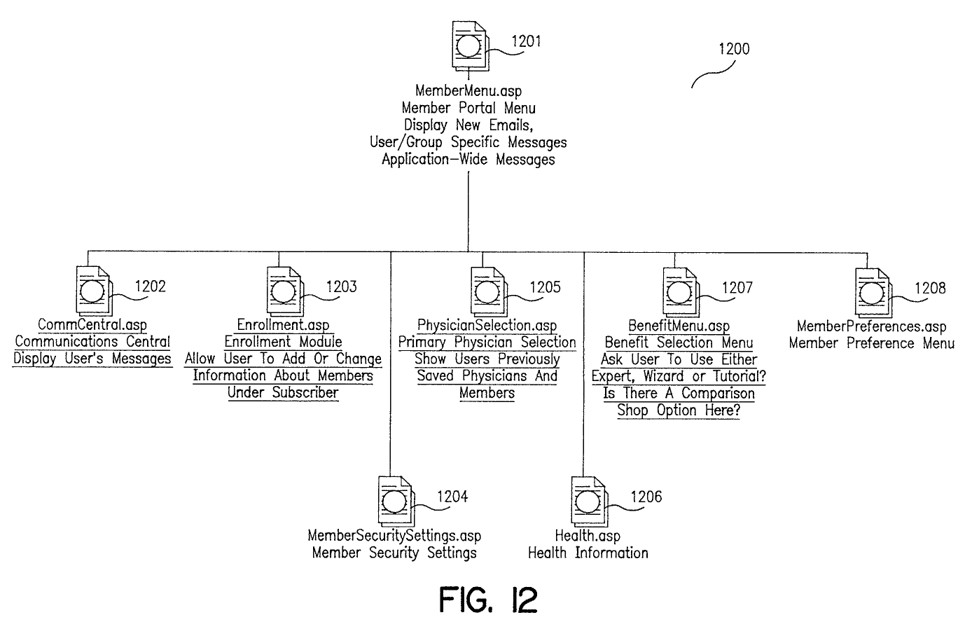

Additional details of the above-described exemplary processes are illustrated in flow charts provided in FIGS. 12-45. FIG. 12 illustrates an exemplary process flow 1200 for an exemplary member menu. At the member portal menu 1201, new emails, user/group specific messages, as well as application-wide messages may be displayed. From the member portal menu 1201, a user may access “Customer Care Center” 1202 to display the user's messages, the enrollment module 1203 to allow the user to add or change information about members (e.g. dependents) under the subscriber's control, member security settings 1204, physician selection 1205 to show the user's previously saved physicians and members, health information 1206, the benefit selection menu 1207, or the member preference menu 1208.

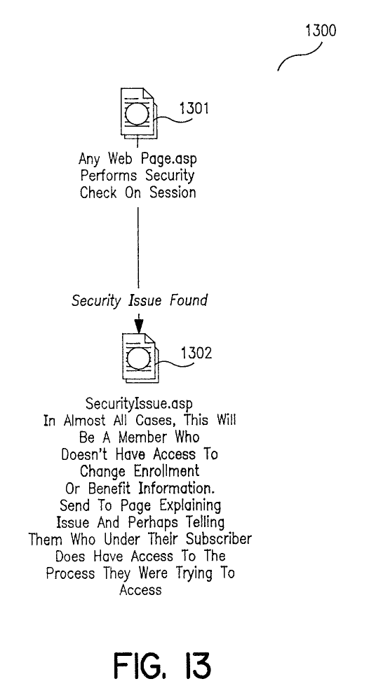

FIG. 13 illustrates an exemplary security process flow 1300, which may be used with any of the herein described web pages. The web page may perform a security check 1301 when accessed, and if a security issue is found (i.e. the user attempting to access the page does not have access rights thereto, the user may be redirected 1302 to a page explaining that he or she does not have access to change enrollment or benefit information, and, indicating who, under their subscriber, does have access to the process they were trying to access.

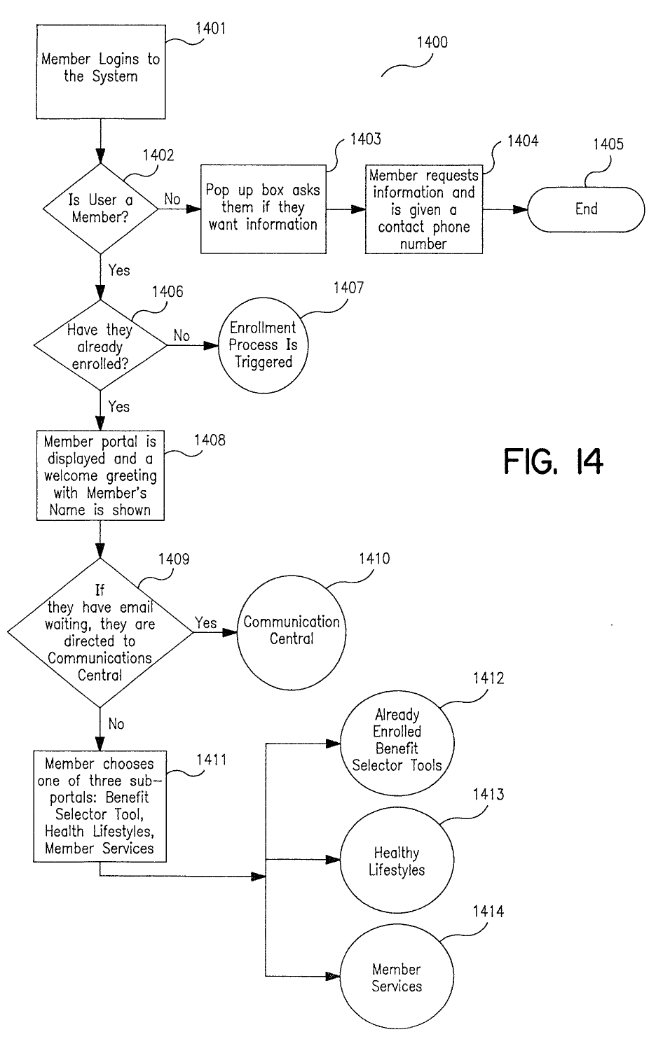

FIG. 14 illustrates an alternative exemplary member entry screen process flow 1400. Upon login 1401, a determination is made 1402 whether the user is a member. If not, a box pops up 1403 asking if the user wants further information (i.e. to become a member), a request for information is made and the user is given 1404 a contact phone number, at which point the process terminates 1405. If the user is a member, a determination is made whether the user has already enrolled 1406. If not, the enrollment process is triggered 1407. If so, the member portal is displayed and a welcome greeting with the member's name is shown 1408.

A determination is made whether the existing member has mail 1409, in which case they are directed to Customer Care Center 1410. Alternatively, a message may appear in a pop-up box asking whether they would like to open their mail. If they select yes, they may jump directly to Customer Care Center 1410 and their messages may be automatically brought up. If they select no (or if there is no user email) the pop-up box may disappear and they may be free to navigate the site 1411, by selecting a benefit selector tool for members already enrolled 1412, the healthy lifestyles section 1413, or member services 1414. Until their messages are clear, the pop-up box may appear each time they log into the site.

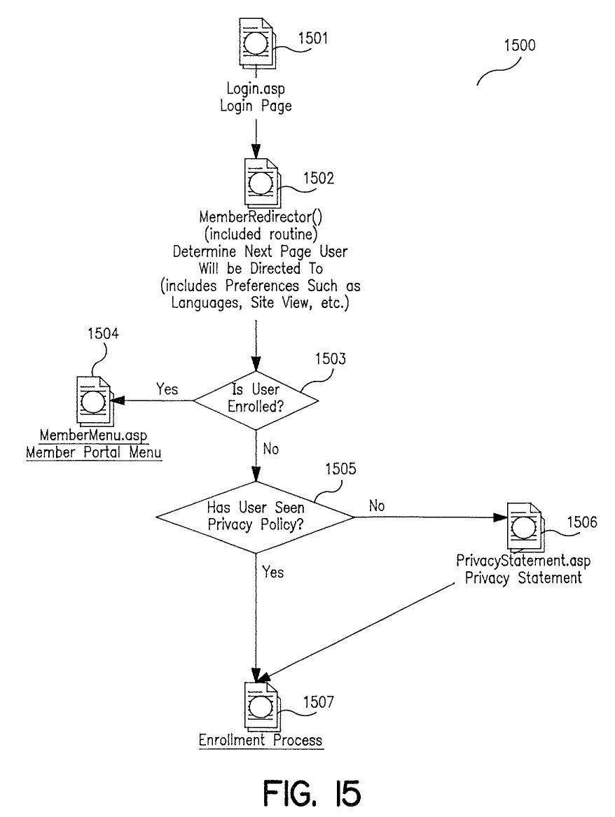

With reference now to FIG. 15, an exemplary member login process flow 1500 is illustrated. Upon selection of the Members only portal, the end-user may be prompted to log in 1501 using their SSN and PIN, or other similar security means, and the system determines 1502 the next page to which the user will be directed (including, e.g., preferences such as languages and site view). If the entry is invalid the user may be prompted to re-enter or move to the Contact Information screen for information about becoming a member. If the entry is valid, the system may discern 1503 whether the user is a new or existing member. If the user is a new enrollee, a determination is made 1505 whether the user has seen the site's privacy policy and/or statement. If not, a privacy statement is displayed 1506 and the user may be prompted to consent to the policy, after which the user may be carried to the enrollment screen 1507. If the user has already seen and/or agreed to the privacy policy, the user may be carried directly to the enrollment screen 1507. If the user is an existing member, the full portal components menu may appear 1504 for further navigation. If a user is enrolled in multiple groups, he or she may be prompted to choose one of the groups, if such a choice is required.

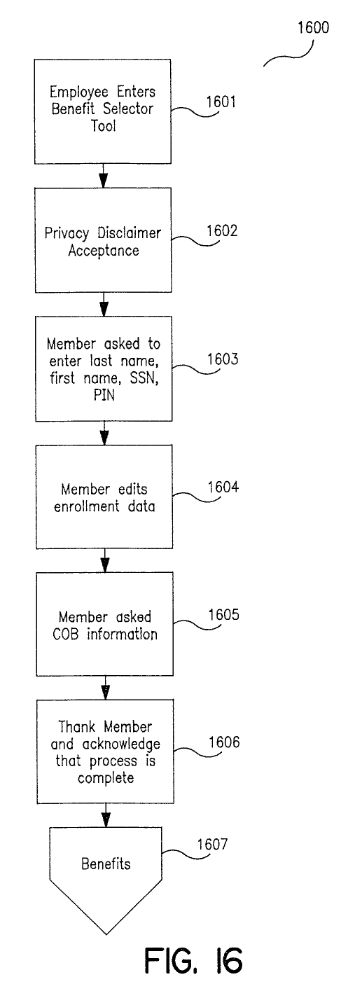

FIG. 16 illustrates an exemplary enrollment process flow 1600, which begins by the employee entering 1601 the benefit selector tool and accepting 1602 the terms of a privacy disclaimer or policy. The member is asked 1603 to enter his or her last name, first name, social security number, and PIN. The member may then edit 1604 enrollment data. The member may then be asked 1605 coordination of benefits information. The member is then displayed 1606 a message thanking him or her for enrolling and acknowledging that the process is complete, after which the member is taken to the benefit selection process 1607.

The enrollment screen may contain all of the “typical” enrollment data required in order to process a member into a health plan's eligibility database. The member SSN and PIN number described in the beginning of this section may have a flag attached if data is going to be imported. Subscribers may be provided with an initial, system generated PIN that can be used for their first entry into the system as well as to obtain PINs for other family members over the age of 18.

After completion of the basic enrollment information, the member may be prompted to select primary care physicians for themselves and their family members. They may be provided with a search option for each physician using the technology outlined in the Provider Directory/Primary Physician section below. After full subscriber and member enrollment information is complete, the member may be asked to confirm the information. At that time they may be offered the option to either complete a Health Risk Assessment, Configure Benefits or Confirm and Exit. Menu options via left navigation may have Member Preferences exposed to facilitate the confirmation of member preferences.

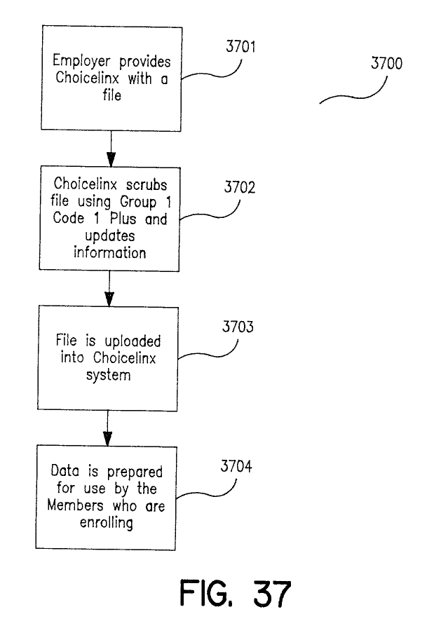

In addition to manual entry of enrollment information, the company management may work with the Benefits Departments of the employer in order to obtain a data download of all basic enrollment information. That way the member does not need to type it in “fresh”—instead they can verify/modify and edit missing/incorrect data to speed things up. An exemplary process flow 3700 for the data importation process is illustrated in FIG. 37. As shown, the employer may provide 3701 the company with a file. The downloaded file may be scrubbed 3702 using, e.g., Group 1 Code 1 Plus address standardization software, in order to guarantee accuracy of all data fields. The file is uploaded into the company system 3703, and data is prepared 3704 for use by the members who are enrolling.

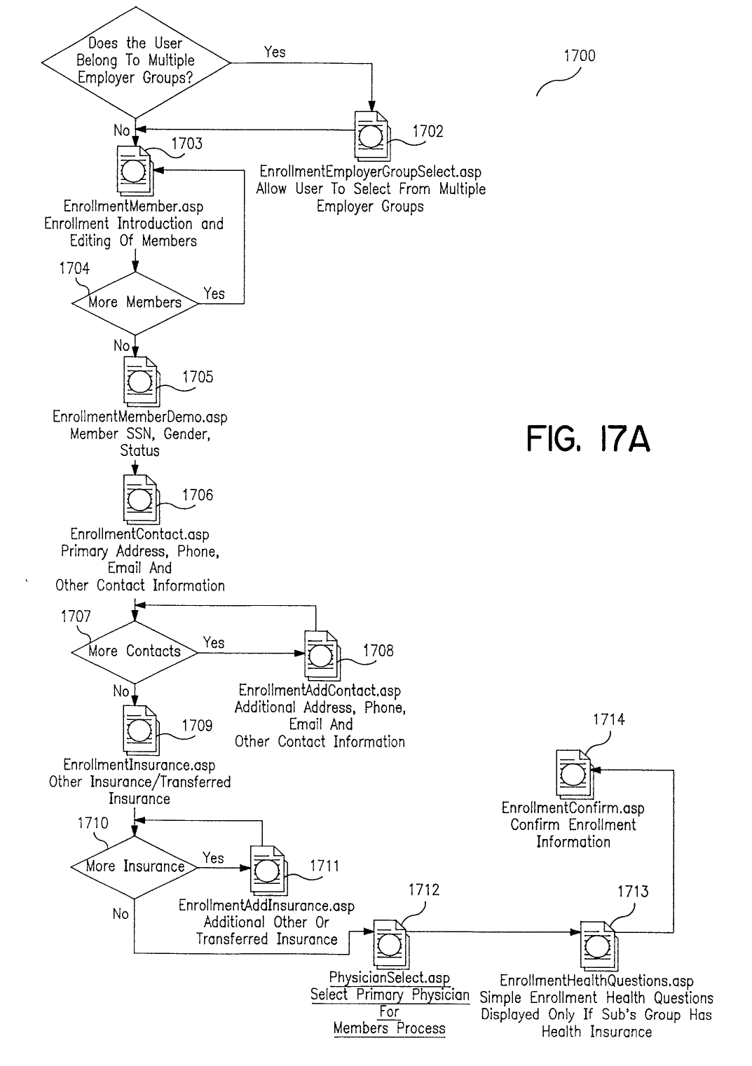

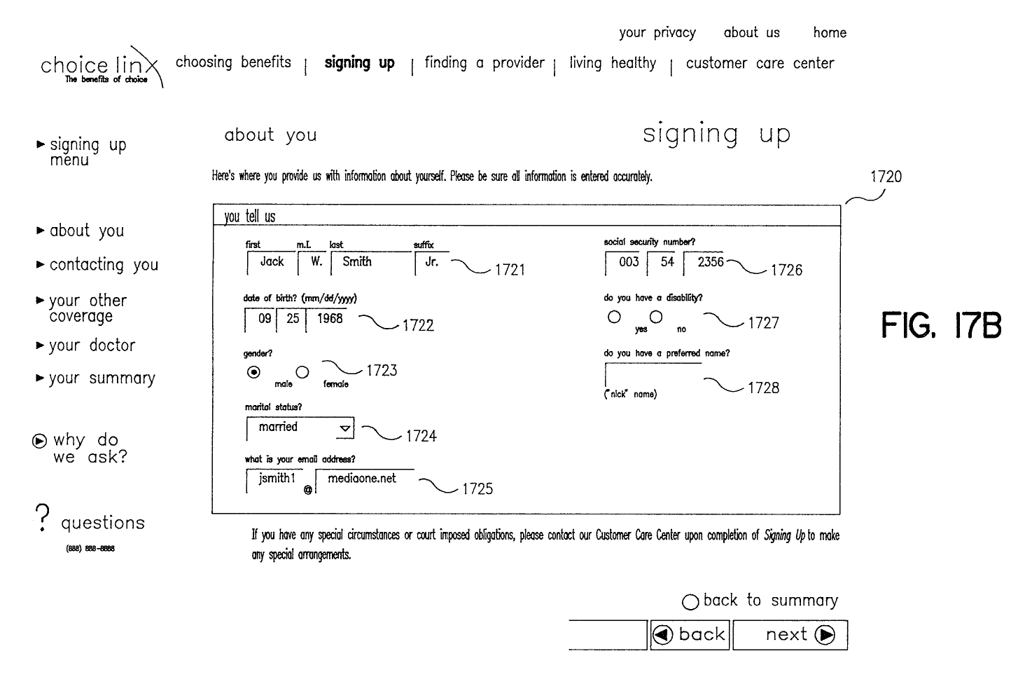

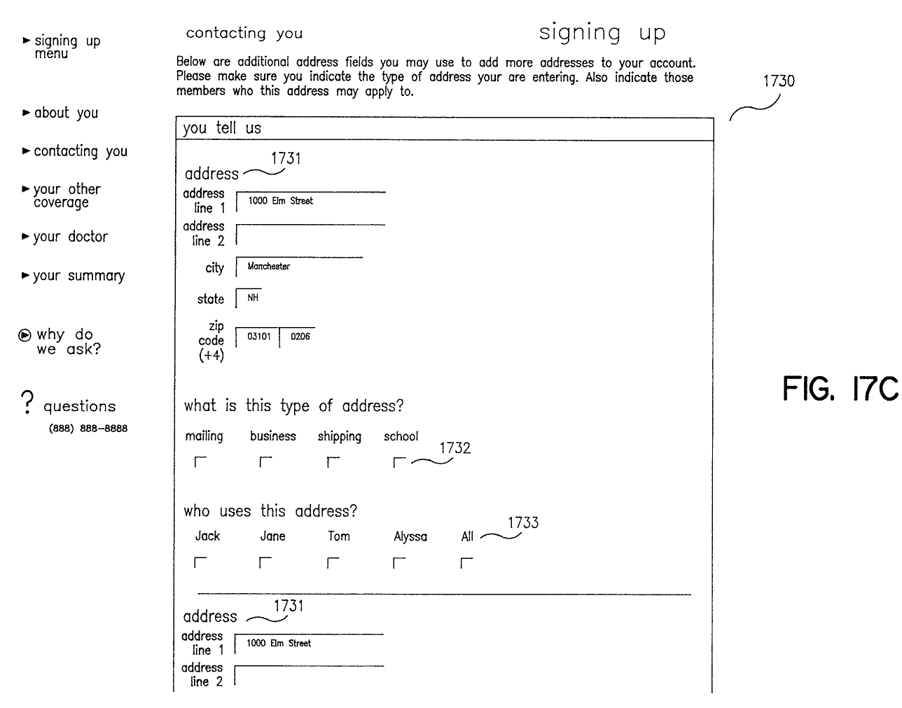

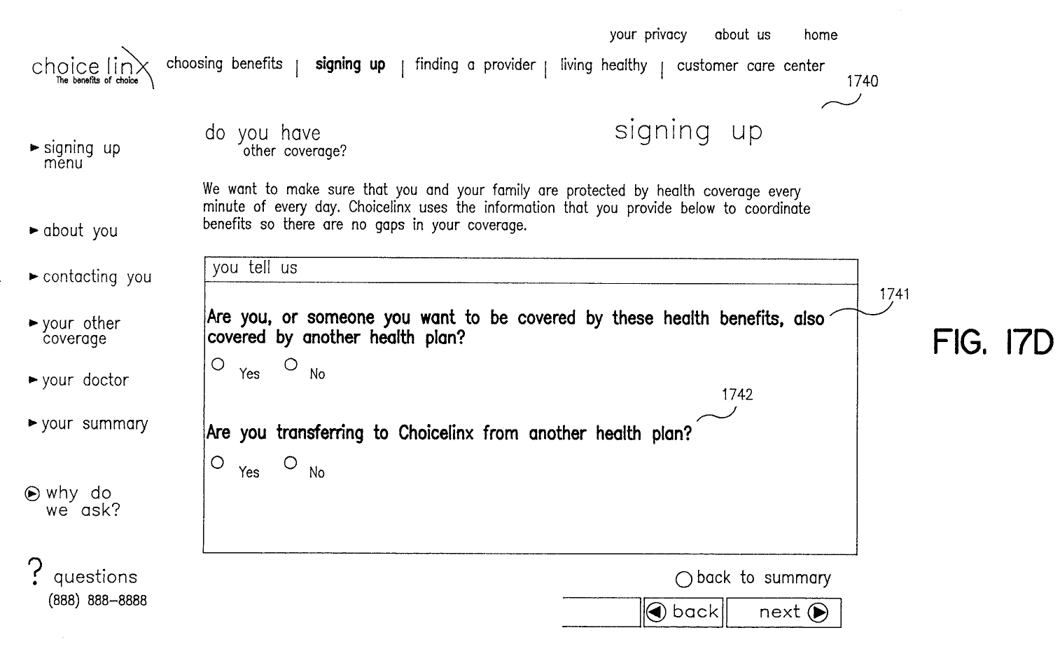

FIG. 17A illustrates an alternative enrollment process flow 1700 in one embodiment of the invention. As shown, a determination may be made 1701 whether the user belongs to multiple employer groups. If so, the user may be prompted to select 1702 from those groups, before proceeding. If not, the user may be led 1703 to an enrollment introduction and member editing section. The user may be asked 1704 whether there are further members for whom information is to be entered, and if so, the user may again be led 1703 to an enrollment introduction and member editing section. Otherwise, the user may be prompted 1705 to enter his or her member social security number, gender, and status, as well as 1706 primary address, phone number, and other contact information.

A determination may be made 1707 whether there is further contact information to be added, and if so, such additional information may be entered 1708. Otherwise, insurance information may be entered 1709, including information regarding other insurance or policies, as well as transferred insurance. A determination is made 1710 whether there is further insurance information to add, in which case such additional information may be entered 1711. Otherwise, the user may be led to select 1712 a primary physician, answer simple enrollment health questions 1713 (which questions may only be displayed if the subscriber's group has health insurance), and the user is asked to confirm 1714 enrollment information.

The enrollment health questions 1713 may be asked subsequent to enrollment to help guide the user towards enhanced medical management services, if appropriate. For example, they may be asked whether they or someone in their immediate family have a history of Asthma, Other Lung Disease, Diabetes, or Heart Disease. They may be able to specify who in their family has each of the ailments.

As part of the enrollment process, the employee may also complete a Health Risk Assessment for each member in the family, for which the data may be stored permanently in the member's record. After completion of the information, the member may be asked whether or not the information may be released electronically to the member's physician(s). Until the member completes the HRA and indicates share permission is granted, the flag may remain at N. A drop down list of providers may default to the name of the Personal Physician (if one was selected) and there may be an opportunity to select multiple physicians if so desired.

The member can also “save” a copy of the HRA recommendations in their personal health file for future access (see the Healthy Lifestyles section). They can also print out the recommendation information at this time. If a disease management flag is tripped based on the information that has been entered, the member may be told that a case manager may contact them and/or an information screen may point them to the Healthy Lifestyles section where they can find out more information about their particular disease/condition.

FIG. 17B illustrates an exemplary enrollment screen view 1720, with fields for the enrollee to complete, including name 1721, birth date 1722, gender 1723, marital status 1724, email address 1725, social security number 1726, disability status 1727, and nick name 1728. As another exemplary enrollment screen view 1730 of FIG. 17C illustrates, additional information may be entered in fields on a separate screen, including additional addresses 1731, which may be a combination of different address types corresponding to a single member, or different addresses for different members, or a combination of the two. The address type may be specified 1732 via a check box interface, and the member or members corresponding to each address may be specified 1733 via a check box, as well.

As another exemplary enrollment screen view 1740 of FIG. 17D illustrates, the user may be prompted to answer whether additional insurance exists 1741, as well as whether the user is transferring to the company from another health plan 1742. The foregoing screens, which may comprise text and drop down boxes, allow an employee to enter comprehensive information about themselves and their family members. This functionality may allow for the storage of multiple addresses and phone numbers, easily segregated by family member and type, with indicators for contact preferences.

Additionally, the system may capture information regarding a member's disability status to provide an extended level of benefits, full-time college student status for life-event tracking, email for reduced paper transactions and nicknames for personalization. Members may also indicate, up-front whether they have other covering benefits to establish primary/secondary status for claims payment, as well as transferring insurance information to easily comply with portability requirements when pre-existing clauses are in effect.

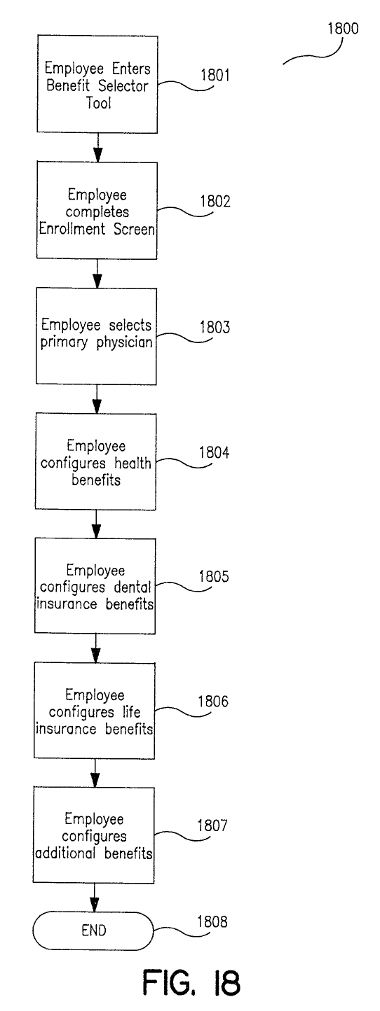

FIG. 18 illustrates an exemplary high-level benefit selector tool process flow 1800. The employee enters 1801 the benefit selector tool and may complete 1802 an enrollment screen. The employee may select 1803 a primary physician and configure health benefits 1804, dental insurance benefits 1805, life insurance benefits 1806, and additional benefits 1807, at which point the selection process may terminate 1808.

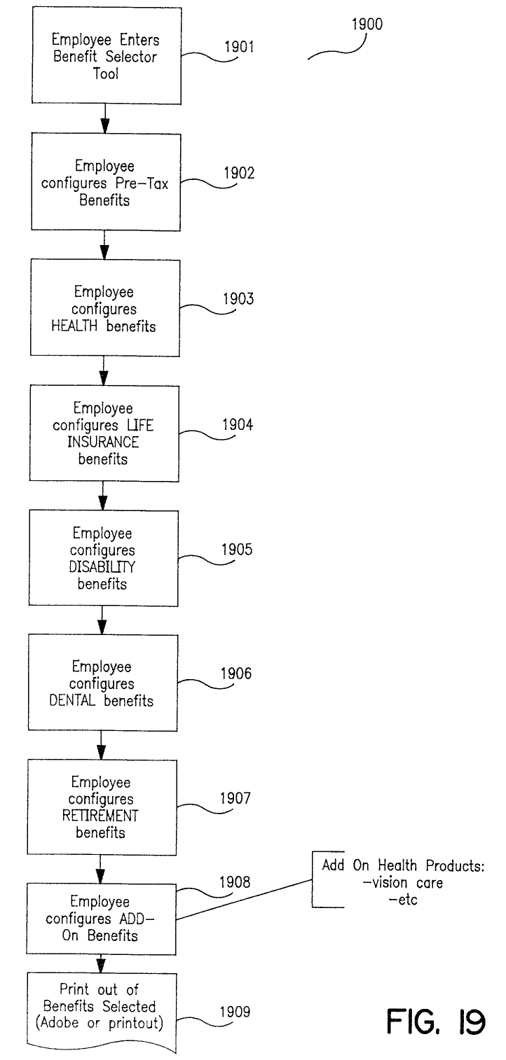

An alternative exemplary member expert benefit builder process flow 1900 is illustrated in FIG. 19. As shown, the employee enters 1901 the benefit selector tool. A base benefit package selected by the employer will be displayed initially. The member may then modify the base package to enhance his or her benefits. Certain benefits may only be modified at the subscriber level, while others at the family level, in order to control for underwriting risk. The employee may configure pre-tax benefits 1902, health benefits 1903, life insurance benefits 1904, disability benefits 1905, dental benefits 1906, retirement benefits 1907, and add-on health benefits 1908 (e.g. vision care), and then receive 1909 a printout or display of the selected benefits (e.g. In Adobe Acrobat or other printable format). During this process, there may be constant monitoring of pre-tax and post-tax dollars, as well as constant monitoring of the four types of input dollars (employer contribution, required employee contribution, voluntary employee contribution, and fitness incentive dollars) and how they are being spent.

It is noted that a unique feature of the system is the ability to up-sell services on a pre- or post-tax basis. Consumers may decide, for instance, whether or not they wish to buy a third dental cleaning or an annual eye exam. They may also purchase products such as pharmacy discount cards, a Personal Care Coach, or disease management programs for family members. Depending on the benefit, these will be either pre- or post-tax deductions from the employee's paycheck. These up-sell services may eliminate, in many cases, the need for an employee to utilize a flexible spending account and submit separate reimbursement accounts.

The benefit configuration screen may be the core of the Benefit Selector Tool section. As users navigate through the site, they may be able to see changes in the resource meter and “How it adds up”. This Meter may show them how many Employer Contributed dollars are available to them, as well as how many Member Contributed dollars have been spent. Prior to selecting benefits they may be welcomed to the benefits selection portion of the site and provided with either a pre-filled calculator that may help to configure their “How it adds up” feature or an empty calculator. They may have the option of disabling the feature and moving directly to benefits configuration, with the option of enabling it again at any time. If the data is pre-filled, they may have the option of editing it for accuracy.

As the member continues to navigate through each of the benefits sections (e.g. health, life, dental, retirement, disability, charitable, flexible spending, prevention and wellness, medical services financing, alternative medicine, uncovered services, disease management, integrated financial and other services) they may see similar dynamic changes in the resource meter that reflects the impact of the selection made. These changes may be based on actuarial algorithms. The resource meter may automatically be updated as the member moves from benefit to benefit, or they can choose to update at any time by hitting an update resource meter button. Members may also have the option to hit a help button next to the paycheck to get detailed information on the breakdown of contributions by category on a pre and post-tax basis.

A user may have the option at any time of completing the transaction or canceling out. If the transaction is completed prematurely, whereby benefits designated by the employer have not been configured, messaging may occur to inform the member of remaining options. The messaging may ask them whether they want to submit a waiver of insurance coverage. If they choose yes, they may be carried directly to a page within the member services area that contains all of the required disclaimer language. They may be given the option, at the completion and submission of the waiver to continue configuring benefits with the remaining voucher funds.

The member may also have the option to exit prior to confirmation while saving the data compiled up until that point. This may enable them to edit only that which is necessary prior to confirmation without having to re-key each data element.

As the member selects each of their health benefits, the following exemplary rules may apply:

| Rule | Rule | | | |
|---|---|---|---|---|
| Category | Category | Rule | | |
| Code | Description | Number | Rule Description | Rule Message |
| 1 | Dental | 1 | Prompt with message | For an additional $4.00 per |
| | | | after dental services | person per month you can |
| | | | selection. | obtain an extra cleaning each |
| | | | | year, for a total of 3 cleanings |
| | | | | per person, per year. |
| 2 | HRA | 2 | If HRA answer = Y, | Based on the information |
| | | | then show message | you provided, we |
| | | | after office visit | recommend that you select a |
| | | | selection. | personal health coach who |
| | | | | can assist you in developing |
| | | | | your living healthy roadmap. |
| 3 | Cosmetic | 3 | If salary > $30,000 | Would you like to set aside |
| | | | and age >30 or if | money from each paycheck |
| | | | member_state = NY or | for cosmetic services? |
| | | | CA, then show | |
| | | | message after hospital | |
| | | | professional services | |
| | | | selection. | |
| 4 | Alternative | 4 | If member selects | Would you like to set aside |
| | | | alternative benefits, | money from each paycheck |
| | | | then show message. | for cosmetic services? |
| 5 | PT | 5 | If member selects low | Would you like to set aside |
| | | | PT co-pay, then show | money from each paycheck |
| | | | message. | for massage therapy or other |
| | | | | non-covered alternative |
| | | | | health services? |
| 6 | Pharmacy | 6 | If HRA answer = Y, | In order to reduce your out |
| | Mail | | then show message | of pocket expense and |
| | | | before office visit co- | maximize your benefits, we |
| | | | pay selection. | recommend that you select a |
| | | | | low office co-pay, mail order |
| | | | | pharmacy and enhanced |
| | | | | living healthy, well mind |
| | | | | management benefits? |
| 7 | Living | 7 | Prompt after | Would you like to add pre- |
| | Healthy | | diagnostic testing | tax dollars for items such as |
| | Assessment | | services selection. | glasses, contacts or other |
| | | | | services? |
| 8 | Pharmacy | 8 | If select $5 co-pay, | |
| | Co-pay | | pharmacy choices are | |
| | | | 10/15/25, 10/20/25, | |
| | | | 15/25/35. | |
| 9 | Network | 9 | If network contract = 1, | |
| | | | then coinsurance type | |
| | | | (10%, 20%, 30%). If | |
| | | | network contract = 2, | |
| | | | then co-pay type ($5, | |
| | | | $15, $25). | |
| 10 | Service | 10 | Prompt with message | If you agree to e-mail only |
| | | | after configuration of | customer service, you can |
| | | | preventive care | save $3.00 per family |
| | | | services. | member per month. Our e- |
| | | | | mail guarantee ensures that |
| | | | | you may have a response |
| | | | | within 15 minutes during |
| | | | | regular business hours. |
| 11 | Classes | 11 | If member selects Y at | As an added benefit to the |
| | | | rule 2, then display | Enhanced Living healthy, |
| | | | message with | Well Mind Management |
| | | | hyperlink. | program, you are eligible for |
| | | | | Education and Wellness |
| | | | | classes. |
| 12 | Getaway | 12 | Prompt with message | Would you like to set aside |
| | | | after full health | money from your paycheck |
| | | | configuration. | to save for a Health Retreat |
| | | | | or Day Spa Services. |

The member may then be carried through each of the benefit options in order of benefits required by the employer (such as STD, LTD, Health) and pre to post tax. Tax status may be determined subsequent to consultation with Employee Benefits Specialists.

Dollars may be calculated according to the allocation algorithm and upon movement from pre to post tax status, any remaining employer dollars may be run against the tax rate table for the member's salary level and payroll schedule, tax may be calculated and subtracted, leaving a net employer dollar figure for use in purchasing additional benefits. There may be hyperlinks for each benefit option to provide the member with a concise, user-friendly description of the services entailed.

Upon completion of benefits configuration, a confirmatory e-mail may be sent to the member and employer. Messaging to the latter may be sent in batch (in one e-mail with a list of employees who have completed the process) to reduce administrative overhead for the client. Each employer may have the ability to “turn-off” a benefit or enable messaging that specifies the “services are exempt from employer contributions”.

The employee may have the ability at the end of each benefit section to hit a button to calculate their post-tax pay. This may use the same tax rate table as is used in the progression from pre and post tax status, deducting all 125 benefits from the gross pay, applying the appropriate tax, and deducting all non-125 benefits from the net pay for a pay period amount. If they select the calculation when the still have remaining employer dollars, the non-125 benefits may be deducted from gross, then the remaining employer dollars may be added to the net pay and tax applied according to the table for a pay period amount.

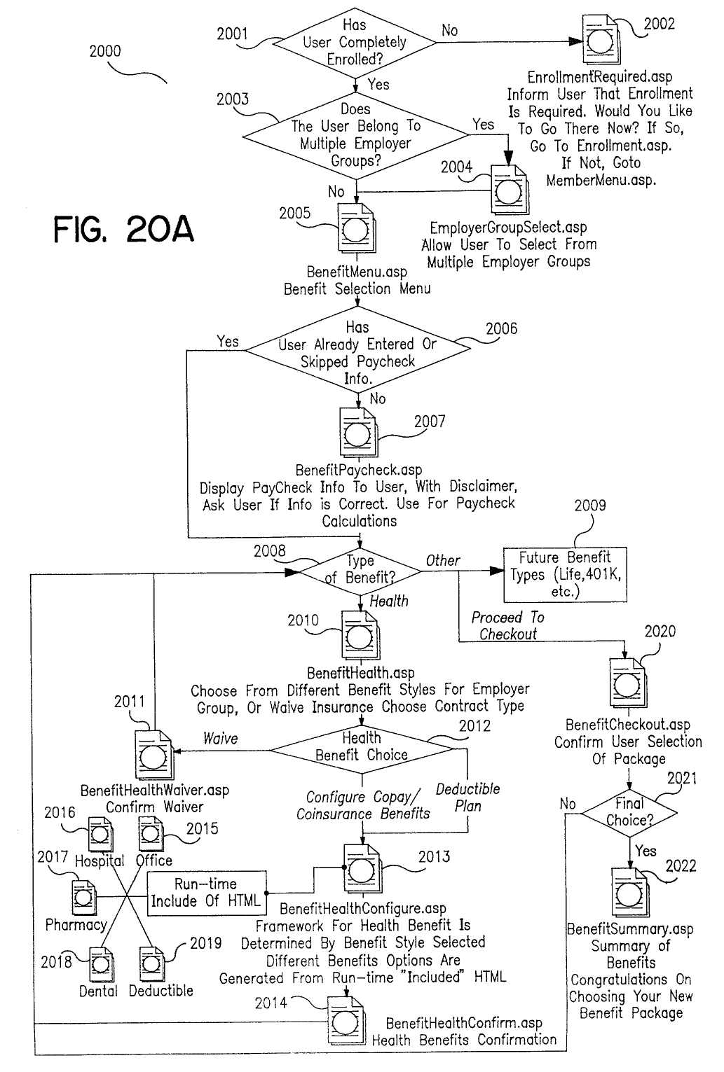

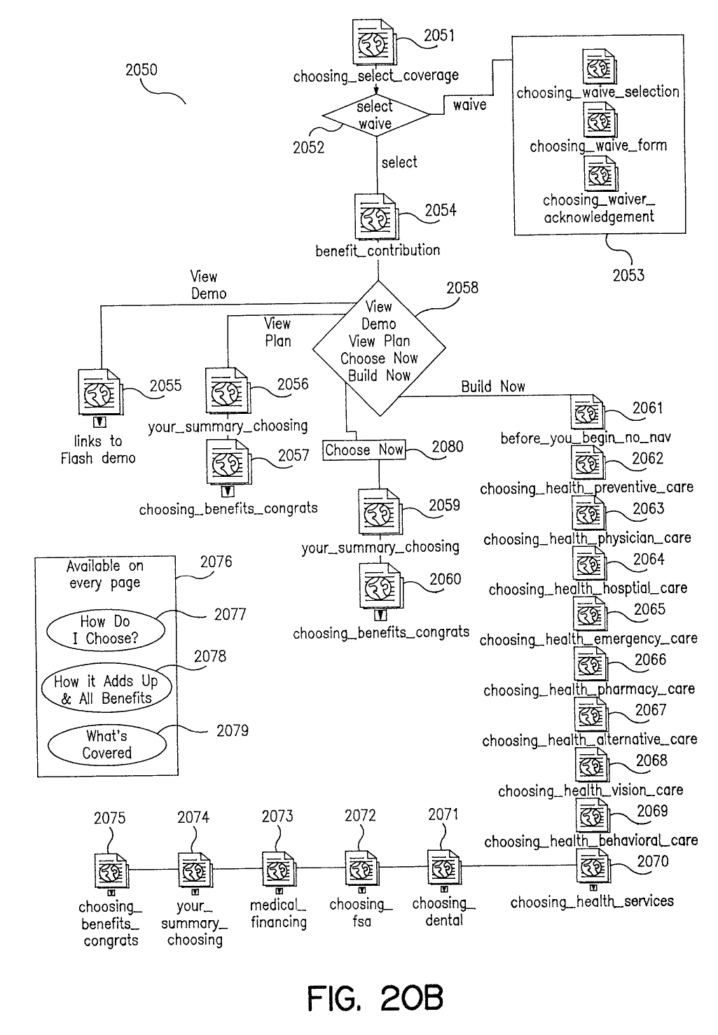

FIG. 20A illustrates one exemplary process flow 2000 for the benefit selection process. As shown, a determination may initially be made 2001 whether the user has completely enrolled. If not, the user may be informed that enrollment is required 2002 and be taken to the appropriate enrollment screens. If the user has completely enrolled, a determination is made 2003 whether the user belongs to multiple employer groups, in which case the user may be permitted 2004 to select from among multiple employer groups before proceeding. Otherwise, the user may be taken 2005 to the benefit selection menu.

A determination may then be made 2006 whether the user has already entered or skipped entering paycheck information. If the user has not entered the required information, the user may be presented 2007 with his or her paycheck information, with appropriate disclaimers. The user may be prompted whether the information is correct, and if so, the information may be used for paycheck calculations. The user is prompted to select 2008 the benefit he or she wishes to configure, and may be taken 2009 to a separate section to configure certain benefit types (e.g. future benefit types, such as life insurance and 401(K)).

The user may choose 2010 from different benefit styles for the employer group, or waive insurance for certain types of coverage, as well as choose the type of contract he or she wishes to have. If a waiver is requested, the user may be required to confirm 2011 that he or she is waiving a particular type of coverage before proceeding. Further health benefit choices may be made 2012, including configuring consumer cost sharing items such as co-pay/co-insurance, deductibles, maximum out of pocket expenses, access to discount programs, etc.

A framework for health benefits 2013 may be determined by the benefit style selected (including, e.g., deductible benefits 2019, dental benefits 2018, pharmacy benefits 2017, hospital benefits 2016, and provider's office benefits 2015), and different benefits options may be generated to display to the user 2014 for confirmation. Once the selection is finished, the member may proceed to “check out”, where he or she may confirm 2020 the package selection. If the choice is final 2021, the user is presented 2022 with a message of congratulations on choosing the new benefit package. If the choice is not final, the user may return 2008 to choose another benefit type.

FIG. 20B illustrates another exemplary high-level process flow 2050 for the benefit selection process. A user begins with the coverage selection screen 2051, from which the user may select or waive 2052 coverages. If the user wishes to waive coverage, he or she may be required to 2053 select the coverage he or she wishes to waive, complete an electronic “form” containing all of the required disclaimer language, and acknowledge the waiver.

The user then is presented with the benefit contribution 2045 screen, from which he or she may choose 2058 whether to view a demo, view the plan, “choose now”, or “build now”. As selected, a demo (e.g. in Flash format) may be presented 2055 to instruct the user how to choose benefits or perform other such system functions. The user may view a summary 2056 and be presented with a “congratulations” message 2057 upon choosing to view the plan. Similarly, after choosing a plan 2080, the user may view a summary 2059 and be presented with a “congratulations” message 2060 upon choosing the “choose now” option.

If the user selects the “build now” option, he or she may initially be presented 2061 with “before you begin” introductory information, prior to the building operation. The user may then choose line items from within each benefit category (e.g., health care), one “line item” at a time, e.g., preventative care 2062, physician care 2063, hospital care 2064, emergency care 2065, pharmacy care 2066, alternative care 2067, vision care 2068, behavioral care 2069, health services 2070, dental care 2071, flexible spending account 2072 (i.e. for medical expense reimbursement), and medical financing 2073. Once the selection is complete, the user may view a summary 2074 and be presented with a “congratulations” message 2075 upon choosing the “choose now” option. Certain features, explained in further detail herein, may be made available for selection to the user 2076 during each of the foregoing steps, including “how do I choose?” 2077, “how it adds up & all benefits” 2078, and “what's covered” 2079.

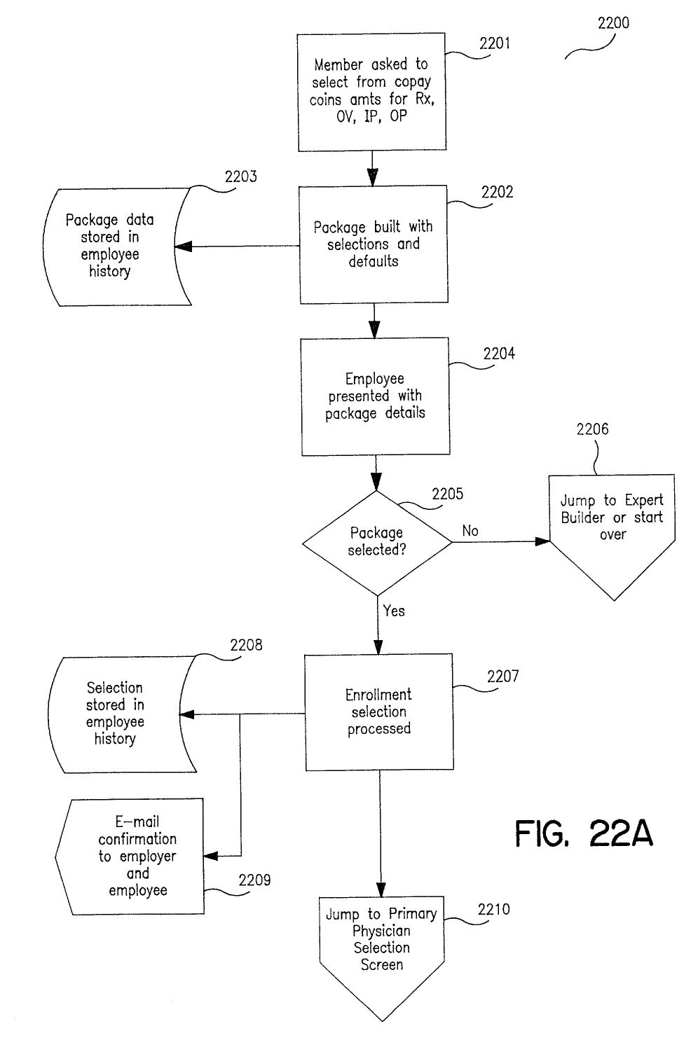

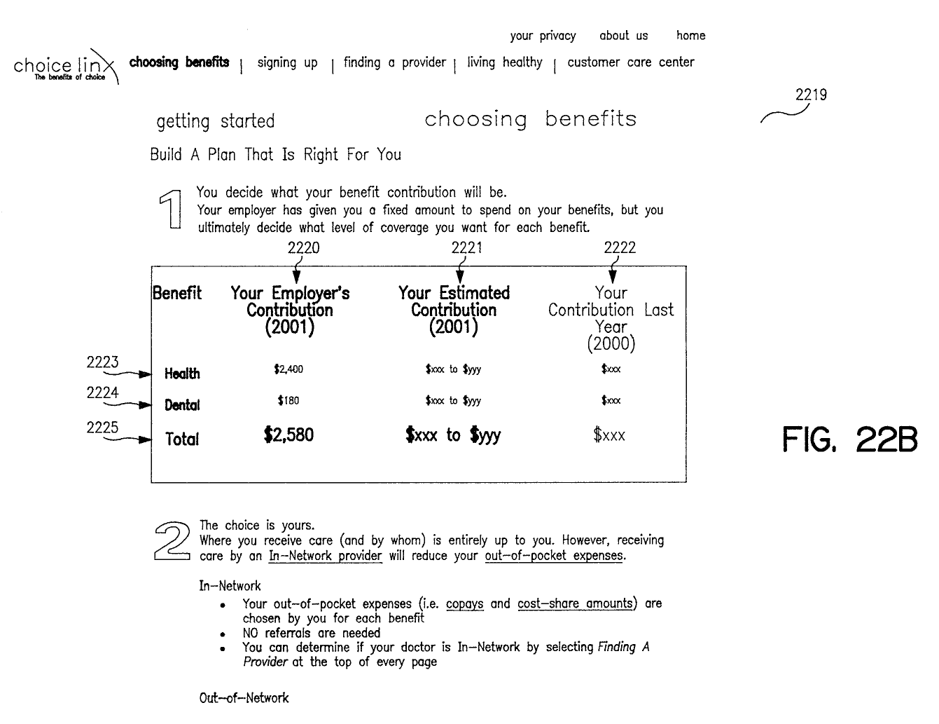

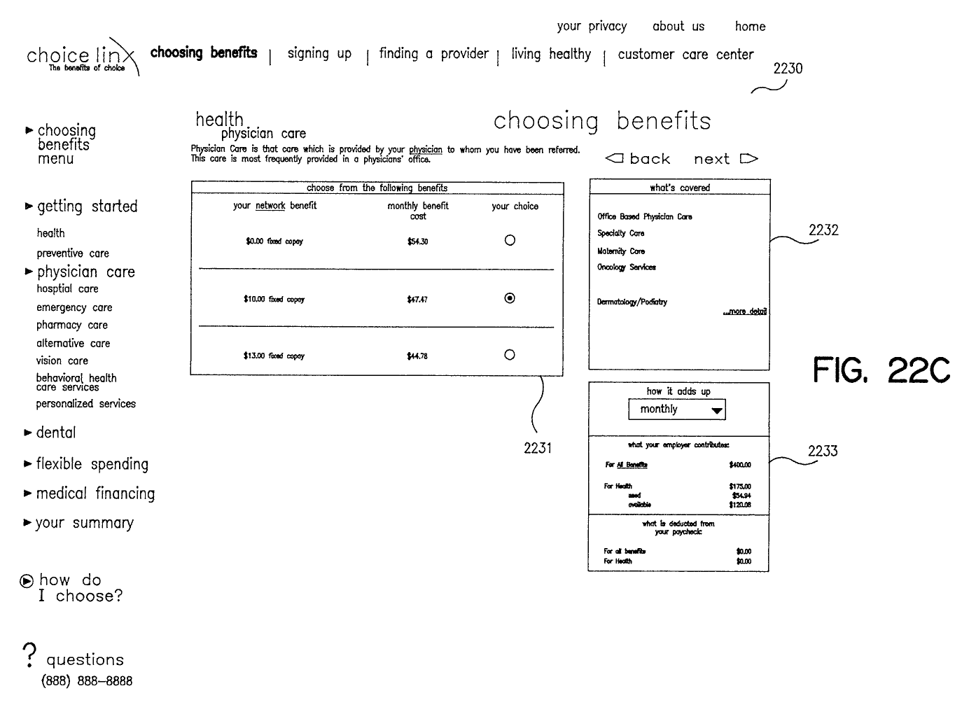

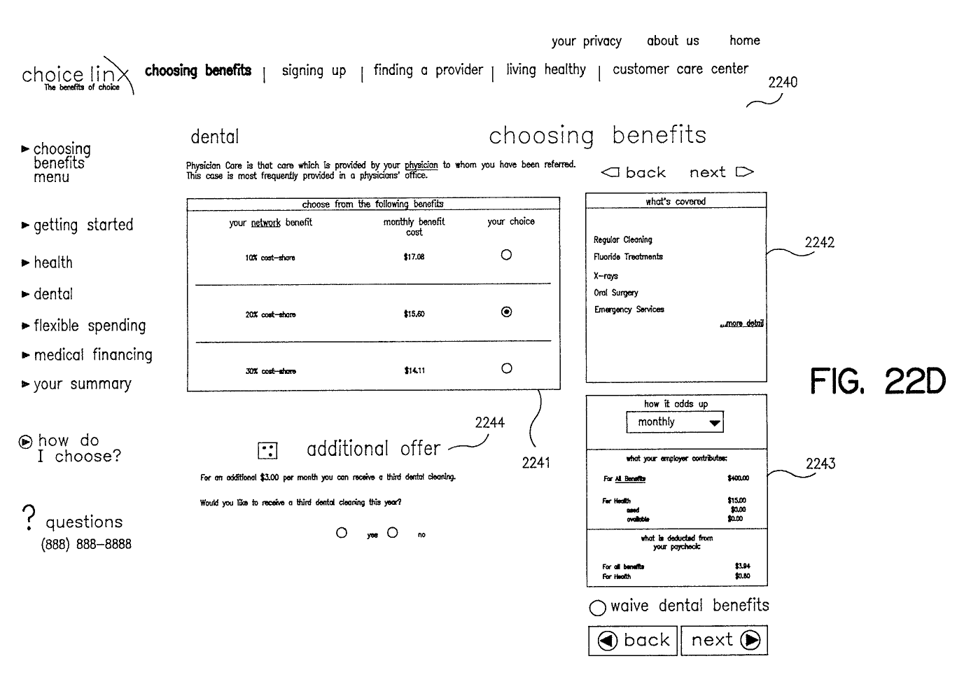

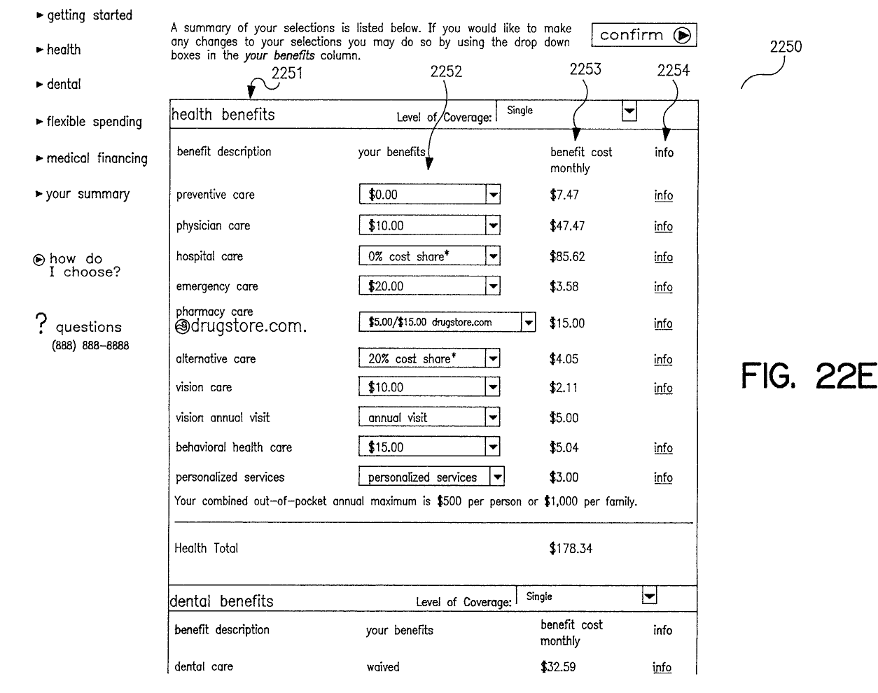

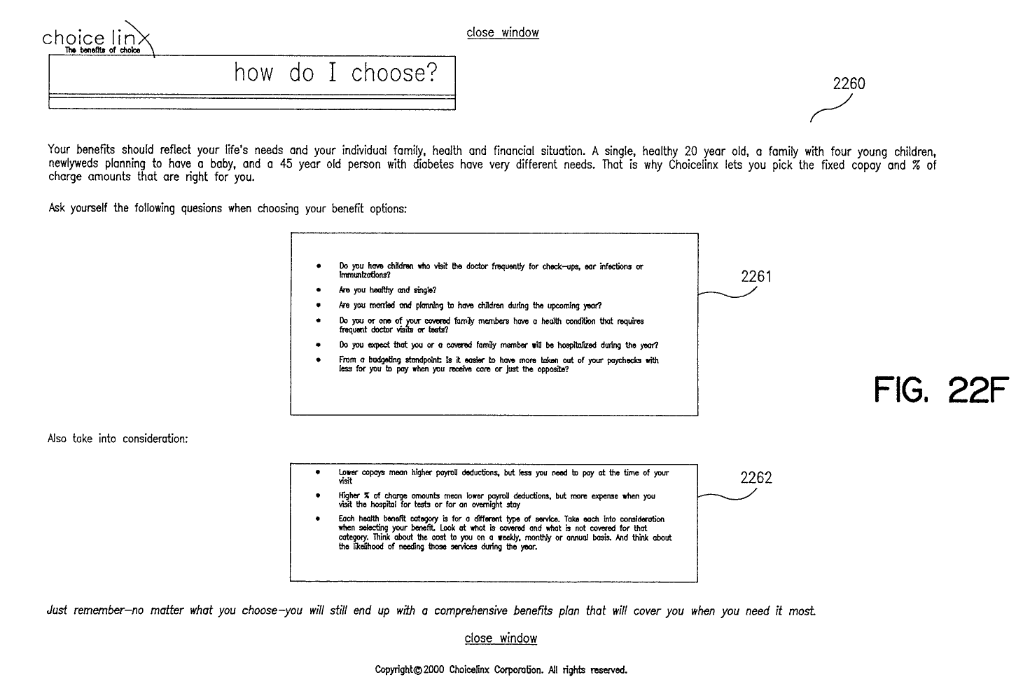

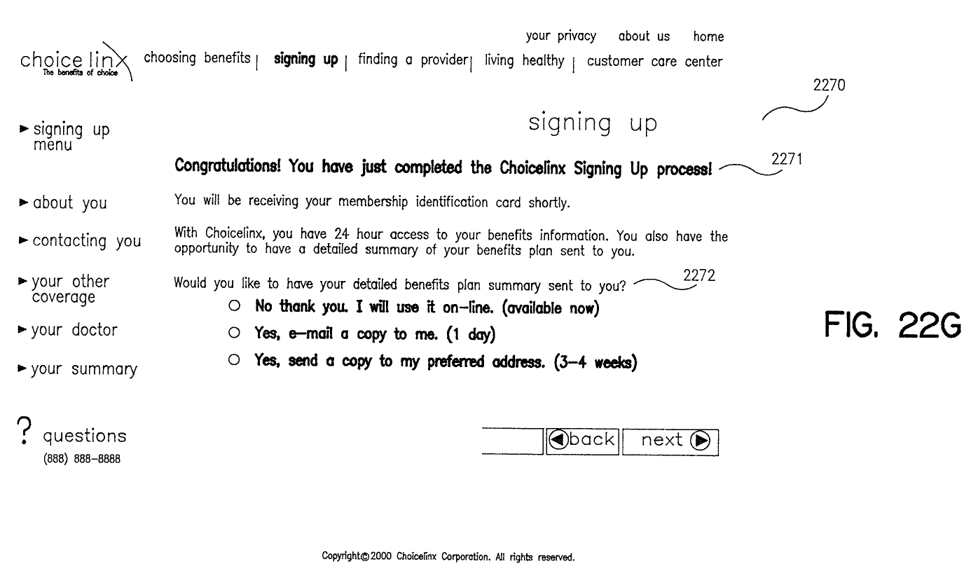

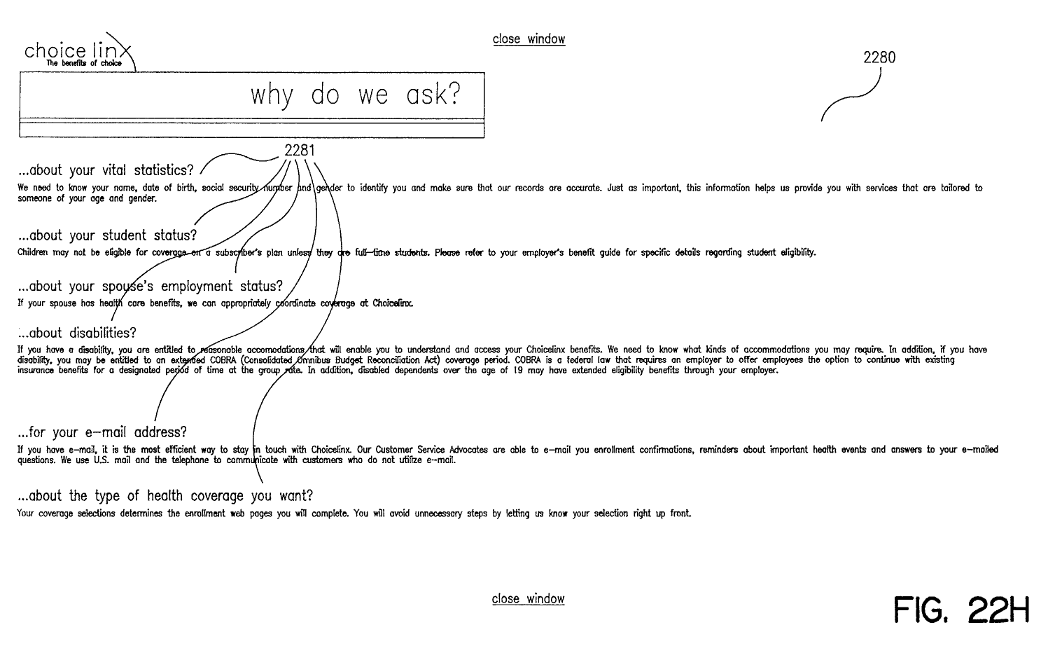

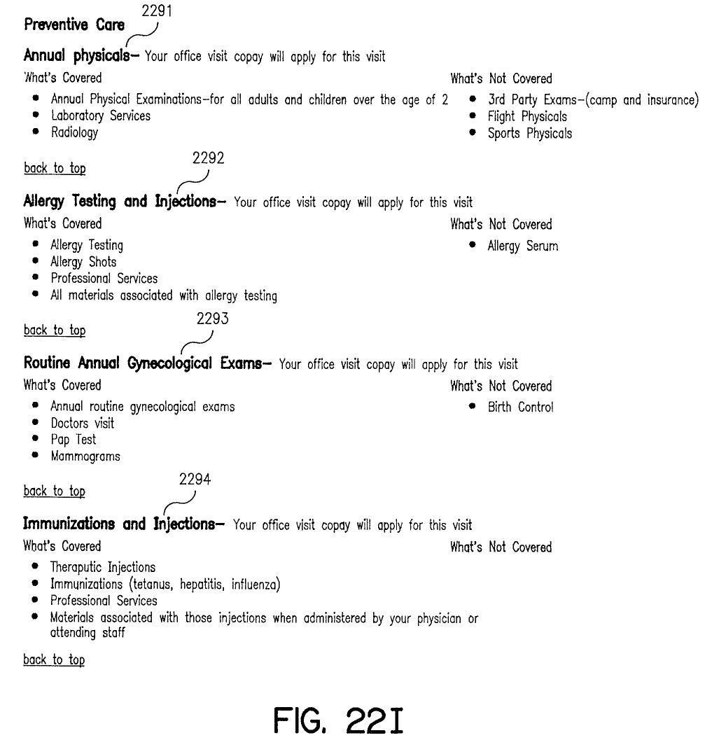

FIG. 22A illustrates an exemplary member benefit Wizard process flow 2200. The member is first asked 2201 to select from co-pay and coinsurance amounts, e.g., for prescription, office visits, inpatient, and outpatient care. A package is built 2202 with the selections and defaults and the package data is stored 2203 in the employee history. The employee is presented 2204 with package details and is prompted 2205 whether or not to select the package. If the package is not selected, the member may 2206 start over or jump to an Expert builder. If the package is selected, the enrollment selection is processed 2207, the selection is stored 2208 in the employee history, a confirmatory email is sent 2209 to the employer and employee, and the member is redirected 2210 to the primary physician selection screen.

There may also be links to vendor sites, but these links might be developed as a limited storefront site to discourage full navigation through the vendor site during configuration.

Exemplary browser or screen views of the benefit selection process are illustrated at FIGS. 22B-F. Although exemplary embodiments will be described herein in connection with system that is accessible via the Internet and a web browser, it is to be understood that a system consistent with the invention may be provided on any computer network, e.g. a Local Area Network. As shown in FIG. 22B, an exemplary initial information screen 2219, a member may be shown his or her employer's contribution 2220, his or her own estimated contribution 2221, and the contribution from the prior year 2222, for health 2223 and dental 2224 care, as well as the totals 2225 for each.

FIG. 22C illustrates an exemplary co-pay benefits choice screen 2230, including benefits selection area 2231 indicating the monthly benefit cost for each of a plurality of selectable co-pay amounts, a selectable “what's covered” option 2232 showing what covered services correspond to the selected co-pay amount, a “how it adds up” area 2233 showing the member the cost of the selected benefit over a given time period, including a breakdown of the amounts of employer contribution and paycheck deduction. Advantageously, the discrete price associated with each option within a heath care line item is displayed on the screen to the user. In FIG. 22C for example, the screen indicates discrete pricing within the physician care line item for various co-pay options, i.e. for a $0.0, $10.00, and $15.00 co-pay.

Discrete pricing for various options may be displayed depending on the requirements of the offering party. For example, an employer may offer healthcare benefits with one set of options and associated pricing, while a managed care organization (MCO) may desire to present a different set of options to consumers. An MCO, for example, may display option pricing based on place of service or access, e.g. different pricing options may be provided based on choice of doctor or hospital.

The “how it adds up” feature may serve as a resource meter for the employee so that he/she can track: (1) how much their employer has given them to spend in each category (“what your employer contributes”), (2) how much they have spent of their employer's dollars (“what your employer contributes”), and (3) how much they have spent as their own contribution (“what is deducted from your paycheck”) By clicking on an “All Benefits” hyperlink, a window may appear that explains to the employee both their pre- and post-tax spending. The “how it adds up” feature may also allow the employee to switch between monthly, annually, and bi-weekly costs, both for the dollars shown within “How It Adds Up”, as well as within “Choose From Within the Following Benefits”.

FIG. 22D illustrates an exemplary dental benefits choice screen 2240, including benefits selection area 2241 indicating the monthly benefit cost for each of a plurality of selectable dental care line items, a “what's covered” area 2242 showing what covered services correspond to the selected cost share benefit, a “how it adds up” area 2243 showing the member the cost of the selected benefit over a given time period, including a breakdown of the amounts of employer contribution and paycheck deduction. As shown, one or more additional offers 2244 may be presented to the user at this time, including, e.g., a third dental cleaning per year for an additional $3.00 per month.

The benefit categories and associated line items that are available to the employee or consumer for making benefit selections may be pre-determined by the employer or the MCO, depending on how much choice the employer or MCO wishes to make available. It may be possible to either collapse these categories or to create new ones, depending on how much choice is desired. The employee may view the benefit description, the benefit cost (monthly, annually, bi-weekly), and the selection made by the employee. The benefit options may vary by benefit line item in terms of the numbers of options displayed, which may be employer or MCO driven. Additionally, the system may display provider network choices, in addition to more traditional choices, such as fixed co-pays or percentage cost shares. Additional information messages may be triggered to inform employees about such things as out of pocket maximums.

FIG. 22E illustrates an exemplary summary of benefits screen 2250, including for each of a plurality of health benefits 2251 the benefit selected 2252, the monthly cost of each selected benefit 2253, and “info” options 2254 to view further information regarding the benefits selected. FIG. 22F illustrates an exemplary “how do I choose” screen 2260, containing a list of questions 2261 for the member to consider when selecting benefits, as well as other factual items 2262 to take into consideration. The “how do I choose” button on the Choosing Benefits page may provide information to the employee about how to select the appropriate level of benefit coverage. The “how do I choose” screen may highlight issues and questions that an employee can ask about their own situation to provide guidance with benefit selection.

The “how do I choose” screen may also interact with data warehousing for each employee or consumer to provide customized choice guidance. For example, prior usage or cost trend information, e.g. over a preceding year, may imported from an associated database in connection with a suggestion on the “how do I chose” screen as to which benefit choices the employee or consumer may wish to modify. Also, the system may be configured so that certain benefit selection combinations act as triggers to alert a consumer about various options. For example, low co-pay selections for certain healthcare coverage may suggest that the consumer believes he or she is unhealthy. Thus, when this benefit combination is selected it may trigger a notice to the consumer that a health risk assessment should be considered.

As FIG. 22I illustrates, an exemplary “what's covered” screen view 2290 for preventative care services may include information detailing covered services and co-pay amounts for, e.g., annual physicals 2291, allergy testing and injections 2292, routine annual gynecological exams 2293, and immunizations and injections 2294. The “what's covered” screen may display the top five benefits that are covered by a particular Benefit Category. The screen may also identify specific items that are not covered by a selection. By clicking on “More Detail”, a window may appear, which contains more detail about the benefits. It may allow the employee to view, at the time of benefits selection, all services that are covered and not covered by the benefit plan. This may be the pre-cursor to the dynamically constructed on-line summary plan document (SPD) called “My Plan” which may be available to the employee on-line after they have completed Choosing Benefits and Signing Up.

At any time, the member may be given the option to print out a complete or partial Summary of Benefits, an SPD formatted specifically for the company product and utilizing, for example, Adobe Acrobat. The Summary of Benefits may include wellness guidelines according to HEDIS and Healthy People 2010 standards and may reflect the contribution dollars of both the employer and the member. An exemplary summary of benefits delivery screen view 2270 is illustrated at FIG. 22G, which may include a congratulatory message for completing the signup process (when this screen is viewed following successful enrollment, and selection of benefits and provider is complete), as well as a query to the user 2272 regarding the manner in which a summary of benefits should be delivered to him or her (e.g. online, by email, or by regular mail).

At any point in time during the benefits selection process, the Summary of Benefits selection may be made. The screen may then display the benefit choices that have been made, as well as the pricing, employee contribution, and employer contribution. The employee may also adjust the Level of Coverage (tier type) and change the pricing based upon the number of covered family members. The on-line “Your Plan”, “My Plan”, and/or “Summary of Benefits” functionality may further allow for searches by alpha or keyword with near or exact match options and full tree indexing structure to drill-down into the benefits they have selected, the full legal and regulatory documentation, what is covered and what is not covered, all benefit limitations and all benefit maximums. As may be the case with all of the website, this may be made available 24 hours per day, 7 days per week.

An employee may be presented with provider network choices before entering the benefit line item selection portion of Choosing Benefits. It is contemplated that this network choice (e.g., hospital system or PHO-specific) would be overarching all benefit categories, versus providing benefit line item-specific network selections. The same functionality may also apply to a product selection (e.g., HMO, PPO, POS) as well. Each page on Choosing Benefits may contain a “Questions” icon and/or a toll-free number that employees can call while they are enrolling if they need help. These features may be employer or MCO-specific.

During the benefits configuration process, a member may wish to know why the company is requesting particular information. FIG. 22H illustrates an exemplary “Why do we ask?” screen view 2280, which may be accessed via a clickable selection during the benefits configuration process. In the “why do we ask?” section, a user may be presented with short, textual responses 2281 to common questions from users regarding the reasons certain information may be requested, e.g. an explanation that vital statistics information is required for record keeping accuracy and for tailoring services appropriately, or that student status information is requested to determine eligibility for coverage of dependent children. This feature may be available on every page to inform the user why such personal, detailed questions are being asked. It may explain the benefits to the user of some of the questioning, as well as the regulatory requirements where applicable. It may serve to demystify the process of submitting such information and provide for a more meaningful user experience.

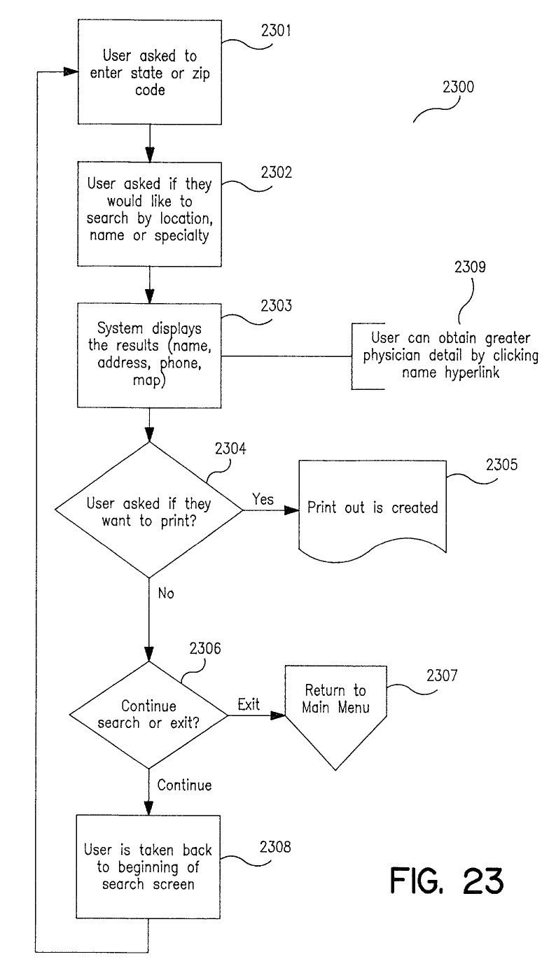

FIG. 23 illustrates an exemplary provider directory process flow 2300. The user may initially be asked 2301 to enter a state or zip code (or a default may be supplied from their eligibility information). The user may be asked 2302 if they would like to search by location, name, specialty, or a combination of more than one of the three criteria, and the system displays 2303 the results (e.g. name, address, phone number, map). Additional information, including physician detail, may be obtained by the user's selection 2309 of a provider name hyperlink. The user may be asked 2304 if he or she wants to print the results, in which case a printout is created 2305. Otherwise, the user is prompted 2306 to continue the search or exit. If the user chooses to exit, he or she is taken 2307 to the main menu. Otherwise, the user is taken back 2308 to the beginning of the search screen.

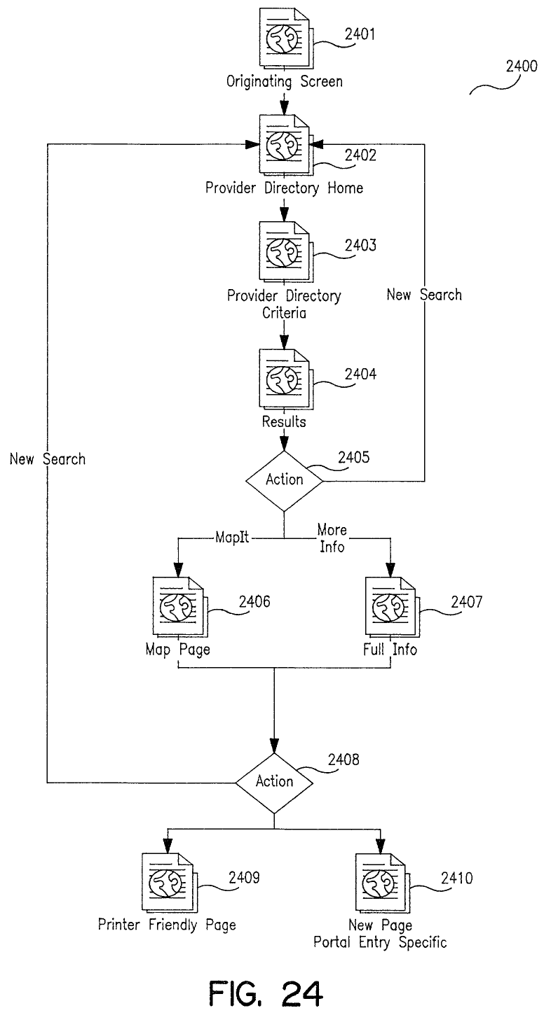

FIG. 24 illustrates an alternative exemplary provider directory process flow 2400. From the originating screen 2401, the user enters the provider directory home 2402 and enters provider directory criteria 2403. Results are obtained 2404, and the user is prompted whether to perform a new search 2405, in which case an affirmative answer returns the user to the provider directory home 2402. Otherwise, the user may elect to generate 2406 a map of, or to, the provider's physical location or view 2407 further provider details. At this point, the user is prompted whether to perform a new search 2405, in which case an affirmative answer returns the user to the provider directory home 2402. Otherwise, a printer-friendly page may be generated 2409, or a customized page or view specific to the point of portal entry may be generated 2410.

When the user views the provider directory search results, in addition to selecting a physician and seeing his or her biography, obtaining a map and directions to the provider's office, the user may also be permitted to confirm selection of the provider as a primary physician. If the member chooses to confirm this physician as their primary physician, a disclaimer may appear that details the difference between a primary and specialty care physician as well as the need for the member to determine whether this physician in particular is accepting new patients. The member may also have the opportunity (via an option button or otherwise) to select multiple physicians, indicating which is their primary physician.

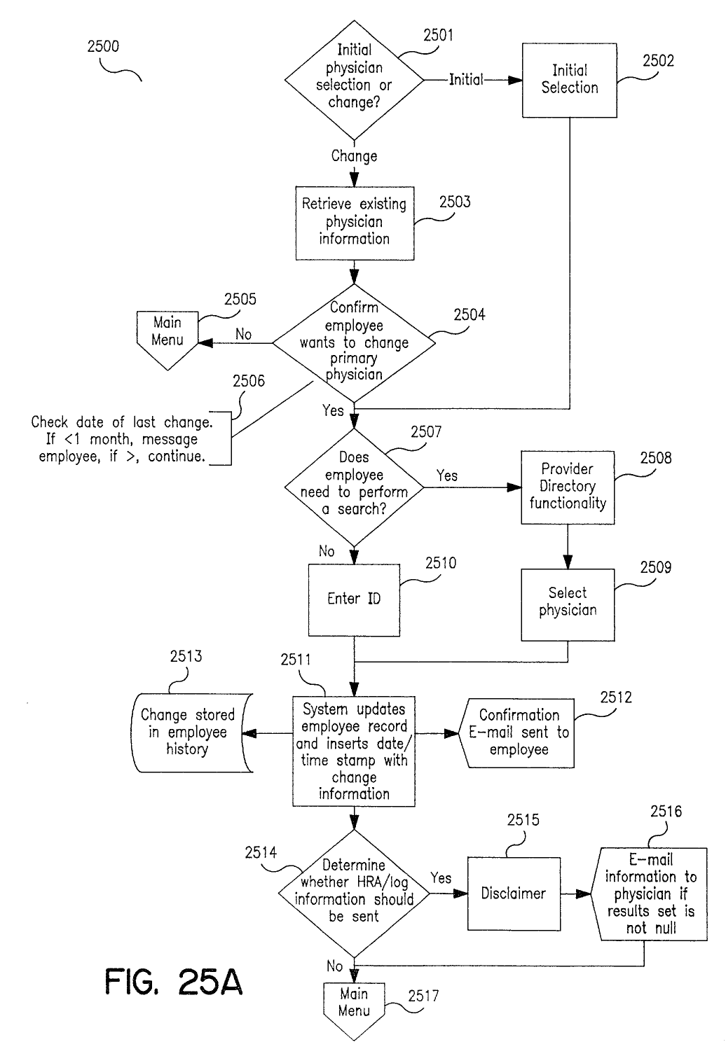

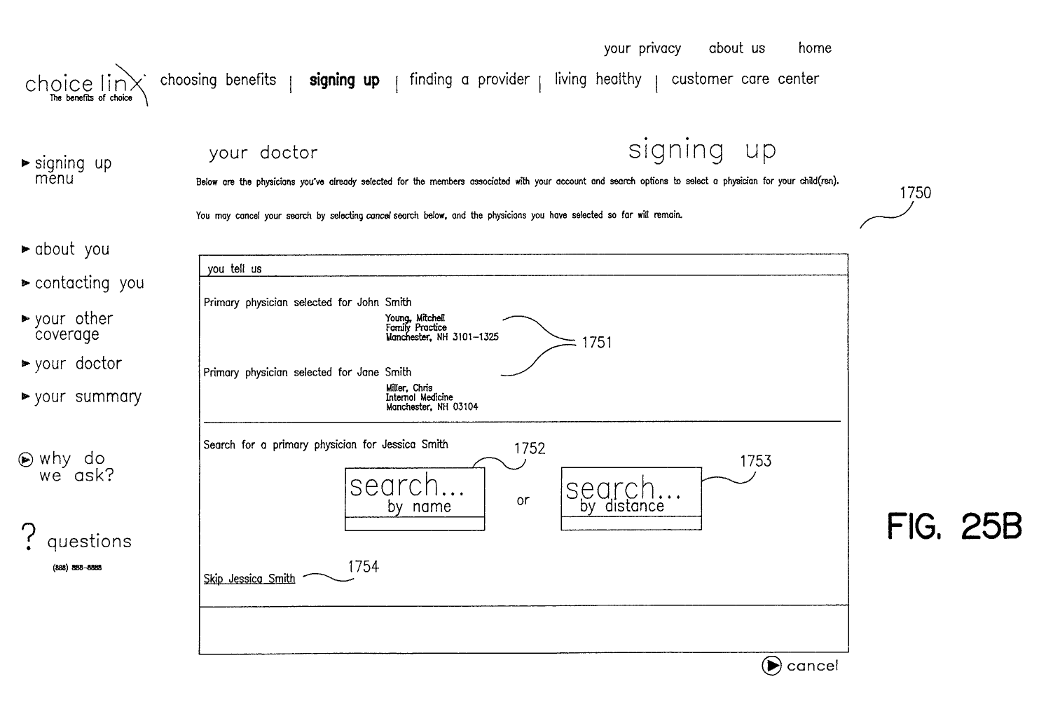

An exemplary primary physician selection process flow 2500 is illustrated in FIG. 25A. The member may be prompted 2501 whether he or she is selecting an initial physician or changing a physician already selected, or this determination may be automatically made by the system. If the member is changing an existing primary care physician, existing physician information may be retrieved 2503, and the employee may be required to confirm 2504 that he or she wants to change primary physicians. If the member answers “no”, he or she may be returned 2505 to the main menu. If the member answers “yes”, a determination may be made 2506 whether the last primary physician change occurred less than one month ago, in which case a message is sent to the employee, indicating that a change is not yet allowed. Members may be restricted from changing their physician more than once in a one-month period to reduce administrative expense in enrollment card generation for plans where the primary physician name appears on the card.

If the member is making an initial selection 2502, or if the member has not changed his or her primary physician in the last month, then the member may be prompted 2507 whether he or she needs to perform a search. If a search is needed, provider directory functionality 2508, as outlined above, may be provided, and a physician selection 2509 may be made using the directory. Otherwise, the member may enter 2510 a physician ID, in lieu of using the directory.

The system may update 2511 the employee record and insert a date/time stamp with the change information, the change may be stored 2513 in the employee history, and a confirmation email may be sent 2509 to the employee. A determination may be made 2514 whether health risk assessment and/or log information should be sent to the newly selected provider. If no information needs to be sent, the member may be returned 2517 to the main menu. If such information must be sent, the employee may be required to agree to a disclaimer 2515 with respect to the release of such information, after which the information may be sent 2516 via email to the newly selected provider, and the member may be returned 2517 to the main menu.

Through the foregoing functionality, members may be able to identify doctors for themselves and their family members using the search functionality available within this section of the site. The technology may be designed to recognize the family composition and the logical options for physician sharing within the unit to reduce the total number of individual searches required. This feature may provide the primary member with, e.g., the option of selecting one physician for their entire family or search independently for each spouse, then choose one pediatrician for all of the children or search independently if desired.

FIG. 25B illustrates an exemplary primary physician selection screen view 1750, including a display 1751 of previously selected primary physicians for each family member, options to search for a provider by name 1752 or distance 1753 from a given geographic location, as well as an option to skip 2754 selection of a primary physician at the given time.

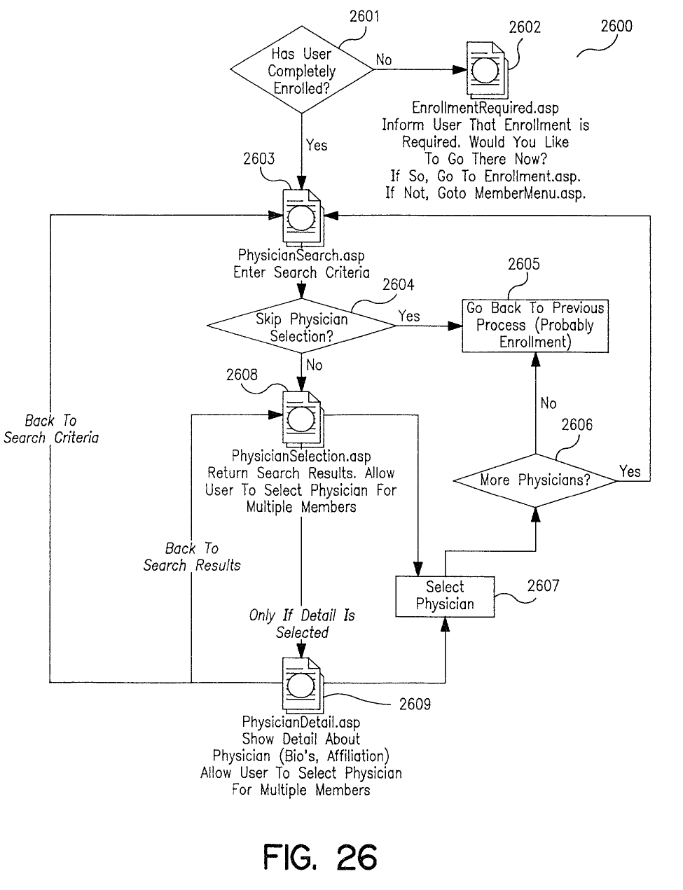

FIG. 26 illustrates an alternative exemplary physician selection process flow 2600. As shown, a determination may initially be made 2601 whether the user has completely enrolled. If not, the user may be informed that enrollment is required 2602 and be taken to the appropriate enrollment screens. If the user has completely enrolled, then he or she may be taken 2603 to the physician search criteria entry screen, as described above. A determination may then be made 2604 whether the user wishes to skip physician selection. If so, the user may be returned 2605 to the previous process from whence he or she came (e.g. enrollment). If not, the user is returned 2608 to the results of his or her search and may be permitted to select a physician for multiple (e.g. family) members.

The user may view 2609 details about the provider, including biographical and affiliation information, and may return to the results 2608 or search 2603 screens until the desired physician is selected 2607. The user may be prompted 2606 whether he or she wishes to choose additional physicians. If so, the user may return to the search 2603 screen. If the user is finished selecting physicians, the user may be returned 2605 to the previous process from whence he or she came (e.g. enrollment).

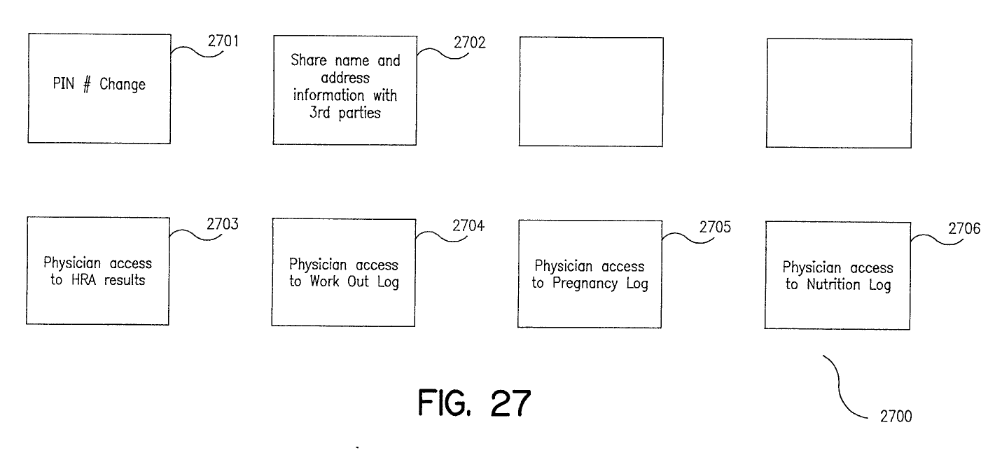

FIG. 27 illustrates the selectable components of an exemplary member preference selection interface 2700 in one embodiment of the invention. Such a member preferences section may include complete user profiles, which may be dynamic to allow for updates by the member or employer. The member may change his or her PIN number 2701, opt 2702 whether to share his or her name and address information with third parties, and opt whether his or her physician may access his or her health risk assessment results 2703, work out log 2704, pregnancy log 2705, and/or nutrition log 2706. Other selectable options may be provided via the member preference interface, including, e.g., demographics, primary physician, additional physicians, messaging preferences, turning on options for vendor and e-mail updates, color palette choices, signature options and other such customizable features.

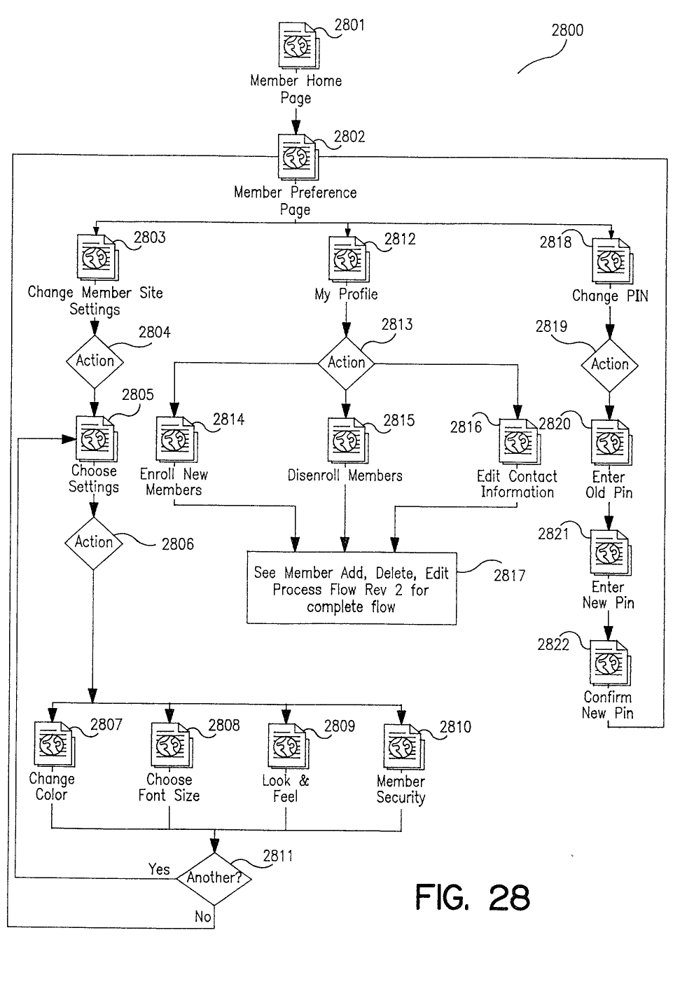

An alternative exemplary member preference process flow 2800 is illustrated in FIG. 28. From the member home page 2801, the user may access the member preference page 2802, from which he or she may opt to change member site settings 2803, change profile information 2812, or change his or her PIN number 2818. To change site settings, the user may be prompted 2804 to choose settings 2805 to change, and the selection 2806 may include changing color 2807, font size 2808, look and feel 2809, and/or member security 2810 options.

After a change is made, the user may be prompted 2811 whether there is another change. If not, the user may be returned to the member preference page 2802. If so, the user may choose 2805 another setting to change. To change profile information 2812, the user may be prompted whether to enroll new members 2814, dis-enroll members 2815, or edit contact information 2816. Based on the selection made, the user may be redirected to a member add/delete/edit process, as described below. To change his or her PIN number 2818, the user may be prompted 2819 to enter 2820 the old PIN number 2020, then the new PIN number 2821, and then to confirm the new PIN number 2822, after which the user may be returned to the member preference page 2802.

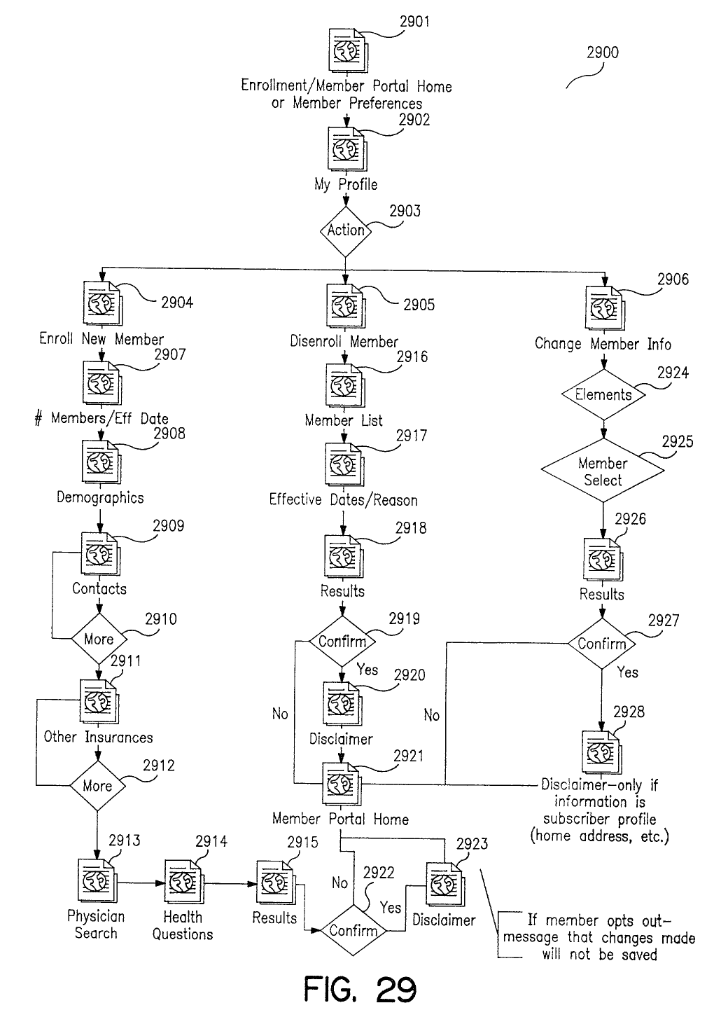

FIG. 29 illustrates an exemplary post-enrollment add/delete/change process flow 2900. From the enrollment/member home or member preferences screen 2901, the user may select to edit his or her profile 2902, which may prompt the user to select 2903 from the options of enrolling a new member 2904, dis-enrolling a member 2905, or changing member information 2906. From the enroll new member screen 2904, a user may be taken to a screen 2907 prompting for the number of members in the household and the desired effective date of coverage, and then to a demographic information form 2908. The user may then be taken to a contact information entry screen 2909, and after entering a contact, the user may be prompted 2910 whether there is further contact information to be entered, in which case the user may be returned to the contact information entry screen 2909.

The user may then be taken to an insurance information entry screen 2911, and after entering one set of insurance information, the user may be prompted 2912 whether there is further insurance information to be entered, in which case the user may be returned to the an insurance information entry screen 2911. The user may then perform a physician search 2913, answer a questionnaire comprising health questions 2914, and view the prospective results 2915 of the foregoing information entered (i.e. to verify that the enrollment information is correct, or that the user wishes to proceed).

The user may be prompted to confirm 2922 the enrollment, as entered. If the user chooses not to confirm the entries, he or she may be returned 2921 to the member portal home. Otherwise, before being returned 2921 to the member portal home, the user may be asked to agree to disclaimer language 2923, and if the member opts out of agreeing with the disclaimer, his or her changes regarding the new enrollment may not be saved.

If the user has chosen to dis-enroll a member 2905, a member list 2916 may appear for selecting the member(s) to dis-enroll, and the user may be prompted to enter 2917 the effective date(s) of disenrollment(s) and reasons therefor. The user may view the prospective results of the disenrollment(s) 2918 and may then be prompted to confirm 2919 the disenrollment(s). If the user chooses not to confirm the entries, he or she may be returned 2921 to the member portal home. Otherwise, before being returned 2921 to the member portal home, the user may be asked to agree to disclaimer language 2920, and if the member opts out of agreeing with the disclaimer, the disenrollment(s) may not be processed.

If the user has chosen to change member information 2906, he or she may select the elements 2924 to change, as well as the member(s) 2925 to which the change(s) pertain. The user may then view the results 2926 (i.e. to verify the changes entered). The user may be prompted to confirm 2927 one or more of the foregoing entries. If the user chooses not to confirm the entries, he or she may be returned 2921 to the member portal home. Otherwise, before being returned 2921 to the member portal home, the user may be asked to agree to disclaimer language 2928, and if the member opts out of agreeing with the disclaimer, his or her changes may not be saved.

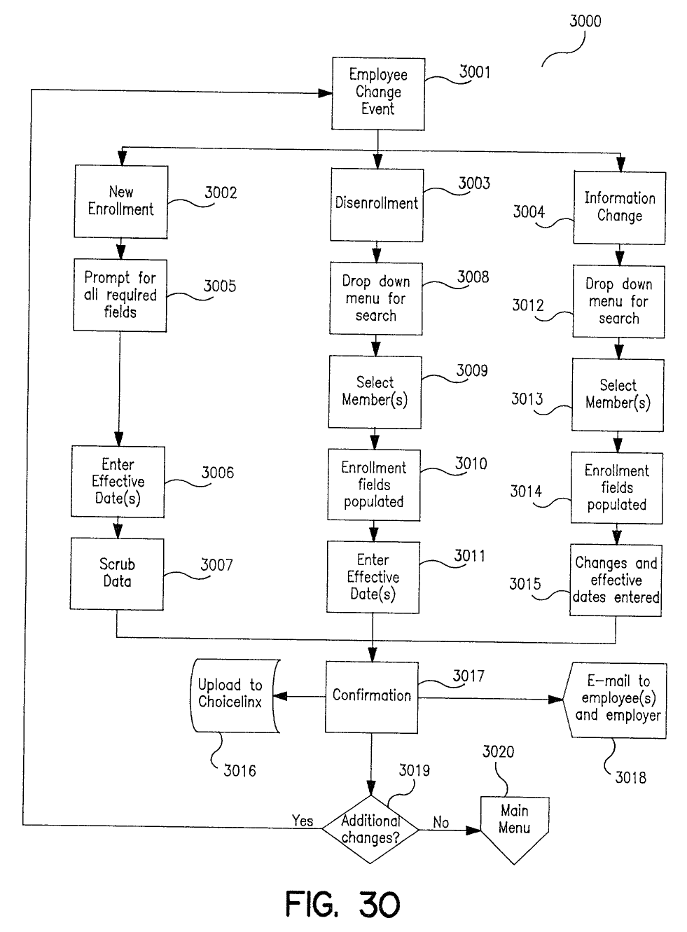

FIG. 30 illustrates another exemplary enrollment/disenrollment/enrollment information change process flow 3000. When an employee opts to change 3001 enrollment information, he or she may be prompted to select new enrollment 3002, disenrollment 3003, or enrollment information change 3004. If the user chooses new enrollment 3002, he or she may be prompted 3005 for all of the required fields, and may be prompted to enter the effective date of desired coverage 3006. The data, as entered, may be scrubbed (e.g. using Group 1 Code 1 Plus address standardization software) 3007 to ensure consistency. The user may then be prompted to confirm 3017 the new enrollment and entered data, and upon confirmation, the data may be uploaded 3016 to the company, and an email may be sent 3018 to the employee(s) and/or employer. The employee may be prompted 3019 whether there are additional changes, and if there are none, he or she may be returned 3020 to the main menu.

When an employee opts to dis-enroll 3003 a member, he or she may be presented with a drop-down menu 3008 for searching for the member to dis-enroll. The member(s) to dis-enroll may be selected 3009, the enrollment fields may be appropriately populated 3010, and the effective date of disenrollment may be entered 3011. The user may then be prompted to confirm 3017 the disenrollment and entered data, and upon confirmation, the data may be uploaded 3016 to the company, and an email may be sent 3018 to the employee(s) and/or employer.

The employee may be prompted 3019 whether there are additional changes, and if there are none, he or she may be returned 3020 to the main menu. When an employee opts change enrollment information 3004, he or she may be presented with a drop-down menu 3012 for searching for the member whose information is to be changed. The member may be selected 3013, the enrollment fields may be appropriately populated 3014, and the appropriate changes and effective dates may be entered 3015. The user may then be prompted to confirm 3017 the changes and entered data, and upon confirmation, the changed data may be uploaded 3016 to the company, and an email may be sent 3018 to the employee(s) and/or employer. The employee may be prompted 3019 whether there are additional changes, and if there are none, he or she may be returned 3020 to the main menu.

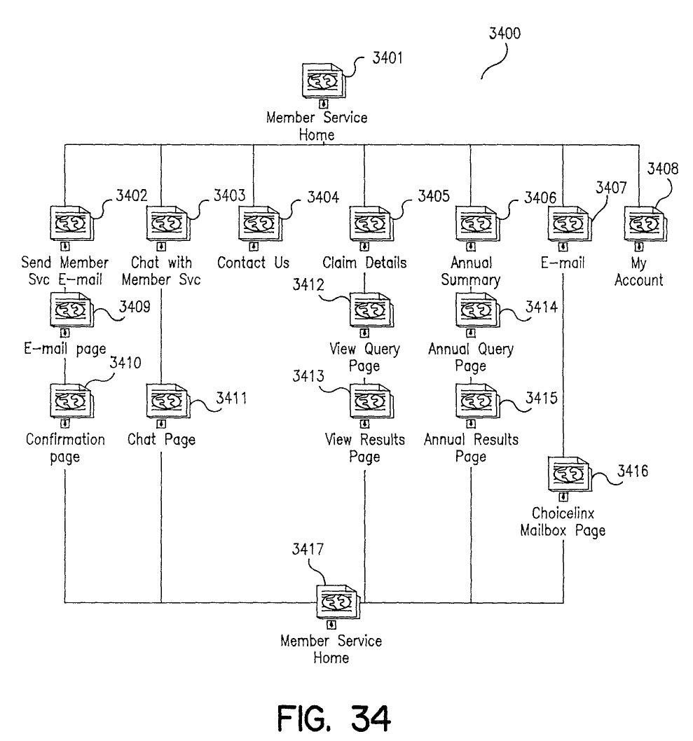

FIG. 34 illustrates an exemplary member services process flow 3400. From the member service home page 3401, a member may choose to send member service e-mail 3402 via an e-mail page 3409 and a confirmation page 3410, chat with member services 3403 via a chat page 3411, contact member services 3404 (e.g. by email, CGI/Java script, or by viewing postal/telephonic contact information), view claim details 3405 via a query page 3412 and a results page 3413, view annual summaries 3406 via a query page 3414 and a results page 3415, send email 3407 via a mailbox page 3416, and view his or her account 3408. After performing any of the foregoing functions, the member may be returned to the member service home page 3417.

It is noted that, while the foregoing described processes are set forth with respect to the “members only portal”, it should be understood the same or similar processes may be employed to perform the same or similar functions with respect to members, employers, providers, and/or system administrators (e.g., the steps for searching the provider directory process might be similar or identical for members, employers and providers). Likewise, while the processes set forth below are described with respect to providers and/or employers, it should be understood the same or similar processes may be employed to perform the same or similar functions with respect to members, employers, providers, and/or system administrators.

### Providers Only Portal

This portal may be the primary area for physicians to find information pertaining to members. The initial screen may ask for the provider's ID and PIN in order to gain access to the site. If the correct information is not supplied, then a message may be displayed asking them to call Customer Service.

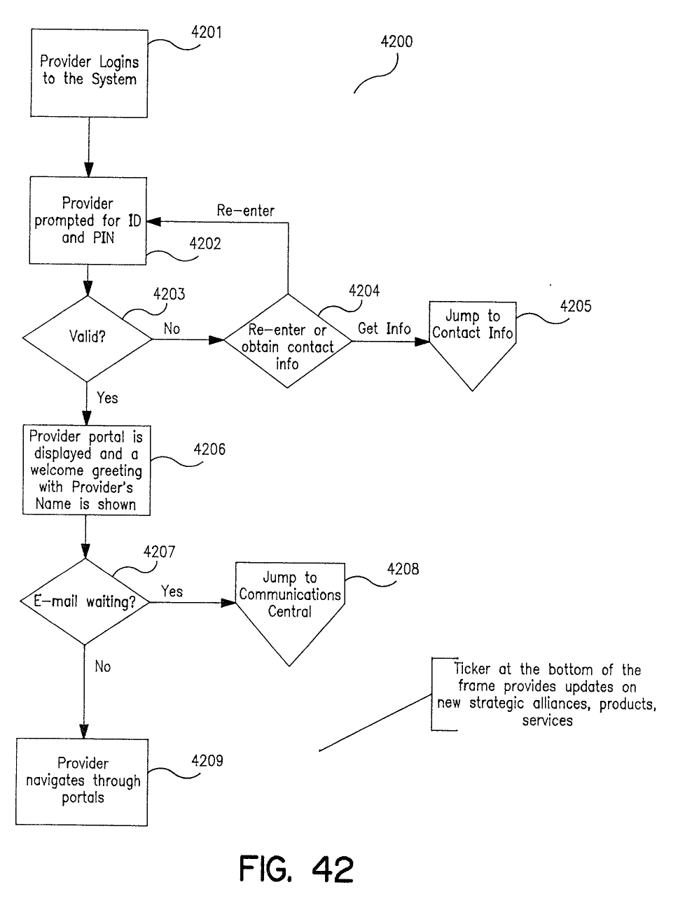

Turning now to FIG. 42, an exemplary provider entry screen process flow 4200 is illustrated. Upon selection of the provider portal 4201, the end user may be prompted 4202 for their login ID and PIN. A determination may be made 4203 whether the entry is valid. If the entry is invalid the user may be asked 4204 to select either a re-entry or contact information to become a company provider.

If they choose the former, they may again be given the prompt 4202 for an ID and PIN. If they choose the latter, they may jump 4205 directly to the Contact Information Screen. Once they enter a correct ID and PIN the full provider portal menu may appear 4206 for further navigation.

A determination is made whether the provider has mail 4207, in which case they are directed to Customer Care Center 4208. Alternatively, a message may appear in a pop-up box asking whether they would like to open their mail. If they select yes, they may jump directly to Customer Care Center 4208 and their messages may be automatically brought up. If they select no (or if there is no user email) the pop-up box may disappear and they may be free to navigate the site 4209. Until their messages are clear, the pop-up box may appear each time they log into the site. A ticker may be provided at the bottom of the current frame, displaying updates on new strategic alliances, products and services.

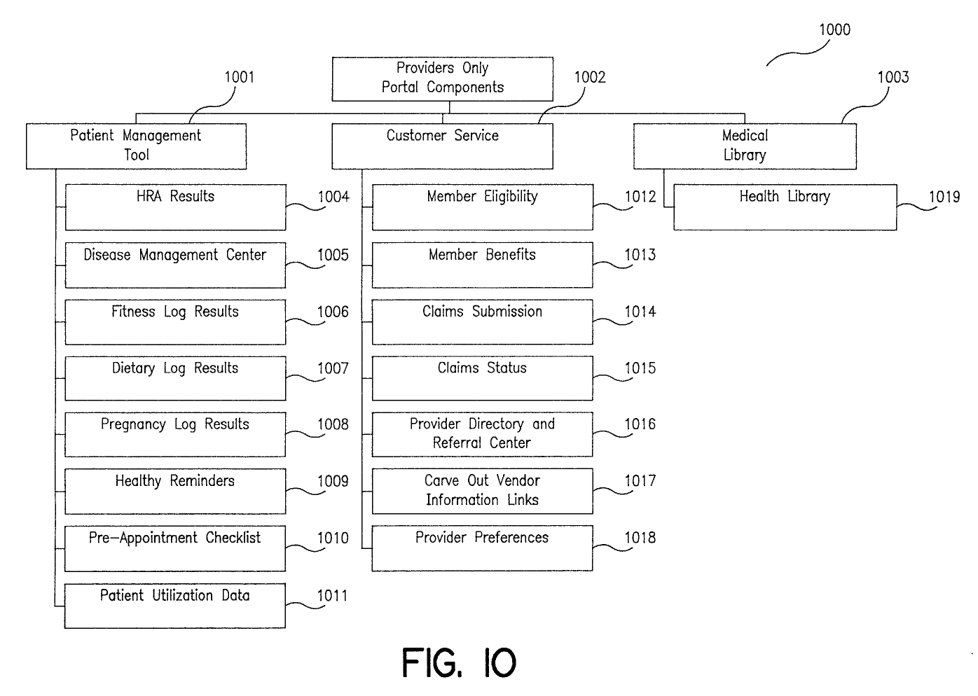

As illustrated in FIG. 10, the Providers Only Portal (POP) may comprise three primary areas: patient management 1001, customer service 1002, and medical library 1003. Each of these three areas may have a large, descriptive icon, and that the detailed sections under each area may also be highlighted.

The patient management area 1001 may include a health risk assessment results area 1004, a disease management center 1005, fitness log results area 1006, dietary log results area 1007, pregnancy log results area 1008, healthy reminders area 1009, pre-appointment checklist area 1010, and patient utilization data area 1011. The health risk assessment (HRA) results area 1004 may allow the providers to have access to the HRA results for individual patients, given the patient's permission.

Additionally, providers may have the ability to see summary information for their patient panels. This function may allow the physician to view a patient's HRA results if the permission flag is set to Y by the member. They may have a drop down list to search on those patients assigned to them who have previously granted authorization and they can view or print out (MS Word or Adobe, depending upon the third party application) a copy of the most recent as well as previous report cards. They may be able to select on more than one patient and print out cards for each. They may also be able to jump directly from the HRA over to the Healthy Reminders section or Health Library to send helpful information to their patients via e-mail.

The disease management center 1005 may be the “dashboard” for the Personal Physician provider in terms of monitoring their patients enrolled in disease management programs. This functionality/ service may most likely be supplied by a third party vendor who may either input directly or connect to the company system. This site may host data in the same way as the HRA in that the patient may grant permission and the physician can select from amongst those members who are participating in the program. They may have the ability to input results to the site, print out one or more updates, print from a range of dates for all participating members, print on or search by the most recent status' only and jump directly to Healthy Reminders and the Health Library.

The fitness log results area 1006 may allow the providers to have access to the Fitness Log results for individual patients, given the patient's permission. The dietary log results area 1007 may allow the providers to have access to the Dietary Log results for individual patients, given the patient's permission. The pregnancy log results area 1008 may allow the providers to have access to the Pregnancy Log results for individual patients, given the patient's permission. For the fitness, dietary, and pregnancy logs, search and print functionality may be the same as for HRA and disease management in terms of drop downs, flags and selecting for multiple patients. Date range or results set may be handled as it is for these logs under the member portal.

The healthy reminders area 1009 may allow the providers to send one of a number of canned messages to their patients from the Healthy Reminders area, which may be in the form of a hyperlink contained within an e-mail. They may be allowed to edit the text to make it more personalized. Some exemplary canned messages are as follows: “appointment reminder”, “advice on your upcoming test”, “advice on your test results”, “encouragement on your wellness program”, “encouragement on your disease management program”, “recommendations on helpful information”, “referral to a support group”, “general greeting”, “holiday/birthday greeting”, “diet recommendation”, “exercise recommendation”, and “specialist recommendation”. Providers may be able to pull a report of the most recent messages sent to their patients to avoid duplication.

The pre-appointment checklist area 1010 may allow providers to create and maintain pre-appointment checklists for their patients. The patient utilization data area 1011 may allow the providers to view utilization data (claims experience) for individual patients as well as their patient panels. It may be summarized utilizing categories of care. Providers may be able to search in the same manner as with the HRA or disease management to see claims that are specific to themselves and their patients. They may not be able to view all care received by their patients as provided by other physicians. They may search on an individual or on a range of patients via a drop-down list and they may get a claims result set back. They may then select for an individual claim detail, all claims for a date range, claims for a certain procedure code, claims for a certain diagnosis code. They may have a date range option for each with the default being the current year to date. They may be allowed to see the status of the claim (pending, paid, rejected) and the dates received and processed.

The customer service area 1002 may include a member eligibility area 1012, a member benefits area 1013, a claims submission area 1014, a claims status area 1015, a provider directory and referral center 1016, a vendor information links area 1017, and a provider preferences area 1018. The member eligibility area 1012 may be a real-time eligibility link for providers to access. Using keys such as first name, last name, date of birth, SSN, etc, providers may be able to look up a member's eligibility or enrollment status. Once found, the system may prompt them and ask if they would like to see the member's Summary of Benefits or claim status.

Fuzzy logic may be used to come up with the closest match, but a physician can only get complete enrollment and/or claims detail if the member selected him/her as their primary physician. Otherwise they may just see active dates for enrollment even if the status expired. If the physician has been selected as primary, they may get a pop-up box asking if they would like to see the member's summary of benefits or claim status.

By choosing the summary of benefits they may be able to either view the full detail of services covered or print it in Adobe Acrobat format. This may differ from the Summary of Benefits the member has available to them in that the physician may not see the employer and member contribution amounts or benefits other than health, prevention and wellness, alternative medicine and disease management. If the physician selects the claim status, they may jump directly to the utilization data site. The member benefits area 1013 may be a real-time benefits link for providers to access. Using keys such as first name, last name, date of birth, SSN, etc, providers may be able to look up a member's benefits. This may be a direct link to view the full Summary of Benefits as described above.

The claims submission area 1014 may be a real-time benefits link for providers to access. The claims status area 1015 may be used to inquire and receive information regarding pending claims. This may be a link similar to that outlined in the utilization section. The physician may be able to search on an individual member by last name via a drop down list of his/her patients, and get a list of the corresponding claims. They can then select a claim and receive the status information (pending, paid, rejected). They may also be able to view the status reason information.

The provider directory and referral center 1016 may have two primary functions: 1) to provide on-line access to the provider directory, and 2) to provide referral information to approved providers. This may be a core component of the system. It may allow members, employers and physicians to search for providers within zip code ranges, by name and by specialty. It may be both a freestanding module on the web site under Member Services and also be integrated in places such as the Enrollment Screens. It may provide maps and driving directions (e.g. using GeoAccess Streets). There may also be a sub-portal whereby providers can maintain their personal profile. The system may provide the maintenance option when a provider logs in using their PIN.

Additionally, the functionality may not vary from that described in the Member Portal section. Search features may be the same as may the mapping capabilities. The vendor information links area 1017 may contain information about carve-out networks such as Rx or Behavioral Health. It may contain URL links to the vendor's web sites as well as have detailed benefit information. In the provider preferences area 1018, providers may have the option of updating their personal and practice information with future functionality to address personal navigation preferences and the ability to send auto-messaging to their patients if desired.

Providers may be able to edit any of their personal and practice information used in the course of the Provider Directory and Primary Physician Selection Processes. The site may house general demographic and office location information as well as languages spoken, special interests, community activities, schools attended, special certification/accreditation earned. They might also add staff member names, individual or staff pictures and other more personal information to allow the consumer to make the best decision possible. The following fields may be incorporated: Provider first name, provider middle initial, provider last name, primary/secondary/tertiary office address 1, address 2, city, state, postal code, country, phone number, fax number, e-mail address, primary specialty, sub-specialty, languages spoken, undergraduate school attended, medical school attended, years in practice, special interests (professional and otherwise), civic activities, office manager and personal nurse name.

Customization may be based on navigation preferences, and there may also be an option to message current patients if primary office or other pertinent information is changed on the site as a means for general notification. The medical library area 1003 may comprise health education materials in the form of links to other content sites, libraries of articles, and recommendations for fitness and dietary information. The materials may be organized around the diseases that the disease management programs may support: Cardiovascular Disease (CVD), Congestive Heart Failure (CHF), Chronic Obstructive Pulmonary Disease (COPD), Diabetes, and Hypertension. Additionally, links to fitness and dietary sites may be made.

The company may provide and maintain some of its own materials, as well. Links to smoking cessation and other preventive measure classes may be made. This may not differ from the functionality outlined in the Members Portal. Functionality may be provider specific and may include, for example, links to the New England Journal of Medicine (http://www.nejm.org/content/index.asp), JAMA (http://www.jama.ama-assn.org), PubMed (http://www.ncbi.nlm.nih.gov/PubMed), MedScape (http://www.medscape.com/) and/or other on-line research magazines or sites oriented towards physicians. There may also be links to stock sites or the ability to personalize with their own tickers and reveal market headlines specific to healthcare and biomedical engineering and research. Finally, information links may be maintained for a sizable list of diseases and conditions.

### Employers Only Portal

This portal may be the primary area for employers. The initial screen may ask for the employer's ID and PIN in order to gain access to the site. If the correct information is not supplied, then a message may be displayed asking them to call their account representative.

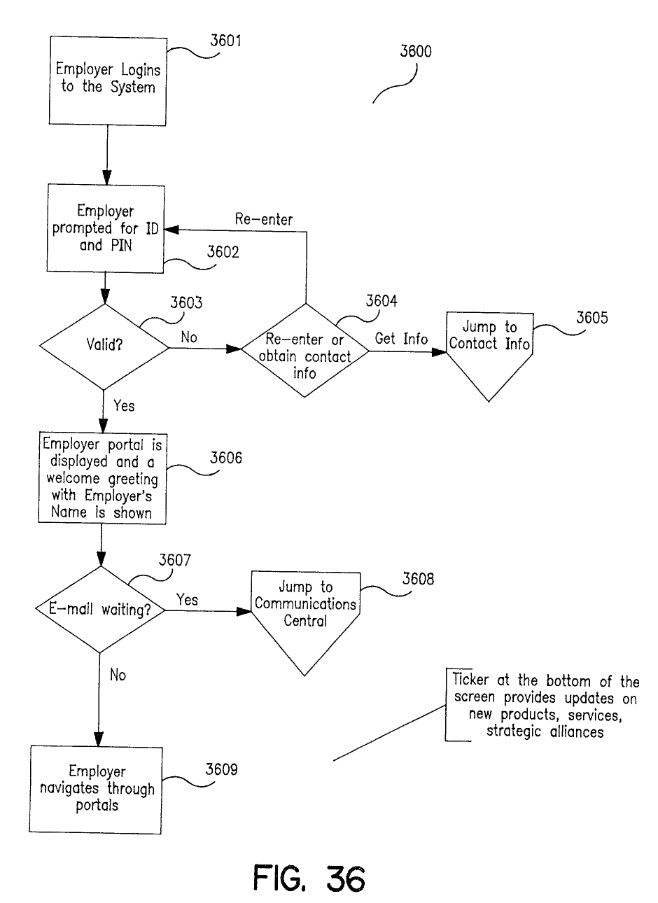

Turning now to FIG. 36, an exemplary employer entry screen process flow 3600 is illustrated. Upon selection of the employer portal 3601, the end user may be prompted 3602 for their login ID and PIN. A determination may be made 3603 whether the entry is valid. If the entry is invalid the user may be asked 3604 to select either a re-entry or contact information to sign up for the service. If they choose the former, they may again be given the prompt 3602 for an ID and PIN. If they choose the latter, they may jump 3605 directly to the Contact Information Screen.

Once they enter a correct ID and PIN the full employer portal menu may appear 3606 for further navigation. A determination is made whether the employer has mail 3607, in which case they are directed to Customer Care Center 3608. Alternatively, a message may appear in a pop-up box asking whether they would like to open their mail. If they select yes, they may jump directly to Customer Care Center 3608 and their messages may be automatically brought up. If they select no (or if there is no user email) the pop-up box may disappear and they may be free to navigate the site 3609. Until their messages are clear, the pop-up box may appear each time they log into the site. A ticker may be provided at the bottom of the current frame, displaying updates on new strategic alliances, products and services.

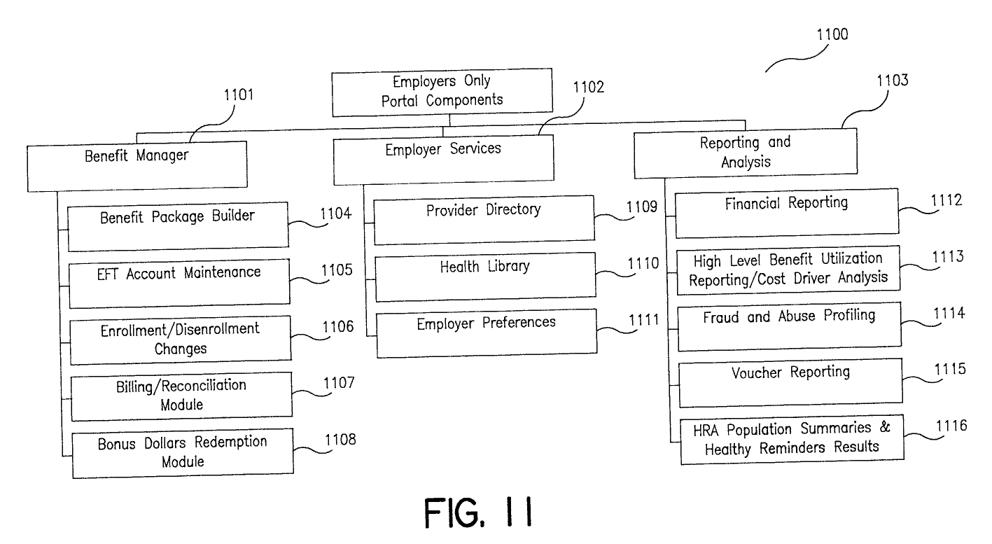

As illustrated in FIG. 11, an exemplary Employers Only Portal (EOP) may comprise three primary areas: a benefit manager 1101, an employer services section 1102, and a reporting and analysis section 1103. Each of these three areas may have a large, descriptive icon, and that the detailed sections under each area may also be highlighted.

The benefit manager 1101 may include a benefit package builder 1104, an EFT account maintenance section 1105, an enrollment/disenrollment section 1106, a billing/reconciliation module 1107, and a bonus dollars redemption module 1108. The benefit package builder 1104 may be the tool used by the employer and the company personnel to create the benefits that may be available to the member. For each of the benefit modules, that there may be 5-7 options available for the employer to choose from. The employer may, for example, select 3-4 options per benefit module and that is what may be displayed on the site to the member.

The system may summarize and printout copies of the benefit package chosen by the employer. There may be an audit trail on this data. Cost information for each benefit may also be displayed. The EFT account maintenance section 1105 may allow the employer's benefits personnel to update electronic funds transfer information (account number, bank name, amount of transfer) so that it can be automated between the employer's bank and the company's bank for self-funded accounts.

The employer may have a full profile screen at which all of their information can be updated including Name, Address, Contact Name, Phone Number, Fax Number, Contact E-mail Address, Bill To Address, Bill To Name, Bank Name, Account Number, Transfer Amount, etc. The EFT information may be specific to self-funded clients but could be used for employers on a monthly or quarterly payment schedule as well. For the former there may need to be linkages to claims data as well as verification points, and for both there may need to be an enrollment tie-in and procedural rules around effective dates and payment schedules.

The enrollment/dis-enrollment section 1106 permits employers to add/delete/modify member information on-line. This may need to be done in an on-line fashion via the site, as well as via a file upload (which may or may not be on the site). For the former, they would perform the following: for adding new employee(s), completing all of the EDI standard fields, selecting effective dates and confirming; for terminating coverage for employee(s), performing a search on the last name (only those employees that belong to the company would appear), entering effective dates, and confirming; for changing employee information, editing employee eligibility information, entering effective dates, and confirming. For the latter, they would perform the following: Producing a file in the industry standard EDI format; and utilizing the FTP (file transfer protocol) function to transfer the file to the company.

The billing/reconciliation module 1107 may be used so that on-line bills from the company to the employer could be seen/paid, as well as the reverse for self-billing accounts. This functionality would enable the employer to view, pay and reconcile billing on-line. This may require a look-up feature for current statement or prior period statements.

Paid bills may be noted visibly as such and the employer may be able to perform a search on payment mechanism and date. There may be an option button to allow the employer to pay the current statement, with a pop-up box to query and confirm account information. This may be automatically populated but edit-enabled. If no account information exists on file, the information may be accepted and upon confirmation by the employer, a message may appear that X period of time may be required to verify account, the failure of which may result in an e-mail generated to the contact person's name.

The contact name may appear and may be edited. If the contact information is changed, the system may ask the end-user whether this may be permanently changed or if it is a one-off. Permanent changes may be stored in the employer file, date/time stamped and user ID recorded.

Reconciliation functions may also be performed. Reminder e-mails noting payment due may be automatically generated to the group contact name X days prior to the due date. Further back-end processing may also occur in this module 1107. The bonus dollars redemption module 1108 may be used so that employers can control how the Bonus Dollars may be spent for each member.

The employer services section 1102 may include a provider directory 1109, a health library 1110, and an employer preferences section 1111. The provider directory 1109 may have two primary functions: 1) to provide on-line access to the provider directory, and 2) to provide referral information to approved providers. This may be a core component of the system. It may allow members, employers and physicians to search for providers within zip code ranges, by name and by specialty. It may be both a freestanding module on the web site under Member Services and also be integrated in places such as the enrollment screens. It may provide maps and driving directions (using, e.g., GeoAccess Streets).

The functionality of the provider directory may be similar to the functionality outlined in the Members Only Portal. The health library 1110 may comprise health education materials in the form of links to other content sites, libraries of articles, and recommendations for fitness and dietary information. The materials may be organized around the diseases that the disease management programs may support, e.g., Cardiovascular Disease (CVD), Congestive Heart Failure (CHF), Chronic Obstructive Pulmonary Disease (COPD), Diabetes, and Hypertension. Additionally, links to fitness and dietary sites may be made. The company may develop and maintain some of its own materials, as well. Links to smoking cessation and other preventive measures classes may be made. Finally, information links may be maintained for a sizable list of diseases and conditions.

The functionality of the health library may be similar to the functionality outlined in the Members Only Portal. The employer preferences section 1111 may allow employers to edit their profile and establish custom navigation preferences for the site. Employers may have the ability to change their profile at any time. Fields that may be included are Employer Group Name, Parent Company Name, Mailing Address1, Mailing Address2, City, State, Postal Code, Country, Business location Address1, Location Address2, City, State, Postal Code, Country, Contact Name, Contact Number, Contact Role, Communications options (mail, phone, e-mail or e-mail only), Contact e-mail address, Contact Fax Number.

The reporting and analysis section 1103 may include a financial reporting section 1112, a high level benefit utilization reporting/cost driver analysis section 1113, a fraud and abuse profiling section 1114, a voucher reporting section 1115, and health risk analysis population summaries and healthy reminders results section 1116. Apart from annual financial reporting, the financial reporting section 1112 may provide the employer with the ability to perform aggregate analyses such as overall expense per-member-per-month (PMPM) by each benefit category, premium vs. expense ratios and modeling of trends based on complete claims data. The queries may be canned and provided to the employer via option buttons on a reporting screen. Results may be provided back in MS Word or Excel format and can be downloaded from the site. A disclaimer regarding the variance in results due to claims lag may appear both on the site and on all reports.

The high level benefit utilization reporting/cost driver analysis section 1113 may provide utilization reporting on an employer's population by benefit package category. Subsequent to greater than 6 months of claims experience the employer groups may have the ability to see summary level utilization and cost data. They may have the option of selecting from a range of metrics including prescription cost and utilization, e.g., by category PMPM, Hospital days (inpatient, acute, maternity, sub-acute) PMPM, Specialty care PMPM, Primary Care PMPM, and Preventive Services PMPM. The fraud and abuse profiling section 1114 may aid in tracking Medicare/Medicaid and other insurance or health care system fraud and abuse type problems.

The voucher reporting section 1115 may provide summary reporting on how the voucher dollars were spent. In the health risk analysis population summaries and healthy reminders results section 1116, employers may have the ability to see summary information for their members in terms of HRA information as well as how their populations are doing relative to the HEDIS and Health People 2000 indicators. The employer may have the ability to see aggregate HRA data when the baseline reporting population is greater than X. They may also be able to run, on an ad hoc basis, a report card detailing the overall employee performance with regard to adherence to HEDIS and Healthy People 2010 standards. They may be able to auto-generate reminders to their employees. This reminder may be general in nature so as not to imply that the employer has the ability to monitor individual services provided. It is also important to note that employee-specific benefit and utilization information may not be released to the employer for confidentiality purposes. All such reports provided to the employer should be at a plan summary level.

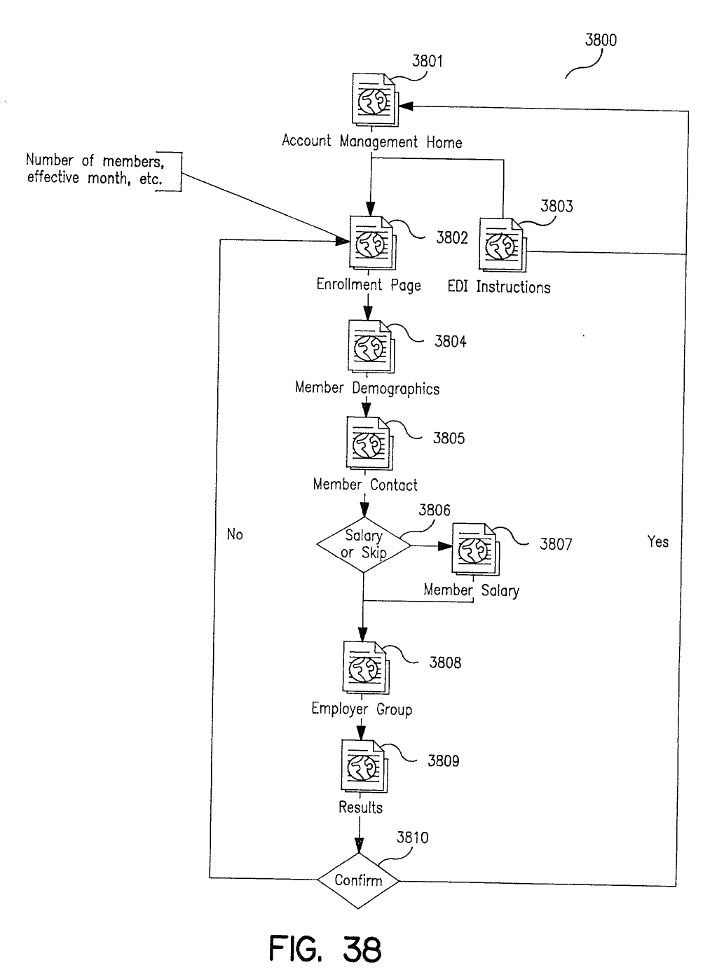

An exemplary employer enrollment process flow 3800 is illustrated in FIG. 38. As shown, from the account management home page 3801, an employer may select an enrollment page 3802, where such information is collected as, e.g., the number of members and the effective month. The employer is then taken to a member demographics page 3804 for entering further data. For each member of the employer, the employer is then taken to a member contact page 3805, where the employer may choose 3806 whether to enter salary information, in which case the employer is taken to a member salary page 3807, or else skip to the next member. The employer may then be taken to an employer group data entry page 3808. A results page 3809 is shown to confirm 3810 the data entered. If any data was entered incorrectly, the employer may return to the enrollment page 3802 to further edit the data. Otherwise, successful confirmation of data entry may automatically generate appropriate EDI instructions 3803 containing the data entered.

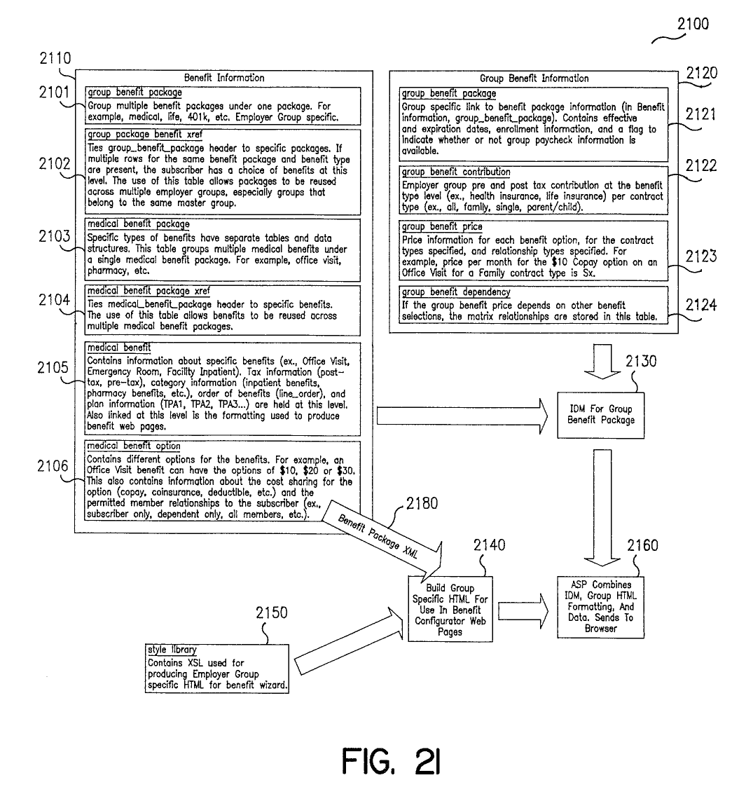

Exemplary employer group/benefit configuration process flow and data structures 2100 are illustrated in FIG. 21. As shown, benefit information 2110 may include group benefit package 2101, group package benefit xref 2102, medical benefit package 2103, medical benefit package xref 2104, medical benefit 2105, and medical benefit option 2106.

The group benefit package 2101 may be employer group specific and may group multiple benefit packages under one package (e.g., medical, life, 401(K)). The group package benefit xref 2102 ties the group benefit package 2101 header to specific packages. If multiple rows for the same benefit package and benefit type are present, the subscriber may have a choice of benefits at this level. The use of this table may allow packages to be reused across multiple employer groups, particularly groups belonging to the same master group.

The medical benefit package 2103 groups multiple medical benefits (e.g., office visit and pharmacy) under a single medical benefit package, as specific types of benefits have separate tables and data structures. The medical benefit package xref 2104 may tie the medical benefit package 2103 header to specific benefits. The use of this table may allow benefits to be reused across multiple medical benefit packages.

The medical benefit 2105 may contain information about specific benefit line items (e.g., office visit, emergency room, facility inpatient). Tax information (e.g., post-tax and pre-tax), line item information (e.g. inpatient benefits and pharmacy benefits), order of benefits (line order), and plan information may be held at this level. Also linked at this level may be the formatting used to produce benefit web pages.

The medical benefit option 2106 may contain different options for the line items. For example, an office visit benefit might have the options of $10, $20, or $30. This also may contain information about the cost sharing for the option (e.g., co-pay, coinsurance, and deductible) and the permitted member relationships to the subscriber (e.g. subscriber only, dependent only, all members).

The foregoing benefit information 2110 may be transmitted as a benefit package in an extended markup language (XML) 2180 format, along with a style library 2150 (which may contain XSL used for producing employer group specific HTML for the benefit wizard), to a build group specific HTML 2140 for use in the benefit configuration web pages. Group benefit information 2120 may include group benefit package 2121, group benefit contribution 2122, group benefit price 2123, and group benefit dependency 2124. The group benefit package 2121 may be a group specific link to benefit package information (e.g. group benefit package 2101 in benefit information 2110), and may contain effective and expiration dates, enrollment information, and a flag to indicate whether or not group paycheck information is available.

Group benefit contribution 2122 may comprise employer group pre- and post-tax contribution at the benefit type level (e.g. health insurance and life insurance) per contract type (e.g. all, family, single, parent/child). Group benefit price 2123 may include price information for each benefit option, for the contract types specified, e.g., price per month for the $10 co-pay option on an office visit for a family contract type is $X. Group benefit dependency 2124 may be a table storing the matrix relationships between group benefit price and other benefit selections on which it depends. Group benefit information 2120 and benefit information 2110 may be sent to an information data management (IDM) module 2130 for the group benefit package, which, along with the build group specific HTML 2140, may supply data to active server pages 2160, which may combine the IDM and group HTML formatting and data, and send the appropriate data to the end user's browser.

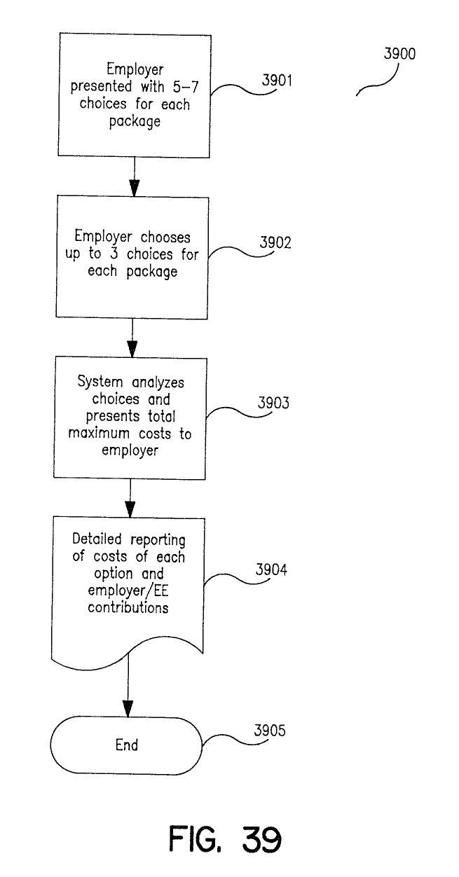

FIG. 39 illustrates an exemplary employer benefit package builder process 3900. The employer may be presented 3901 with, for example, 5-7 choices for each package. The employer may choose 3902, for example, up to 3 choices for each package. The system analyzes 3903 the choices and presents the total maximum costs to the employer. The employer may then view 2904 a detailed reporting of the costs of each selected option, as well as employer/employee contributions, before ending 3905 the build process.

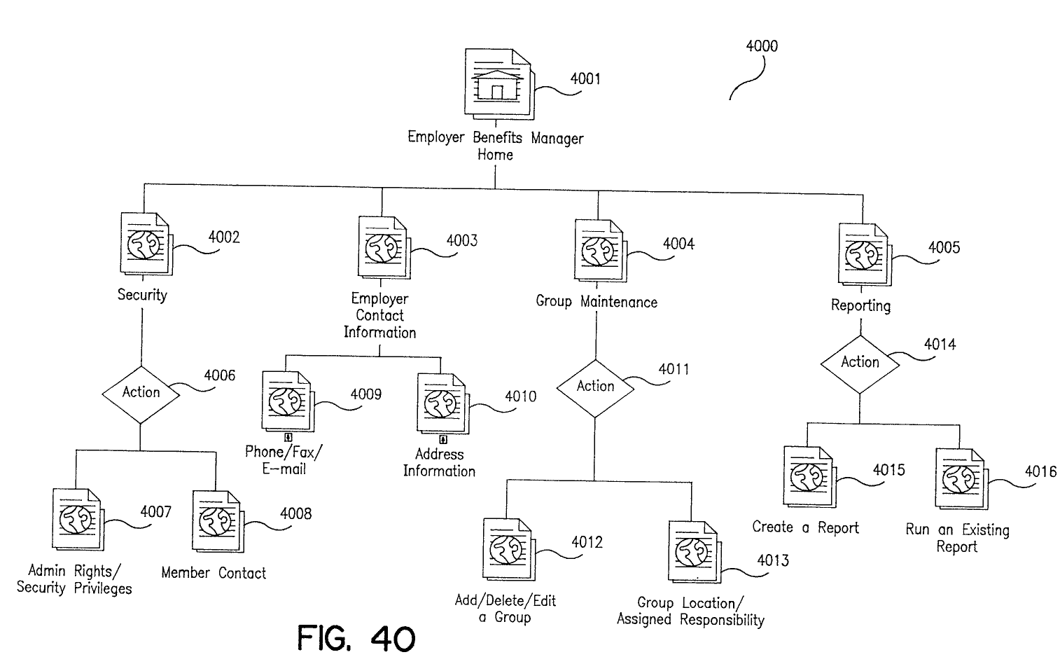

An exemplary employer preferences process flow 4000 is illustrated in FIG. 40. From the employer benefits manager home page 4001, the employer may choose security 4002, contact information 4003, group maintenance 4004, and reporting 4005 preferences. For security preferences 4002, the employer may further select 4006 administrative rights/security privileges preferences 4007, or member contact preferences 4008. For employer contact information 4003, preferences for phone/fax/email 4009 and address information 4010 may be selected. For group maintenance preferences 4004, the employer may select 4011 to add/edit/delete a group 4012 or group location/assigned responsibility 4013. For reporting preferences 4005, the employer may select 4014 to create a report 4015, or run an existing report 4016.

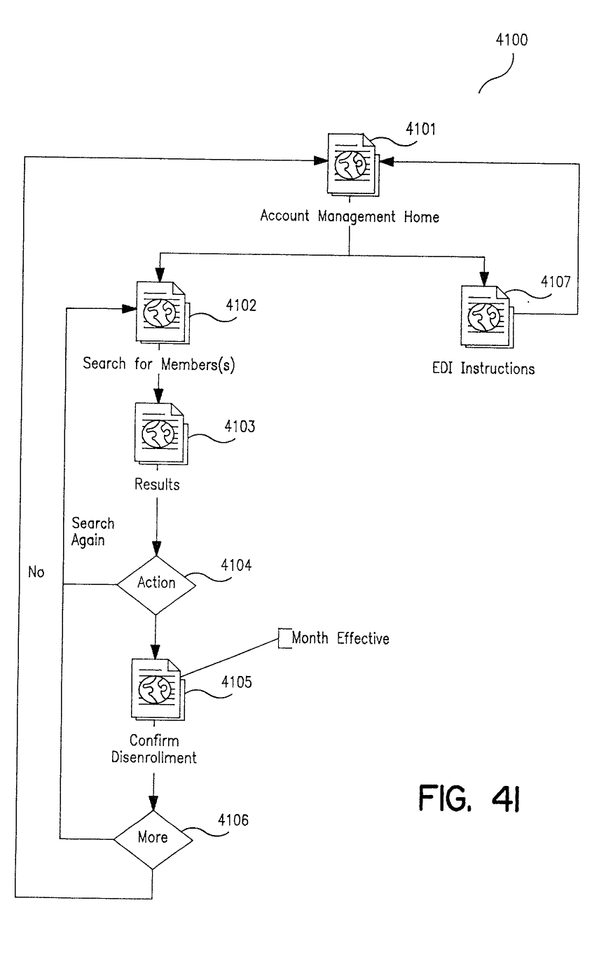

FIG. 41 illustrates an exemplary employer disenrollment process flow 4100. From the account management home page 4101, an employer may either upload EDI instructions 4107 or manually dis-enroll members. For manual disenrollment, an employer may search 4102 for one or more members to dis-enroll, view the results of the search 4103, be prompted 4104 to confirm disenrollment 4105 (and may provide the effective month of disenrollment), and be prompted 4106 whether to dis-enroll more members. If there are no more members to dis-enroll, the employer may be returned to the account management home 4101, otherwise the employer may search 4102 again for one or more members to dis-enroll.

### Customer Service and Customer Care Center

An integrated software Customer Relationship Management (CRM) solution may be employed to support the traditional customer service function. The software may be fully integrated with the web site, the claims processing system, and the operations of other business partners to deliver end-to-end customer relationship management. A customer service application, e.g. from Clarify, may be modified to fit the healthcare model, as well as the business processes described herein.

A customer interaction screen may provide the capability of searching for members (both active and termed), participating providers, or employer groups, and may offer the following exemplary functionality: (1) log any customer interaction (phone, e-mail, or chat) in the Notes section. (2) view Customer Interaction History (gives a detail of customers inquiry by phone, email, or chat); (3) a “flash” screen may pop up very important information in regard to the chosen customer that must be read by the CSA before continuing.

For example, a flash screen may pop up to prompt the CSA to ask, “What is your password?” before giving out any claims information; (4) the ability to access Claim Inquiry data (by clicking on Claim Inquiry this may return the CSA directly to the screen to enter search criteria for the claim and view the claim detail); (5) play scripts & solutions (scripts may help a Customer Service Advocate (CSA) know the questions to ask a customer to get an end result; solutions may help a CSA with after call work); (6) a save button, giving the CSA the ability to file the documented notes to the Customer's Interaction History; and (7) an open button, giving the CSA the ability to move to the Contact Screen.

The Contact Screen may provide more detailed information about the selected customer and may offer the following functionality: (1) the top part of the screen may show Customer's Name, Preferred Name, Date of Birth, Gender, Member Identification#, and Social Security#; and (2) from the Navigation Tree, a CSA may choose from the following: (a) addresses, which may display all addresses for each member; (b) eligibility, which may include effective/termination date and group history; (c) dependents, which may list all covered members covered including the subscriber under the plan and their relationship to the subscriber; (d) ID Cards, which may show ID card history and also give the CSA the capability of ordering an ID card; (e) if the member has chosen a primary doctor, the doctor's name, effective date, provider ID#, and the member's history with the doctor may be displayed; (f) group information, which may include details of the employer group that the member is employed by, e.g., group address, group contact name and phone number; (g) authorization inquiry, which may allow viewing of all authorizations for that member and may display authorization#, date of service, status (suspended, approved, or denied), Provider/Facility name, and Procedure Type; (h) coordination of benefits (COB), which may include details about other insurance the member has; (i) SPD view, bringing the CSA directly to the Summary Plan document for that member to view benefits information, member responsibility, policy's, education issues, etc.; (j) Notes, which may give a detail of customer's inquiry by phone, email, or chat; and (k) “done”, which may move the CSA back to the Customer Interaction Screen, e.g., to continue to log notes, end the call, find a new customer.

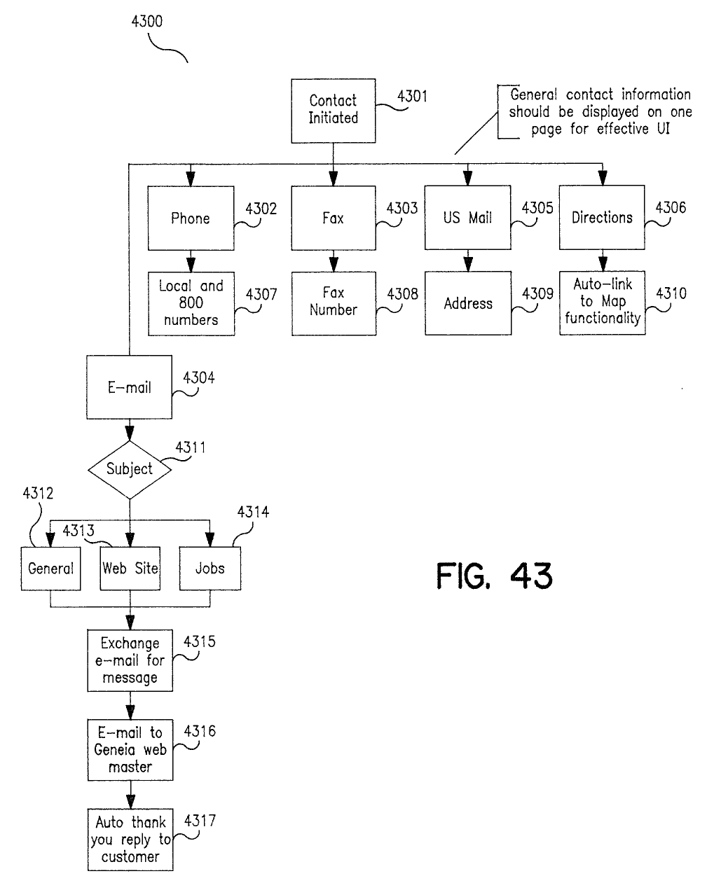

An exemplary company contact information process flow 430 is illustrated in FIG. 43. Upon initiation of a request for contact 4301, a user may choose to contact the company via phone 4302, in which case local and toll-free numbers may be supplied 4307, by fax 4304, in which case a fax number is supplied 4308, by U.S. Mail 4305, in which case a mailing address is supplied 4309, or by email 4304. If the user chooses to contact the company by email 4304, he or she may be prompted to choose 4311 the subject of the email, which may include general 4312, web site 4313, or jobs 4314, for example. The email is entered 4315 and sent 4316 to the web master or system administrator, and an automatic “thank you” reply may be generated 4317 to the user. The user may further request directions 4306 and be linked 4310 to map functionality, as appropriate. General contact information may also be displayed on a single page, for an effective user interface.

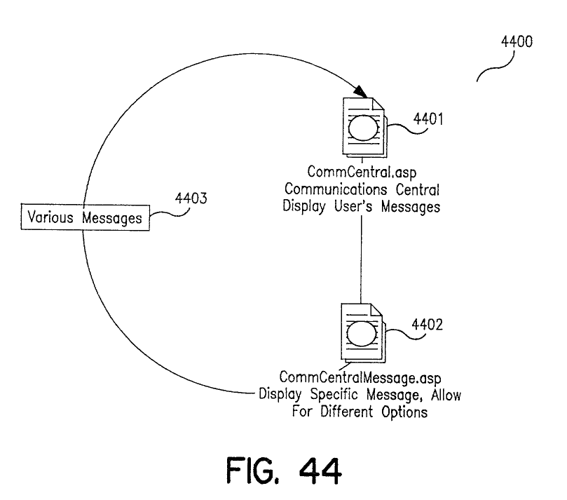

FIG. 44 illustrates one an exemplary Customer Care Center process flow 4400. A user's messages 4403 may be displayed 4401, a specific message may be displayed 4402, or other options may be permitted.

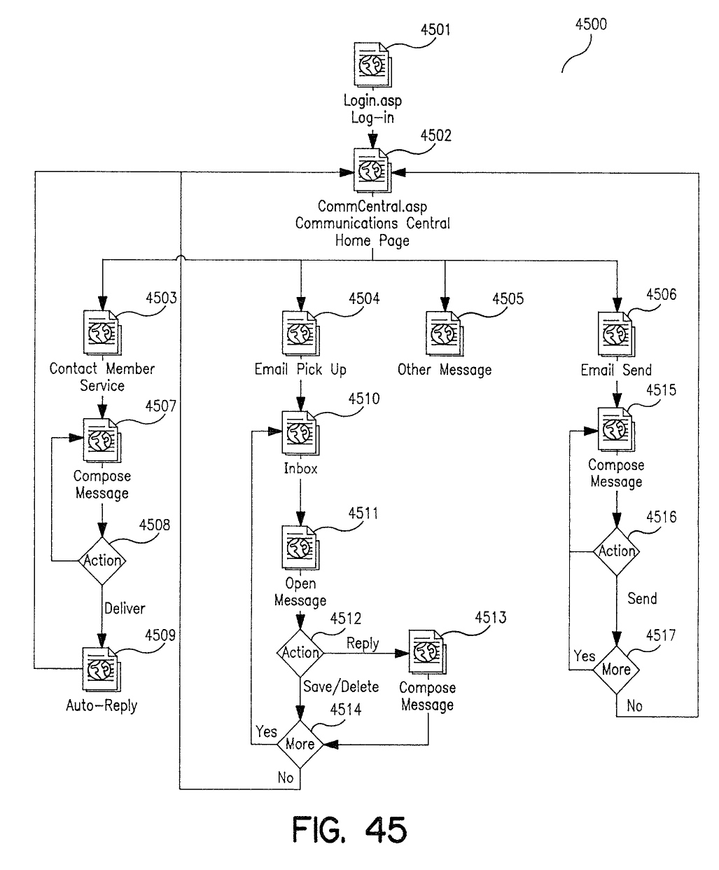

Another exemplary Customer Care Center process flow 4500 is illustrated in FIG. 45. As shown, after logging in 4501 and arriving at the Customer Care Center home page 4502, a user may elect to contact member services 4503, pick up email 4504, view other messages 4505, or send email 4506. Upon electing to contact member services 4503, a user may compose a message 4507 and optionally confirm 4508 entry of the message, and an automatic reply may be sent to the user 4509. Upon electing to pick up email 4504, the user may view his or her inbox 4501, open a message 4511, choose 4512 to save or delete the message or reply by composing 4513 a message, choose to view 4514 more messages by returning to the inbox 4510, or end email pickup by returning to the Customer Care Center home page 4502. If the user elects to send email 4506, he or she may compose a message 4515, optionally confirm 4516 entry of the message, and choose 4517 whether to compose another message 4515 or return to the Customer Care Center home page 4502.

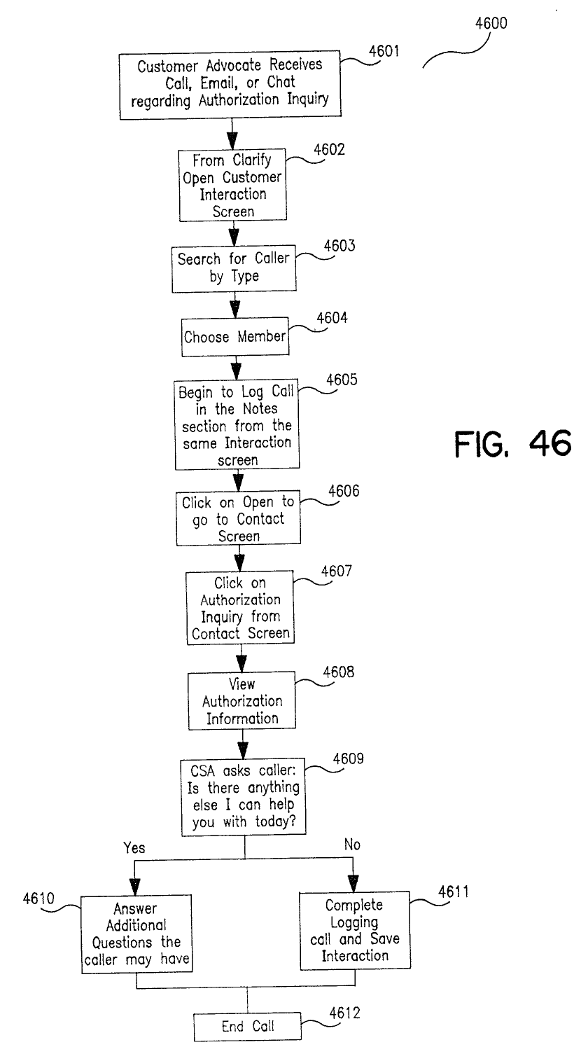

Customer service inquiries may be made regarding a variety of issues. Three exemplary process flows for customer service interaction are provided at FIGS. 46-48. FIG. 46 illustrates an exemplary process flow 4600 for customer service advocate (CSA) interaction with a customer regarding an authorization inquiry. A customer service advocate may receive 4601 a call, email, or chat regarding an authorization inquiry and open 4602 an interaction screen. The CSA may search 4603 for the member by type and select 4604 the appropriate member. The CSA may begin to log 4605 the call in a “notes” section of the same interaction screen and may click on an “open” button to go 4606 to the contact screen. The CSA may click 4607 on “authorization inquiry” from the contact screen and view 4608 authorization information, e.g., authorization number, provider name, procedure, date of service, and expiration date. The CSA may ask 4609 the caller if there is another matter with which he or she may assist, and if so, answer 4610 additional questions the caller may have before ending 4612 the call. If not, the CSA may complete logging the call 4611 and save the interaction before ending 4612 the call.

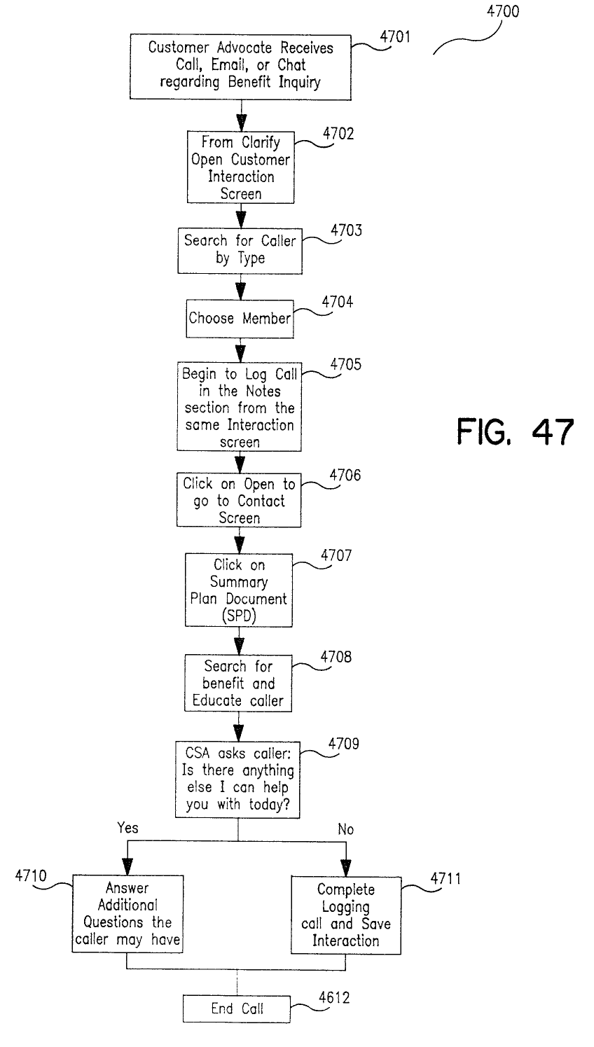

FIG. 47 illustrates an exemplary process flow 4700 for customer service advocate (CSA) interaction with a customer regarding a benefits inquiry. A customer service advocate may receive 4701 a call, email, or chat regarding a benefits inquiry and open 4702 an interaction screen. The CSA may search 4703 for the member by type and select 4704 the appropriate member. The CSA may begin to log 4705 the call in a “notes” section of the same interaction screen and may click on an “open” button to go 4706 to the contact screen. The CSA may click 4707 on the summary plan document (SPD) from the contact screen and search for benefit information 4708 to educate the caller. The CSA may ask 4709 the caller if there is another matter with which he or she may assist, and if so, answer 4710 additional questions the caller may have before ending 4712 the call. If not, the CSA may complete logging the call 4711 and save the interaction before ending 4712 the call.

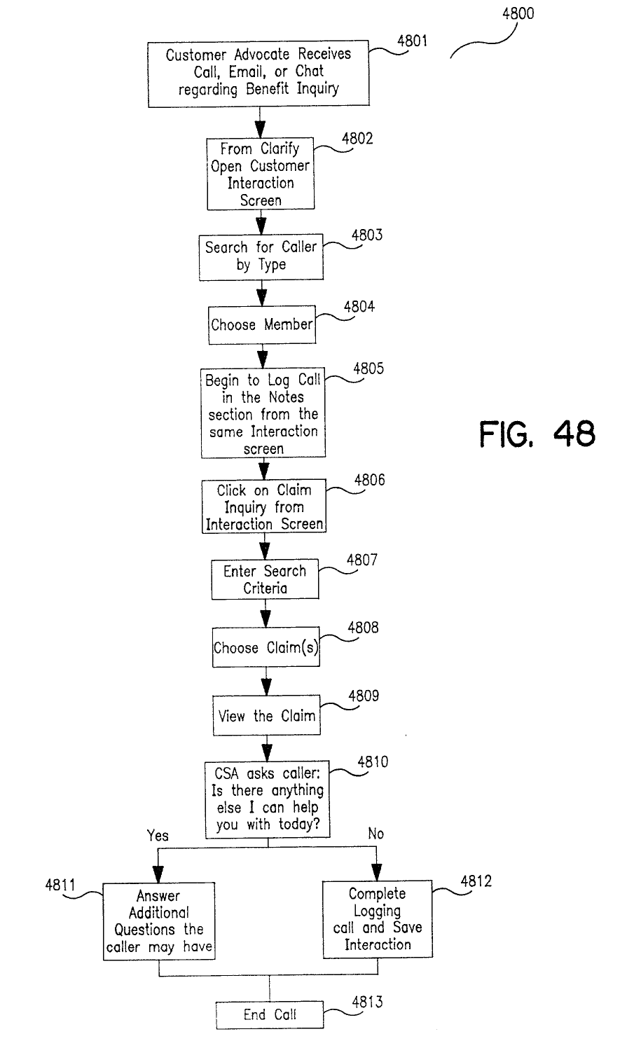

FIG. 48 illustrates an exemplary process flow 4800 for customer service advocate (CSA) interaction with a customer regarding a claim inquiry. A customer service advocate may receive 4801 a call, email, or chat regarding a benefits inquiry and open 4802 an interaction screen. The CSA may search 4803 for the member by type and select 4804 the appropriate member. The CSA may begin to log 4805 the call in a “notes” section of the same interaction screen and may click on a “claim inquiry” button to go 4806 to the claim inquiry screen. From there, the CSA may enter 4807 search criteria e.g. member ID, provider ID, claim number) and choose 4808 the appropriate claim(s) for viewing 4809, to assist the caller. The CSA may ask 4810 the caller if there is another matter with which he or she may assist, and if so, answer 4811 additional questions the caller may have before ending 4813 the call. If not, the CSA may complete logging the call 4812 and save the interaction before ending 4813 the call.

### Auto-Benefits Building

Partner Systems may include companies such as CSC, iMckesson, Standard Register, and Express Scripts. Partner Systems may be identified in the system based on criteria established at Group Setup (e.g., network decisions, products purchased). It may be automatically determined within the benefits database which partner systems are affected per benefit choice that the member has chosen. Once the member has confirmed their “Choosing Benefits” section, their configured benefit packages may be created based on the Group setup criteria and the member's choices. The packages may be mapped to the partner specific benefit codes, and this crosswalk may be maintained by the company.

Depending on the process prescribed per partner system, the benefit packages may be sent to all applicable partner systems with the detail necessary for them to support the company's members. The partners may process their respected files and generate acknowledgement files with detail at the transaction level for review. Updates to member information may be made in a similar fashion to the above-described process. Any changes to a member may automatically be sent to partner systems as necessary, which process may happen automatically upon update to a member's record.

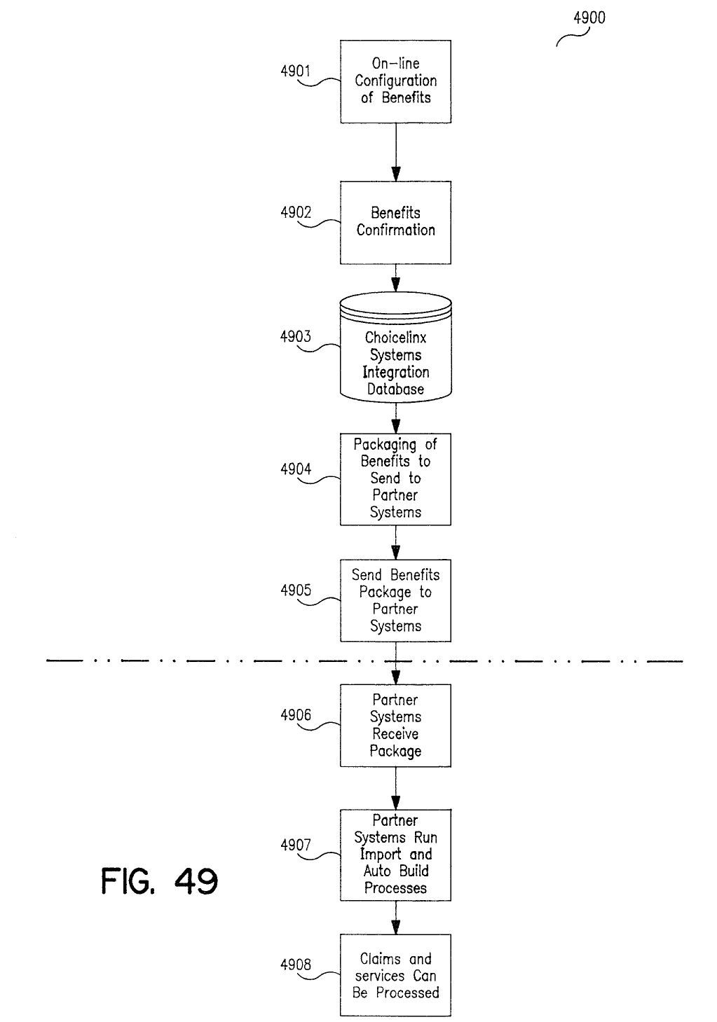

FIG. 49 illustrates an exemplary high-level process flow 4900 for automatic benefits building. The employee may configure 4901 benefits online, within the employer's predefined benefits parameters. The employee may review the benefits he or she has chose and confirms 4902 the selection. The company's systems integration database may manage 4903 both benefits and enrollment data and data feeds. For example, eligibility feeds may be generated for ID cards, PBM, and medical management purposes.

The benefits may be packaged 4904 to be sent to partner systems. In one method of accomplishing this, the employee's (or consumer's) benefit selection may be translated from its raw data format to a code format recognized by the partner system. The translated benefit package may then be sent electronically to the partner system. Those skilled in the art will recognize that the partner systems may utilize a variety of code formats, requiring a translation algorithm for each partner system code format. The translation to the partner system format prior to transmitting the package to the partner system, however, simplifies integration of the package in to the partner system.

The benefits package may be sent 4905 to partner systems, e.g. as a nightly feed, or more or less frequently, to the partner systems, along with enrollment and benefits information. Data may be released with employer-specific criteria during open enrollment periods.

On the partner system side, a partner system may receive 4906 a package, including enrollment and eligibility file. The partner system may run 4907 import and auto-build processes. The partner system may import the eligibility data and associates members with the employer group. Benefits may be built to a pre-defined benefit plan using the partner system benefit codes transmitted by the company. Finally, claims and services may be processed 4908, e.g. claim eligibility may be confirmed, claims may be adjudicated, etc., immediately after benefits are loaded.

### Overall Business Model and Underwriting Process

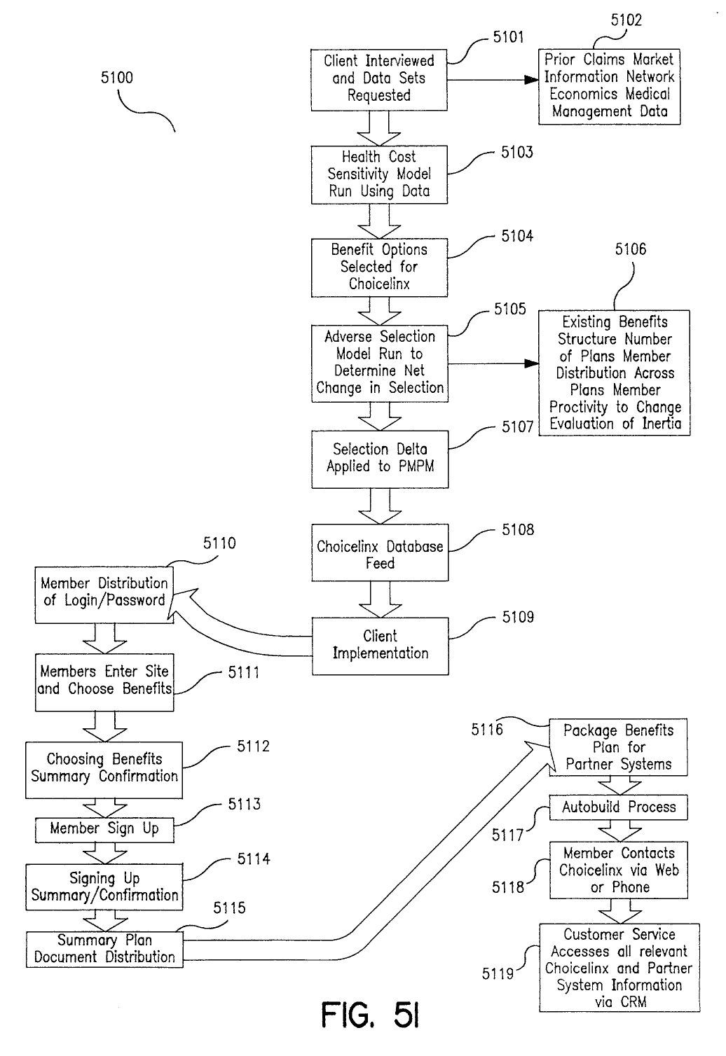

With reference now to FIG. 51, the overall business model employed by the company will now be described. The company may offer a comprehensive suite of products and services that can meet the varying needs of traditional insurers, financial services companies, managed care organizations, and self-funded employers. The company's architecture may be scalable to support any size company and flexible enough to grow as its customers grow. The suite of company products may include Benefits Configuration & Enrollment, Self-Service Modules, Employer Reporting Tools, Customer Service and Medical Management.

For the sales cycle, the company may conduct an extensive inventory of client requirements to determine the most appropriate design and offering of available products and services. Subsequent to this inventory, the company may request a list of data elements necessary to support both the Health Cost Sensitivity and Adverse Selection Model components (described in further detail herein). Pricing and benefit structures may be determined and presented to the client with all relevant assumptions, associated medical costs, administrative and set-up fees may be discussed with the client, and contracts may be executed.

As for client implementation, data from the Health Cost Sensitivity Model and Adverse Selection Models may be fed into the company's Web Database and all remaining client set-up information may be gathered, including complex business rules to drive the web application as well as the back-end systems.

During open enrollment, members may receive a login and password to access the site as prescribed by the client set-up rules. The member then may log into the site during the specified open-enrollment period, configure their benefits, sign up and become effective for the benefit term. A detailed plan document may then either be distributed directly to the member or accessed via the site according to their preference.

After enrollment, once the member has confirmed their benefits, their configured benefit packages are created based on the Group setup criteria and the member's choices. The packages are mapped to the partner specific benefit codes, and this crosswalk may be maintained by the company. Customers may then be serviced through a central desktop application that pulls in information from each partner system and the company's database and draws on their customized SPD. Customers may also perform self-service functions via the web, the back-end designed in such a way as to leverage the same calls to the partner systems that the Customer Service application utilizes.

FIG. 51 illustrates an exemplary overall business model process flow 5100. As shown, a client may be interviewed 5101 and data sets may be requested, as appropriate. Such data sets 5102 may include, e.g., prior claims, market information, network economics, and/or medical management data. A health cost sensitivity model may be run 5103 using the data. Benefit options may be selected 5104 for the company, and an adverse selection model may be run 5105 to determine the net change in the selection.

The adverse selection model 5106 may take into account, e.g., the existing benefits structure, the number of plans, the member distribution across plans, and the member proclivity to change his or her evaluation of inertia. The net change in the selection may be applied 5107 to PMPM. A database feed 5108 may occur, and the client may implement 5109 the company's system. Distribution of member logins and passwords may occur 5110. Members may then enter the site 5111 and choose benefits 5112, confirming their selection. Members may sign up 5113 and confirm 5114 the signup data. A summary plan document may then be distributed 5115. The benefits plan may be packaged 5116 for partner systems. The auto-build process may begin 5117, as described above. The member may contact 5118 the company via web or phone, and customer service may access all relevant system data 5119 to aid customers.

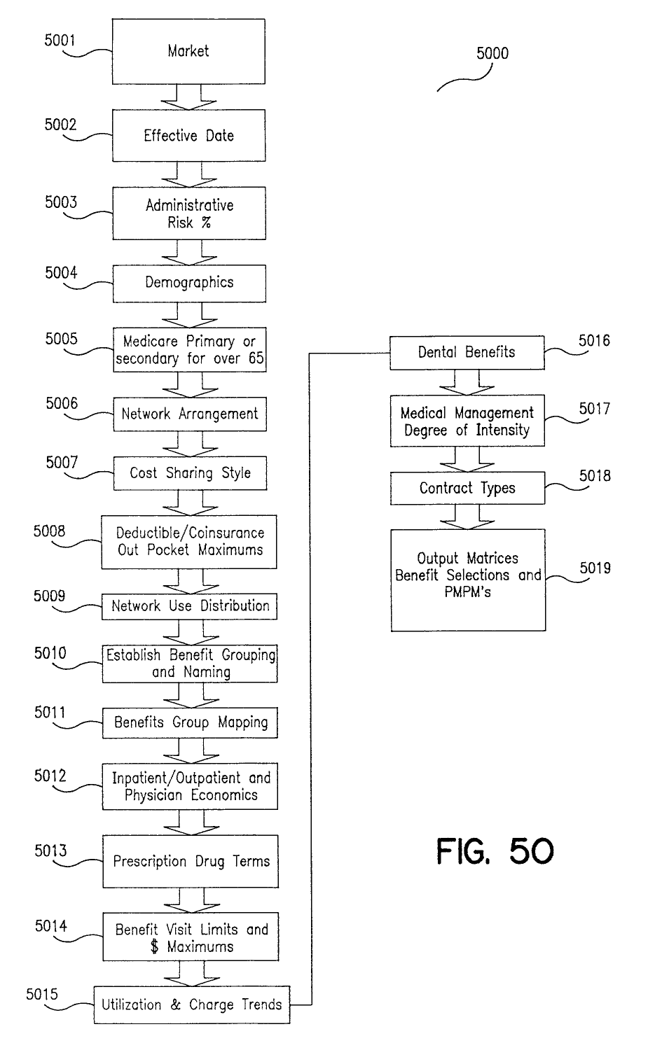

An exemplary underwriting process flow 5000 is illustrated in FIG. 50. The underwriting process may perform one or more of the following steps and/or use the following data in the underwriting process: market 5001, effective date 5002, administrative risk percentage 5003, demographics 5004, Medicare primary or secondary for over-65 5005, network arrangement 5006, cost sharing style 5007, deductible/coinsurance out of pocket maximums 5008, network use distribution 5009, establish benefit grouping and naming 5010, benefit groups mapping 5011, inpatient/outpatient and physician economics 5012, prescription drug terms 5013, benefit visit limits and dollar maximums 5014, utilization and charge trends 5015, dental benefits 5016, medical management degree of intensity 5017, contract types 5018, and output matrices, benefit selections and PMPMs 5019.

### Health Cost Sensitivity Model

The HCSM may be developed using actuarial information, e.g., the Milliman & Robertson, Inc. Health Cost Guidelines and Ages 65 and Over Health Cost Guidelines and their judgment. The underlying actuarial cost models may include utilization rates per 1,000 members per year, average reimbursement per service and cost per member per month (PMPM) for a number of detailed medical service categories. Two years' prior medical claims history and the existing level of medical management are used in cooperation with census data and all other inputs outlined below to determine medical costs for the group.

The following items may need to be entered or selected within the General Input menu: region, effective date, administration/risk percentage, demographics, and Medicare primary or secondary. For the region, the HCSM currently allows for the choice of more than 200 Metropolitan Statistical Areas in the country. Selecting a particular region may result in the starting utilization rates, average billed charges, and Medicare RBRVS fee levels being changed to reflect the practice patterns and reimbursement levels for the specified region.

The starting cost targets may represent, for example, expected costs for the period Jan. 1, 1999 through Dec. 31, 1999 (i.e., groups effective Jan. 1, 1999). To change the effective starting date, a user may first select the month and then the appropriate year from drop-down list boxes. The model may assume a twelve-month rating period; therefore the midpoint of the rating period may be six months after the effective date. Administration/risk margin may be entered as a percent of the total revenue target. This percentage may also be used to account for coordination of benefit recoveries and net reinsurance.

The user may elect to use M&R's standard labor force demographics or plan specific demographics by age and gender. Both active employees and retirees (early and those at least 65 years of age) may be entered. If the plan has retirees over 65, the user must choose whether the plan will cover them primary (Medicare would then be secondary) or secondary (Medicare would then be primary), by choosing from an appropriate drop down box.

A product type menu may include options, such as network arrangement, in-network cost sharing style, out-of-pocket maximum including or excluding deductible, and in-network/out-of-network distribution. For the network arrangement, the user may choose between “Lock-In” and “Choice” Options. In addition, the user may need to enter the estimated percentage of in-network usage in the “Network Use/Cost Percentage” of an In-Network column. The user may choose between “Coinsurance/Coinsurance with Deductible” and “Coinsurance/Coinsurance without Deductible” by choosing from a drop down box. The user may choose an out-of-pocket maximum that includes or excludes the deductible. By choosing “Excluding Deductible”, the out-of-pocket maximum may be the additional out-of-pocket dollars the member is responsible for after paying the deductible. The user may choose between “In-Network/Out-of-Network Mix by Use” and “In-Network/Out-of-Network Mix by Cost”. When choosing “In-Network/Out-of-Network Mix by Use”, the user may need to enter the percentage of total utilization expected to occur in-network. When choosing “In-Network/Out-of-Network Mix by Cost”, the user may need to enter the percentage of total cost expected to occur in-network.

A Benefit Groups menu may be provided, wherein the user may create unique benefit groupings. The user may need to enter names for the benefit groups to which they will assign the benefit items listed in the Included Benefits Menu. The user may select to include or exclude specific services by choosing from the appropriate drop down box. For those benefits that have been included, the user may need to select the benefit grouping in which they want to include each benefit. A Facility Negotiated Reimbursement Menu may be used to select the target level of hospital facility reimbursement. A Hospital Inpatient Facility menu may be used to select either a percentage discount from billed charges or fixed per diem method of discount calculation. The user may select a percentage discount with optional overrides for case rates in selecting a Hospital Outpatient Facility.

For other negotiated reimbursement physician services, the user may select either a percentage discount from billed charges method, Medicare multiplier method or complete fee schedule input method of calculating physician services economics. For prescription drugs, the user may need to enter the assumed discount from average wholesale price, the maximum allowable costs, tier structure and generic program terms, if any. An HMO Limits Menu may be provided, wherein day and visit limits may be selected for the following exemplary benefits: (1).Inpatient and Outpatient Mental Health and Substance Abuse, (2) Routine Vision Exams, (3) Occupational, Speech, and Physical Therapy and Chiropractic Care, (4) Cardiac Rehabilitation, and (5) Hospice Care and SNF/Acute Rehabilitation.

A Trends Menu may be provided, wherein average annual utilization and average charge trend percentages by service category may be entered in appropriate boxes. A Dental Menu may be provided so that the user may determine whether a dental program will be offered, and if so, whether Levels I, II or III will be offered. A Management Level Menu may be provided, wherein the user enters the degree of medical management for inpatient, outpatient, physician and prescription drug benefits based on predetermined guidelines (e.g. Milliman & Robertson). A Premium Menu may be provided, so that the user may select the number of contract tiers from a drop down menu. After the number of tiers is selected, the user may enter the percentage of employees within each tier. Output may include the multipliers for each contract type. A Model Output menu may be provided, wherein, after selecting the desired input options, the resulting revenue targets may be viewed in this sheet as well as the cost per benefit in staggered increments according to contribution type (e.g., fixed co-pay or percentage cost-share).

### Adverse Selection Model

The Adverse Selection Model (ASM) may be designed to support the company, along with the Health Cost Sensitivity Model (HCSM) in developing illustrative commercial group medical cost targets for a wide range of rating variables. The Primary use of the ASM may be to estimate and quantify the potential for adverse selection under the medical component of the company's system. ASM may address the situation where the plan sponsor is fully or partially self-insured. The model may account for situations in which the plan sponsor currently offers high/low benefit options or offers a single plan design.

The ASM may include the following major components: (1) Input applicable to the plan sponsor's current self-insured benefit plans, including the current enrollment percentages (single and family) in each plan and the relative per member per month (PMPM) actuarial revenue targets each plan. The actuarial revenue targets for these plans may be calculated using the HCSM; (2) Estimation of enrollment in the various benefit options; and (3) Calculation of the selection adjustment that will be applied to the HCSM actuarial cost targets for the benefit options. The core concept underlying the adverse selection calculation may be a claim probability distribution.

The claim probability distributions may be based, e.g., on information in M&R's Health Cost Guidelines, their work and experience with adverse selection in multiple choice benefit offerings and their judgment. The claim probability distributions in the ASM may be less steep than the claims distributions based on the actual costs of a typical insured population. The distributions may be narrower because: (1) people do not have perfect knowledge of nor are they able to quantify accurately, their prospective health care costs; (2) different people perceive the value of benefit choice in different ways; (3) inertia or steerage toward certain benefits reduces selection, and (4) people may select a health benefit plan for reasons other than expected usage of health care. A selection factor may be calculated for the plan sponsor's existing benefit program and for the prospective company's program. The ratio of the company factor to the existing program factor may represent the incremental selection due to the company's program. It is this ratio that may be applied to all the company's HCSM actuarial revenue values.

The output from the model may be an Overall Selection Adjustment, which may be applied to all the actuarial cost targets in the HCSM. This factor may be displayed in the User Options sheet of the ASM. For input from HCSM, for current plans, the user may be required to copy the benefit categories and cost targets from Table 1 of the HCSM (in Model Output) after adjusting the HCSM to reflect the plan sponsor's actual experience and current benefit plans. For company plans, the user may be required to copy the benefit categories and cost targets from Table 1 of the HCSM (in Model Output) after adjusting the HCSM to reflect the plan sponsor's actual experience with individual company plans.

With respect to the Current Plans section, along with the current plan information from Input from HCSM, the user may need to estimate the amount of selection already contained in the current set of benefit plans being offered by the plan sponsor. The user may first need to select how many benefit plans the plan sponsor has currently. The cost targets for the current plans are automatically referenced from Input from HCSM. The user may then need to select the method of identifying the distribution of enrollment, separated by single contracts versus family contracts, currently in each benefit plan. Once selected, the user may need to enter the appropriate enrollment numbers in the corresponding section for each benefit plan.

The selection in Current Plans may be the estimated value of selection implicitly included in the current set of benefit plans being offered by the plan sponsor. For each of the current benefit plans, current employer contribution levels may need to be identified. Employer contribution levels for the company's arrangement may also need to be identified. The user may account for the prospective company benefits to be offered.

The minimum and maximum benefit combinations may be determined based on the company plans entered in Input from HCSM. The user may need to estimate how many employees may choose benefits similar to one of the benefit plans currently offered versus other benefit plans currently offered. The user may need to account for how many employees may choose benefits similar to the benefit plans currently offered versus those benefits slightly more or less expensive. The current targeted PMPM costs, along with the default plan allocation factors and default inertia factors displayed for both single and family enrollees, may be used to estimate the prospective enrollment distribution among benefit plans under the company's program.

The default plan section may allow the user to modify the prospective enrollment distribution among the company's benefit options to reflect the plan sponsor promoting a default plan or base plan. The resulting company selection-loading factor may be the estimated value of selection resulting from the company's benefit options. The overall selection adjustment may be calculated by comparing the selection implicit in the set of current benefit plans to the selection-loading factor resulting from the company's benefit options. This factor should be applied to the cost targets from the HCSM to adjust the level of selection within the company's options as compared to the level of selection within the current plans.

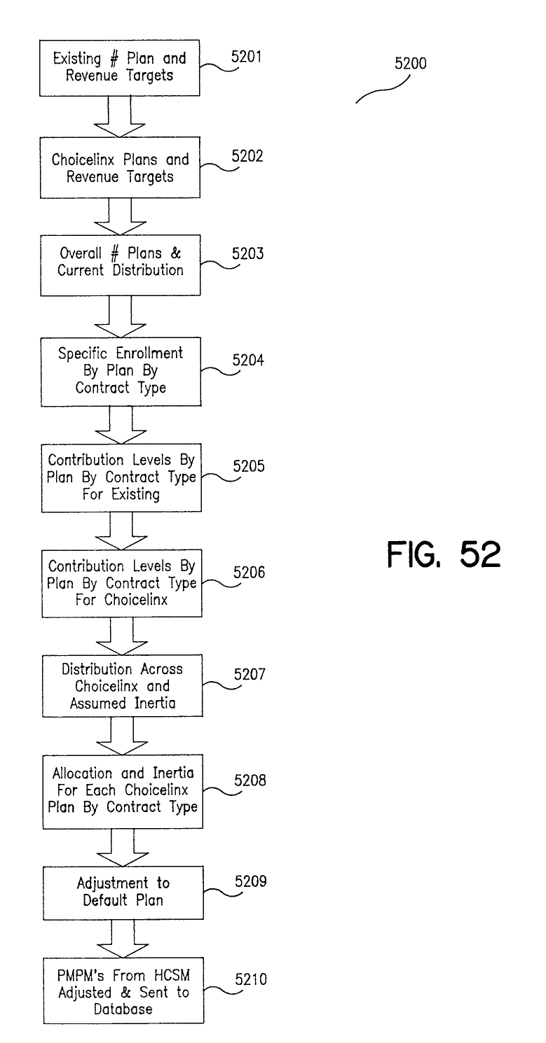

FIG. 52 illustrates an exemplary Adverse Selection Model process 5200. As shown, a number of variables are taken into account through a number of processes: the existing number of plans and revenue targets are considered 5201, the company's plans and revenue targets are considered 5202, the overall number of plans and current distribution are considered 5203, the specific enrollment by plan by contract type is considered 5204, the contribution levels by plan by contract type for existing subscribers are considered 5205, the contribution levels by plan by contract type for the company are considered 5206, the distribution across the company and assumed inertia are considered 5207, the allocation and inertia for each company plan by contract type are considered 5208, adjustments to the default plan are considered 5209, and the PMPMs from HCSM are adjusted 5210 and sent to the database.

The embodiments described and illustrated herein are but some of the several which utilize this invention and are set forth here by way of illustration but not of limitation. It is obvious that many other embodiments, which may be readily apparent to those skilled in the art, may be made without departing materially from the spirit and scope of the invention.

What is claimed is:

1. A method of providing benefits to an employee comprising:
identifying at least one price for each of a plurality of line items within a benefit category; and
offering said line items for purchase by said employee.

2. A method according to claim 1, said method further comprising: providing a predefined employer contribution to said employee for purchase of at least one of said line items.

3. A method according to claim 1, wherein said benefit category comprises insurance benefits.

4. A method according to claim 3, wherein said insurance benefits comprise health insurance benefits.

5. A method according to claim 4, wherein said plurality of line items comprises line items selected from the group consisting of: preventative care, physician care, hospital care, emergency care, pharmacy care, alternative care, vision care, and behavioral health care services.

6. A method according to claim 1, wherein said prices are established based on prior cost data.

7. A method according to claim 1, wherein said prices are established based on actuarial data.

8. A method according to claim 1, said method further comprising: identifying a plurality of options for purchase by said employee within said line items.

9. A method according to claim 8, wherein said options comprise cost sharing options.

10. A method according to claim 8, wherein said options comprise place of service options.

11. A method according to claim 8, wherein said options comprise benefit provider network options.

12. A method according to claim 8, said method further comprising: identifying a plurality of sub-options for purchase by said employee within said options.

13. A method according to claim 1, wherein said line items are offered for purchase by said employee through a user interface accessible through a computer network.

14. A method according to claim 13, wherein said computer network is a local area network.

15. A method according to claim 13, wherein said computer network is a global computer network and wherein said user interface is provided at a web site on said network.

16. A method according to claim 13, said method further comprising: identifying factors on said user interface for said employee to consider in connection with the purchase of one or more of said line items.

17. A method according to claim 13, said method further comprising:
querying said employee through said user interface for personal information related to said employee; and
explaining the need for said personal information on said user interface.

18. A method according to claim 1, said method further comprising:
creating data representing each said line item purchased by said employee; and
transmitting said data to a benefit claims processing vendor configured to automatically build a benefit profile for said employee based on said data.

19. A method according to claim 18, wherein said claims processing vendor is configured to confirm eligibility for payment of benefit claims based on said benefit profile.

20. A method according to claim 1, said method further comprising:
creating data comprising personal information related to said employee and representing each said line item purchased by said employee; and
transmitting said data to a customer service vendor configured to automatically build a customer benefit summary for said employee based on said data.

21. A method of providing healthcare to an individual comprising:
identifying a price for at least one healthcare line item for said individual; and
offering said at least one line item for purchase by said individual.

22. A method according to claim 21, said method further comprising: providing a predefined contribution to said individual for purchase of at least one of said line items.

23. A method according to claim 22, wherein said individual is an employee and said predefined contribution is provided by said employee's employer.

24. A method according to claim 21, wherein said plurality of line items comprises line items selected from the group consisting of: preventative care, physician care, hospital care, emergency care, pharmacy care, alternative care, vision care, and behavioral health care services.

25. A method according to claim 21, wherein said price is established based on prior cost data.

26. A method according to claim 21, wherein said price is established based on actuarial data.

27. A method according to claim 21, said method further comprising: identifying a plurality of options for purchase by said individual within said line items.

28. A method according to claim 27, wherein said options comprise cost sharing options.

29. A method according to claim 27, wherein said options comprise place of service options.

30. A method according to claim 27, wherein said options comprise benefit provider network options.

31. A method according to claim 27, said method further comprising: identifying a plurality of sub-options for purchase by said individual within said options.

32. A method according to claim 21, wherein said line items are offered for purchase by said individual through a user interface accessible through a computer network.

33. A method according to claim 32, wherein said computer network is a local area network.

34. A method according to claim 32, wherein said computer network is a global computer network and wherein said user interface is provided at a web site on said network.

35. A method according to claim 32, said method further comprising: identifying factors on said user interface for said individual to consider in connection with the purchase of one or more of said line items.

36. A method according to claim 32, said method further comprising:
querying said individual through said user interface for personal information related to said individual; and
explaining the need for said personal information on said user interface.

37. A method according to claim 21, said method further comprising:
creating data representing each said line item purchased by said individual; and
transmitting said data to a benefit claims processing vendor configured to automatically build a benefit profile for said individual based on said data.

38. A method according to claim 37, wherein said claims processing vendor is configured to confirm eligibility for payment of benefit claims based on said benefit profile.

39. A method according to claim 21, said method further comprising:
creating data comprising personal information related to said individual and representing each said line item purchased by said individual; and
transmitting said data to a customer service vendor configured to automatically build a customer benefit summary for said individual based on said data.

40. A method of establishing a health care benefits offering to an employee group comprising:
establishing a healthcare cost for said group; and
establishing a plurality of health care line items based on said cost.

41. A method according to claim 40, wherein said plurality of line items comprises line items selected from the group consisting of: preventative care, physician care, hospital care, emergency care, pharmacy care, alternative care, vision care, and behavioral health care services.

42. A method according to claim 40, wherein said cost is established based on prior cost data.

43. A method according to claim 40, wherein said cost is established based on actuarial data.

44. A method according to claim 40, said method further comprising: establishing a plurality of options within at least one of said line items.

45. A method according to claim 44, wherein said options comprise cost sharing options.

46. A method according to claim 44, wherein said options comprise place of service options.

47. A method according to claim 44, wherein said options comprise benefit provider network options.

48. A method according to claim 44, said method further comprising: establishing a plurality of sub-options within at least one of said options.

49. A method according to claim 40, said method further comprising: presenting said line items on a user interface accessible through a computer network.

50. A method according to claim 49, wherein said computer network is a local area network.

51. A method according to claim 49, wherein said computer network is a global computer network and wherein said user interface is provided at a web site on said network.

52. A method of providing benefits to an employee comprising:
establishing an account comprising a predefined employer contribution;
offering a plurality of benefit line items to said employee for purchase; and
deducting a cost associated with each benefit line item purchased by said employee from said account.

53. A method of according to claim 52, wherein said account further comprises an employee contribution.

54. A method according to claim 52, wherein said benefit category comprises insurance benefits.

55. A method according to claim 54, wherein said insurance benefits comprise health insurance benefits.

56. A method according to claim 55, wherein said plurality of line items comprises line items selected from the group consisting of: preventative care, physician care, hospital care, emergency care, pharmacy care, alternative care, vision care, and behavioral health care services.

57. A method according to claim 52, said method further comprising: offering a plurality of options for purchase by said employee within said line items.

58. A method according to claim 57, wherein said options comprise cost sharing options.

59. A method according to claim 57, wherein said options comprise place of service options.

60. A method according to claim 57, wherein said options comprise benefit provider network options.

61. A method according to claim 57, said method further comprising: identifying a plurality of sub-options for purchase by said employee within said options.

62. A method according to claim 52, wherein said line items are offered for purchase by said employee through a user interface accessible through a computer network.

63. A method according to claim 62, wherein said computer network is a local area network.

64. A method according to claim 62, wherein said computer network is a global computer network and wherein said user interface is provided at a web site on said network.

65. A method according to claim 62, said method further comprising: identifying factors on said user interface for said employee to consider in connection with the purchase of one or more of said line items.

66. A method according to claim 62, said method further comprising:
querying said employee through said user interface for personal information related to said employee; and
explaining the need for said personal information on said user interface.

67. A method according to claim 52, said method further comprising:
creating data representing each said line item purchased by said employee; and
transmitting said data to a benefit claims processing vendor configured to automatically build a benefit profile for said employee based on said data.

68. A method according to claim 67, wherein said claims processing vendor is configured to confirm eligibility for payment of benefit claims based on said benefit profile.

69. A method according to claim 52, said method further comprising:
creating data comprising personal information related to said employee and representing each said line item purchased by said employee; and
transmitting said data to a customer service vendor configured to automatically build a customer benefit summary for said employee based on said data.

70. A system for providing benefits to an employee comprising:
at least one database comprising data representing at least one price for each of a plurality of line items within a benefit category;
at least one processor for accessing said database; and
a user-interface for accessing said processor to allow purchase of at least one of said line items by said employee.

71. A system according to claim 70, wherein said database further comprises data representing a predefined employer contribution to said employee for purchase of at least one of said line items.

72. A system according to claim 70, wherein said benefit category comprises insurance benefits.

73. A system according to claim 72, wherein said insurance benefits comprise health insurance benefits.

74. A system according to claim 73, wherein said plurality of line items comprises line items selected from the group consisting of: preventative care, physician care, hospital care, emergency care, pharmacy care, alternative care, vision care, and behavioral health care services.

75. A system according to claim 70, wherein said database further comprises data representing a plurality of options for purchase by said employee within said line items.

76. A system according to claim 75, wherein said options comprise cost sharing options.

77. A system according to claim 75, wherein said options comprise place of service options.

78. A system according to claim 75, wherein said options comprise benefit provider network options.

79. A system according to claim 75, wherein said database further comprises data representing a plurality of sub-options for purchase by said employee within said options.

80. A system according to claim 70, wherein said user interface is accessible through a computer network.

81. A system according to claim 80, wherein said computer network is a local area network.

82. A system according to claim 80, wherein said computer network is a global computer network and wherein said user interface is provided at a web site on said network.

83. A method of processing a benefit claim for an individual comprising:
receiving a signal comprising data representing individual line items within a benefit category purchased by said individual;
automatically building a benefit profile for said individual based on said data; and
confirming eligibility for payment of said claim based on said benefit profile.

84. A method according to claim 83, wherein said benefit category comprises insurance benefits.

85. A method according to claim 84, wherein said insurance benefits comprise health insurance benefits.

86. A method according to claim 85, wherein said plurality of line items comprises line items selected from the group consisting of: preventative care, physician care, hospital care, emergency care, pharmacy care, alternative care, vision care, and behavioral health care services.

87. A method according to claim 83, wherein said signal further comprises data representing at least one option purchased by said individual within at least one of said line items.

88. A method according to claim 87, wherein said option comprises a cost sharing option.

89. A method according to claim 87, wherein said option comprises a place of service option.

90. A method according to claim 87, wherein said option comprises a benefit provider network option.

91. A method according to claim 87, wherein said signal further comprises data representing at least one sub-option purchased by said individual within said option.

92. A method according to claim 83, wherein said signal is received from a local area computer network.

93. A method according to claim 83, wherein said signal is received from a global computer network.

94. A method of providing customer service to an individual purchasing benefits comprising:
receiving a signal comprising data representing individual line items within a benefit category purchased by said individual;
creating a summary of said individual benefit line items from said data; and
referring to said summary to answer questions from said individual relating to said individual benefit line items.

95. A method according to claim 94, wherein said data further comprises personal information related to said individual.

96. A method according to claim 94, wherein said benefit category comprises insurance benefits.

97. A method according to claim 96, wherein said insurance benefits comprise health insurance benefits.

98. A method according to claim 97, wherein said plurality of line items comprises line items selected from the group consisting of: preventative care, physician care, hospital care, emergency care, pharmacy care, alternative care, vision care, and behavioral health care services.

99. A method according to claim 94, wherein said signal further comprises data representing at least one option purchased by said individual within at least one of said line items.

100. A method according to claim 99, wherein said option comprises cost sharing option.

101. A method according to claim 99, wherein said option comprises a place of service option.

102. A method according to claim 99, wherein said option comprises a benefit provider network option.

103. A method according to claim 99, wherein said signal further comprises data representing at least one sub-option purchased by said individual within said option.

104. A method according to claim 94, wherein said signal is received from a local area computer network.

105. A method according to claim 94, wherein said signal is received from a global computer network.
